(19) United States
(12) Patent Application Publication
(10) Pub. No.: US 2012/0179548 A1
(43) Pub. Date: Jul. 12, 2012

(54) METHODS AND SYSTEMS FOR PROVIDING LOCATION-BASED PROMOTIONS ON A USER INTERFACE OF A WIDGET BASED ON ITS CURRENT LOCATION

(76) Inventors: YUN-TING SUN, Taipei (TW); HSIU-PING LIN, Taipei City (TW)

(21) Appl. No.: 13/025,224

(22) Filed: Feb. 11, 2011

Related U.S. Application Data
(63) Continuation-in-part of application No. 13/004,298, filed on Jan. 11, 2011.

(51) Int. Cl. G06Q 30/00

(52) U.S. Cl. 705/14.58

(57) ABSTRACT

The present invention may be related to a system of providing location-based service and an LBS widget coupled with the system. The LBS widget may include a positioning module, a map module and an LBS promotion module. The positioning module may be configured to receive first coordinates. The map module may be configured to show a part of a map on a first user interface, wherein the part of the map may include a first location corresponding to the first coordinates. Moreover, the LBS promotion module may be configured to receive product information and second coordinates related to a promoted product page and mark a second location corresponding to the second coordinates on the part of the map.

### CROSS REFERENCE TO RELATED APPLICATION

This application is a continuation-in-part of U.S. patent application Ser. No. 13/004,298, filed Jan. 11, 2011, which is herein incorporated by reference in its entirety.

### BACKGROUND OF THE INVENTION

The present invention relates to location-based service. More particularly, the present invention relates to system and method of providing location-based promotions based on users' current location(s).

Location-based service (LBS) or location service becomes more and more important in everyday life. Some LBS may be provided in a cellular phone (e.g., a smart phone) or a navigator (e.g., a GPS) as an application (i.e., software, perhaps including an electronic map or coupled with the electronic map, installed in the cellular phone or the navigator, or a widget specifically for coupling to a web or a system that provides an online map) for its user to find a point of interest (POI; that is a point on the map(s) of which the user is interested in looking for). Traditionally, the execution of the application that provides this kind of LBS may include at least two steps: first, finding the location of the user through getting the positioning information of the cellular phone or the navigator (e.g., coordinates or longitude and latitude which are also sent by the cellular phone or the navigator), and second, receiving a keyword inputted by the user through an input field shown on the screen of the cellular phone or the navigator generated by the application (or in some examples, the keyword may be generated through voice recognition) to make the application or the online map system find POls for the user based on the keyword (as search results).

Examples of the aforementioned web, system or online map can be found as an application (or a widget) called “Google Maps” (or simply called “Maps”) in cellular phones. LBS that provide information (e.g., store location, advertisement, travel, real estate or daily life information) stored in the system or coupled to or associated with points on the maps can therefore be realized by providing keyword search to these information based on the user's location. Usually, these kinds of information are called “location information” or “map information”. The map information is stored in a server of the web or the system, and a search engine (perhaps installed in the same server or in another server coupled with the server having the map information) is provided for searching the map information based on the keyword.

In many countries, conventionally the map information is usually established/held and provided by a system provider (which also sets up the infrastruture of telecommunication systems or the cellular network including those telecommunication euipments such as base stations or relay stations for example, or held by a content provider such as Google or Yahoo who provides the application (the widget) for cellular phones.

However, the aforementioned conventional map information (location information) can be classified to “static” information since this kind of information may not be changed/modified rapidly, or even seldom or never be changed. Updating the conventional map information may usually take a long while. For example, the system provider or the content provider of the LBS may adopt data mining techniques to webs on Internet to collect new map information, or assign their employee(s) or street view cars to make a circuit of (or travel around) an area, a district, a city or a whole country to take pictures or do interviews for receiving/collecting new location information (e.g., a newly opened store or a newly completed building on certain location/point(s)), and the engineer(s) who maintains the map will update (i.e., delete/change/modify/add) those should be updated corresponding to the newly received/collected location information related to the original point of the map to become new/updated map information on the map (e.g., based on the coordinates or address they received the location information, etc). However, the above procedures that the system provider or the content provider intiatively update their map information on their map(s) may take a long time (a few days or even a few weeks) to collect the new location information and to update the new location information “manually” into their map.

Another example of updating map information on the aforementioned conventional map can be found as the system provider or the content provider may have a merchant registration center on its web for a merchant or a vendor to register the information (or location information) about his/her store/company/factory, etc, into the system through the web (e.g., refer to the “Merchant Registration Center” of the Google Maps). For example, the merchant may register the information including a name, an address, phone numbers or link(s) of the store/company/factory, etc, or descriptions that introduces their major(s). Then, the system provider or the content provider may make the registered information become associated with the point (location) representing the address shown on the map after receiving the registered information. A corresponding map information about the merchant's (or the vendor's) registered information is then formed on the map. However, the registered information may still become “static” (for at least a long while) on their map, not real-time updated or dynamic, that is, the system or the web can still provide “static” map information (e.g., the name, the address, shop hours or phone number(s), the business items or the products sold in the store, etc., related to the point on the map are all static), but cannot provide real-time/dynamic information about each product sold in the store (e.g., an item is sold out or not, remain how many or what size(s) of the item, arrival or not, when to arrival, the store is closed because of contingency, etc.). The conventional electronic/online map(s) cannot real-time take immediate reaction to the change of the aforementioned items for example. Moreover, there is no interactive mechanisms or functions corresponding to the registered information provided on the map. That is, no interface for a user of the map to “interact” with the information registered by the merchants. In these ways, the conventional map may still “authoritative” that its user can do nothing but accept its map information passively and believes it is correct (i.e., unilaterally receive the map information but cannot realtime interact with the merchant/vendor related to the map information).

Further, users of the conventional maps may have no direct ways to communicate or interact with the map information shown on the map. For example, the users may not be able to communicate with the merchant or ask the merchant a question about a product of a store found on the map by using the online map system or web directly (e.g., providers like Google does not provide a function like “ask the seller a question” as shown on eBay for a user to ask a question about one map information shown on their map directly. The users can only dial the phone number if the merchant makes his/her number be shown on the map and ask the merchant directly by phone).

Furthermore, in this example, there is no functions like “buy it directly,” “place a bid to buy” or “make a reservation,” etc., For the users to take an action (like web auction) to an item sold in the store shown/described in the map information on the aforementioned map. That is, the aforementioned map system or web may lack of “interactivity” that their user cannot interact with their map information (or say, with the merchant who generates or makes the map information be formed on the map) directly through the system or the web, but can only passively receive/accept what they find (the search result(s)) on the map (or say, can only accept what the system or the web gives them).

Drawbacks of the aforementioned map(s) may happen because of the poor interactivity or the lack of real-time changeable ability of the map information provided by the system or the web. For example, a user may go to a store after finding the store on the electronic map in his/her cellular phone, but an item described in the corresponding map information he/she wants is just sold out in the store, or the merchant/vendor has already left the store ahead of normal closing time of the store.

Other conditions that the conventional map system or web cannot satisfy may be found as following:

In prior art, for example, LBS provided by the map system or web may not be capable of allowing a merchant or a seller to upload or update information about his/her product(s) to form a web page (as a web page for an auction item of eBay) and couple the web page to the conventional map(s) for the users of the map(s) to search and get the information of the product(s). Moreover, the map system usually do not provide management functions such as place a bid, decide the bid with highest price to win, conduct a question or an answer to its user or other purchase mechanism as a conventional auction web will do to its map information (or say, the item described in its map information).

On the other hand, the conventional map system or web cannot allow a user to real-time add/modify map information and real-time interact with the map information. Moreover, the timeliness of the map information is not emphasized on the conventional map since most of the conventional map information is static. For example, the available time or expiration time/date of the map information is not shown, and therefore when a user search and find the map information, he/she has no way to know it what described in the map information is still valid. This kind of map system or web cannot be used by the user in certain conditions, for example, to search for a person, a seller or a street vendor nearby who will only show up in next two hours on a corresponding point on the map(s).

Similarly, a seller (a merchant or a vendor) may not be able to provide information having timeliness or interactivity (e.g., “we will show up here in next twenty minutes,” “There is a time-limited sales promotion in next one hours,” or “please click the bottom to make a reservation for 1 hours,” etc.) to users who pass by (or will pass by) and may look for the map information about the merchant or the vendor's store or products through conventional map systems or webs.

Moreover, when a seller brings some products with in his/her car/bag, theoretically he/she can sell the products to those near him/her and who wants to buy the products wherever he/she goes. This means if the seller wants the fact “he/she is here to sell the product” become map information for users of the map to search for and find the location of the product (i.e., the seller's current location) on the map in the users' phones, the location of the product may change time to time. However, the conventional map systems or webs may not support this kind of function(s) to dynamically change the position information (the location or the coordinates) of its map information.

Other bottlenecks of the conventional map systems or webs can also be described in the following example:

One day, Joseph went to a district where he wants to buy a house. He tried to use a map shown on the screen of his cellular phone to search for houses sold around him and also satisfying his requirements. After searching, he found three houses (shown as map information on the map) that could meet his requirement and were sold by (real estate) brokers. One of the brokers of the houses, Mei, was walking on the street in same area but Joseph had no way to know then. However, because the map information is neither interactive nor real-time changed, Joseph could not get information about the status of Mei (who could be walking around the same area) and he could get introduction of the house from her immediately.

Moreover, correctness of the map information is very important when providing the kind of location-based services. However, the conventional map information (or the map system or the web) of the prior art may usually be held and provided by specific companies or organizations (e.g., Google Inc. holds the map information on the Google Maps), and thus the correctness of the map information can only be judged by the companies or the organizations. Furthermore, one may deliberately offer misleading or wrong map information on the conventional map for his/her own purpose (e.g., interests, advantages, etc.). For example, sometimes real estate brokers may post house information with indistinct or wrong point (location or address) on the map for the reason that the brokers do not want any potential buyers or customers to approach the owner of the house directly (i.e., to bypass the brokers for saving commission). Other example of misleading map information may be found if the aforementioned map system for the merchant/vendor to register their store/product information is not well-managed. One may intentionally registers his/her product information at many places of the map (i.e., to make the product information be coupled with/shown at many points on the map (even if these points are not related to his/her products or say a user cannot find the merchant/vendor at the location) in order to increase its exposure or to achieve the advertising validness. Wrong/Incorrect map information (or information correlated to wrong location) will make users confused, waste their time or even cause danger. It may therefore be desirable to have an anti-abuse measure/mechanism to prevent the map becoming improper advertising tools or criminal tools.

In addition, users of the conventional map systems or webs may seldom or never have chances to express their views or give their opinions directly to the correctness of the map information shown on the conventional maps by using any reporting or statement functions coupled with the point related to the map information (or the icon or web page showing the map information) on the conventional map(s). A system or a method for the users (or the public) to supervise the correctness of the map information shown on the map(s) may be necessary and helpful.

The original idea or the basic spirit of the location-based service should be to provide direct, correct, helpful and reachable (i.e., easy to obtain or approach) information surrounding the user's current location to the user immediately (or in real-time). Some of this kind of information should always be most updated (dynamic) for applications such as those mentioned above. Therefore, the static map information of the conventional map system or web may not be able to meet the requirements. Moreover, misleading map information should definitely not be allowable and a user of a map system should have right or a way to join the supervision of its map information.

Therefore, it is desirable to have an LBS system to satisfy the aforementioned needs.

### BRIEF SUMMARY OF THE INVENTION

Examples of the present invention may provide an LBS system. The system may include a position module, a management module and a map information module. The position module may be configured to receive first position information. The management module may be configured to receive product information and generate a product page based on the product information. The product information may include or be related to at least one of a title, a price, a description, a picture, a voice description or a video of a product. The product page may include at least one of the title, the price, the description, the picture, the voice description or the video of the product. Furthermore, the product page may be configured to couple with a communication module. The communication module may be configured to receive a question about the product. Moreover, the map information module may be configured to couple the product page with a location on a map based on the first position information.

Some examples of the present invention may provide an LBS system. The system may include a position module, a management module and a map information module. The position module may be configured to receive first position information. The management module may be configured to receive message information and a value of an expiration time, and generate a web page including the message information. The management module may further include a timer configured to count the time after the web page is generated and the management module may be configured to decide if the web page is valid or should be shown when/after comparing the time and the value of the expiration time. The message information may include at least one of a title, a description, a picture, a voice description or a video. The web page may include at least one of the title, the description, the picture, the voice description or the video. Moreover, the map information module may be configured to couple the web page with a location on a map according to the first position information.

Examples of the present invention may also provide a method of providing location-based service. The method may include receiving first position information; receiving product information, wherein the product information include at least one of a title, a price, a description, a picture, a voice description or a video of a product; generating a product page based on the product information, wherein the product page may include at least one of the title, the price, the description, the picture, the voice description or the video of the product; and coupling the product page with a location on a map based on the first position information.

Other examples of the present invention may provide a method of providing location-based service. The method may include receiving first position information; receiving message information and a value of an expiration time, and generating a web page including the message information, wherein the message information may include at least one of a title, a description, a picture, a voice description or a video, wherein the web page may include at least one of the title, the description, the picture, the voice description or the video; Counting the time after the web page is generated or from the time the web page is set to be valid; Comparing the time and the value of the expiration time to decide if the web page is valid or should be shown; and coupling the web page with a location on a map based on the first position information.

Some examples of the present invention may provide an LBS system. The system may include a position module, a management module and a map information module. The position module may be configured to receive first position information. The management module may be configured to receive product information and generate a product page based on the product information. Moreover, the management module may include a bid module coupled to the product page and configured to receive a bid. The map information module may be configured to couple the product page with a location on a map according the first position information.

Some examples of the present invention may provide a method of providing location-based service. The method may include: receiving first position information; receiving product information and generating a product page based on the product information; receiving a bid through a bid field coupled to the product page; and coupling the product page with a location on a map based on the first position information.

Some examples of the present invention may also provide an LBS system. The system may include a position module, a management module and a map information module. The position module may be configured to receive first position information and updated position information after the first position information. The management module may be configured to receive product information, and generate a product page based on the product information. The map information module may be configured to couple the product page with a first location on a map corresponding to the first position information. Moreover, the map information module may couple the product page with a second location on the map corresponding to the updated position information when the position module receives the updated position information.

Other examples of the present invention may provide a method of providing location-based service. The method may include: receiving first position information; receiving product information, and generating a product page based on the product information; coupling the product page with a location on a map based on the first position information; receiving updated position information about the product information; and coupling the product page with the updated position information when receiving the receive updated position information.

Other examples of the present invention may also provide an LBS system. The system may include a position module, a management module, a map information module and a report module. The position module may be configured to receive first position information. The management module may be configured to receive product information, and generate a product page based on the product information. The map information module may be configured to couple the product page with a location on a map according the first position information. Moreover, the report module may be configured to receive a report indicating the location in connection with the product page is incorrect.

Examples of the present invention may provide a method of providing location-based service. The method may include: receiving first position information; receiving product information; generating a product page based on the product information; coupling the product page with a location on a map based on the first position information; and receiving a report indicating the location in connection with the product page is incorrect.

Examples of the present invention may also provide a first LBS widget (which is also an application module). The first LBS widget may be configured to receive first position information (e.g., coordinates or latitude and longitude), transmit product information and show a tag or an icon coupled to a product page corresponding to the product information and located at a location representing the first position information on a map. The product information may include or be related to at least one of a title, a price, a description, a picture, a voice description or a video of a product. The product page may include at least one of the title, the price, the description, the picture, the voice description or the video of the product.

In these examples, the first LBS widget may further include an instant messenger configured to receive a question about the product and/or send an answer about the question.

In these examples, the product page may further include a bid field configured to place a bid to make an offer to purchase the product, to purchase the product directly, or reserve the product.

In these examples, the product page may further include a report button configured to generate a report to indicate the location related to the product page is incorrect on the map.

In these examples, the first LBS widget may be configured to receive updated position information (or current position information received by the first LBS widget) and send the updated position information to change the location related to the product page on the map. The product page will be coupled to a new point on the map according to the updated position information after the first LBS widget sends the updated position information. In these examples, the first LBS widget may send the updated position information only if the change of the position information received is larger than or equal to a difference limitation.

Examples of the present invention may also provide a second LBS widget. The second LBS widget may be configured to receive second position information, transmit a keyword for searching product information about a product related to the keyword and show a tag or an icon coupled to a product page corresponding to the product information and located at a location representing position information near the second position information on a map. The product information may include or be related to at least one of a title, a price, a description, a picture, a voice description or a video of a product. The product page may include at least one of the title, the price, the description, the picture, the voice description or the video of the product.

In these examples, the second LBS widget may further include an instant messenger configured to send a question about the product and/or receive an answer about the question.

In these examples, the product page may further include a bid field configured to make an offer to purchase the product, to purchase the product directly, or reserve the product.

In these examples, the product page may further include a report button configured to generate a report to indicate the location related to the product page is incorrect on the map.

Some examples of the present invention may provide an LBS widget. The LBS widget may include a positioning module, a map module and an LBS promotion module. The positioning module may be configured to receive first coordinates. The map module may be configured to show a part of a map on a first UI, wherein the part of the map comprises a first location corresponding to the first coordinates. Moreover, the LBS promotion module may be configured to receive product information and second coordinates related to a promoted product page and mark a second location corresponding to the second coordinates on the part of the map.

Other examples of the present invention may also provide an LBS widget. The LBS widget may include a positioning module, an LBS promotion module and a first UI. The positioning module may be configured to receive first coordinates. The LBS promotion module may be configured to receive product information and second coordinates related to a promoted product page. The first UI may include an LBS promotion region, Moreover, the LBS promotion module may be configured to show the product information related to the promoted product page in the LBS promotion region if a distance between the first coordinates and the second coordinates is smaller than or equal to a distance limit.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1A is a block diagram illustrating a location-based service system according to an example of the present invention;

FIG. 1B is a block diagram illustrating a location-based service system according to another example of the present invention;

FIG. 1C is a block diagram illustrating a location-based service system according to still another example of the present invention;

FIG. 2A is a diagram illustrating an input window for the first position information according to an example of the present invention;

FIG. 2B is a diagram illustrating an input window for the product information according to an example of the present invention;

FIG. 2C is a diagram illustrating a communication-module-related window according to an example of the present invention;

FIG. 2D is a diagram illustrating a communication-module-related window according to another example of the present invention;

FIG. 3A is a diagram illustrating an input window for the second position information according to an example of the present invention;

FIG. 3B is a diagram illustrating an product-page window according to an example of the present invention;

FIG. 3C-1 is a diagram illustrating a communication-module-related window according to an example of the present invention;

FIG. 3C-2 is a diagram illustrating a communication-module-related window according to an example of the present invention;

FIG. 3C-3 is a diagram illustrating a communication-module-related window according to an example of the present invention;

FIG. 3D is a diagram illustrating a search-field window according to another example of the present invention;

FIG. 3E-1 is a diagram illustrating a search-result window according to another example of the present invention;

FIG. 3E-2 is a diagram illustrating a search-result window according to another example of the present invention;

FIG. 3F-1 is a diagram illustrating an product-page window according to another example of the present invention;

FIG. 3F-2 is a diagram illustrating a report window according to another example of the present invention;

FIG. 4A is a block diagram illustrating a location-based service system according to an example of the present invention;

FIG. 4B is a block diagram illustrating a location-based service system according to another example of the present invention;

FIG. 4C is a block diagram illustrating a location-based service system according to still another example of the present invention;

FIG. 5A is a diagram illustrating input window for the message information according to an example of the present invention;

FIG. 5B is a diagram illustrating a communication-module-related window according to an example of the present invention;

FIG. 5C is a diagram illustrating a communication-module-related window according to an example of the present invention;

FIG. 6A is a diagram illustrating a web-page window according to an example of the present invention;

FIG. 6B-1 is a diagram illustrating a communication-module-related window according to an example of the present invention;

FIG. 6B-2 is a diagram illustrating a communication-module-related window according to an example of the present invention;

FIG. 6B-3 is a diagram illustrating a communication-module-related window according to an example of the present invention;

FIG. 6C-1 is a diagram illustrating a search-result window according to another example of the present invention;

FIG. 6C-2 is a diagram illustrating a search-result window according to another example of the present invention;

FIG. 6D-1 is a diagram illustrating a web-page window according to another example of the present invention;

FIG. 6D-2 is a diagram illustrating a broken-appointment window according to another example of the present invention;

FIG. 7 is a flowchart illustrating a method of providing a location-based service according to an example of the present invention;

FIG. 8 is a flowchart illustrating a method of providing a location-based service according to another example of the present invention;

FIG. 9A is a flowchart illustrating a method of providing a location-based service according to still another example of the present invention;

FIG. 9B is a flowchart illustrating a method of providing a location-based service according to yet another example of the present invention;

FIG. 10A is a flowchart illustrating a method of providing a location-based service according to still another example of the present invention;

FIG. 10B is a flowchart illustrating a method of providing a location-based service according to yet another example of the present invention;

FIG. 11A is a flowchart illustrating a method of providing a location-based service according to still another example of the present invention;

FIG. 11B is a flowchart illustrating a method of providing a location-based service according to yet another example of the present invention;

FIG. 11C is a flowchart illustrating a method of providing a location-based service according to still another example of the present invention;

FIG. 12A is a flowchart illustrating a method of providing a location-based service according to still another example of the present invention;

FIG. 12B is a flowchart illustrating a method of providing a location-based service according to yet another example of the present invention;

FIG. 13 is a flowchart illustrating a method of providing a location-based service according to still another example of the present invention;

FIG. 14 is a flowchart illustrating a method of providing a location-based service according to yet another example of the present invention;

FIG. 15A is a flowchart illustrating a method of providing a location-based service according to still another example of the present invention;

FIG. 15B is a flowchart illustrating a method of providing a location-based service according to yet another example of the present invention;

FIG. 16A is a flowchart illustrating a method of providing a location-based service according to still another example of the present invention;

FIG. 16B is a flowchart illustrating a method of providing a location-based service according to yet another example of the present invention;

FIG. 16C is a flowchart illustrating a method of providing a location-based service according to still another example of the present invention;

FIG. 17A is a flowchart illustrating a method of providing a location-based service according to still another example of the present invention;

FIG. 17B is a flowchart illustrating a method of providing a location-based service according to yet another example of the present invention;

FIG. 18A is a block diagram illustrating an LBS widget according to an example of the present invention;

FIG. 18B is a diagram illustrating a handwriting generated by moving/wielding a second computing device according to an example of the present invention;

FIG. 18C is a diagram illustrating a handwriting generated by moving/wielding a second computing device according to another example of the present invention;

FIG. 18D is a block diagram illustrating an authorization module according to an example of the present invention;

FIG. 18E is a plot of Matlab simulation result of generating a handwriting with the authorization module shown in FIG. 18D;

FIG. 18F is a block diagram illustrating an LBS widget according to another example of the present invention;

FIG. 19 is a diagram illustrating an input window for the product information according to an example of the present invention;

FIG. 20A is a diagram illustrating an UI of an LBS widget according to an example of the present invention;

FIG. 20B is a diagram illustrating an UI of an LBS widget according to another example of the present invention;

FIG. 20C is a diagram illustrating an UI of an LBS widget according to still another example of the present invention;

FIG. 20D is a diagram illustrating an UI of an LBS widget according to other example of the present invention;

FIG. 21A is a diagram illustrating an UI of an LBS widget for configuring an LBS promotion according to an example of the present invention;

FIG. 21B is a diagram illustrating an UI of an LBS widget for configuring an LBS promotion according to another example of the present invention;

FIG. 21C is a diagram illustrating selected categories of the UI in FIG. 21B;

FIG. 22A is a flowchart illustrating a method of adding product information into an LBS promotion according to an example of the present invention;

FIG. 22B is a flowchart illustrating a method of providing an LBS according to an example of the present invention;

FIG. 22C is a flowchart illustrating a method of providing an LBS according to another example of the present invention;

FIG. 23A is a diagram illustrating an input window for the first position information according to an example of the present invention;

FIG. 23B is a diagram illustrating an input window for the product information according to an example of the present invention;

FIG. 23C is a diagram illustrating a window that shows a product page according to an example of the present invention;

FIG. 23D is a diagram illustrating a communication-module-related window according to another example of the present invention;

FIG. 24A is a diagram illustrating a search-field window according to an example of the present invention;

FIG. 24B-1 is a diagram illustrating a search-result window according to an example of the present invention;

FIG. 24B-2 is a diagram illustrating the change of the search-result window shown in FIG. 24B-1;

FIG. 24B-3 is a diagram illustrating a search-result window according to another example of the present invention;

FIG. 24C-1 is a diagram illustrating a communication-module-related window according to an example of the present invention; and

FIG. 24C-2 is a diagram illustrating a communication-module-related window according to another example of the present invention.

### DETAILED DESCRIPTION OF THE INVENTION

Reference will now be made in detail to the present examples of the invention, examples of which are illustrated in the accompanying drawings. Wherever possible, the same reference numbers will be used throughout the drawings to Referring to the same or like parts.

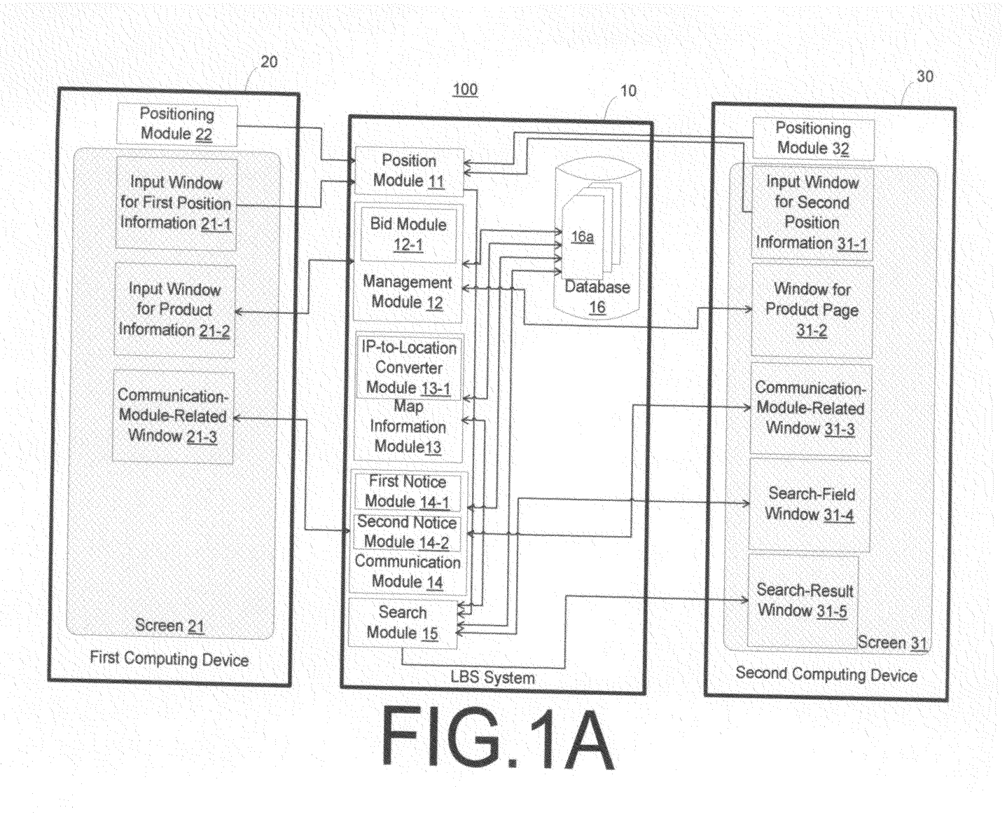

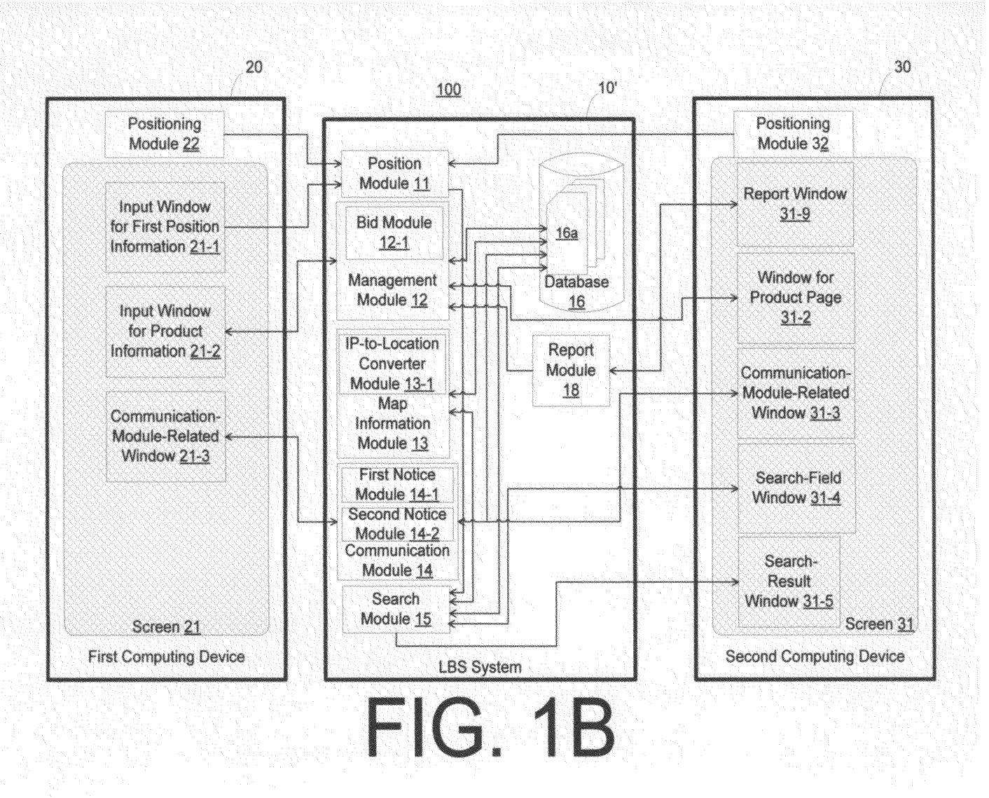

FIG. 1A is a block diagram illustrating a location-based service (LBS) system 10 according to an example of the present invention. Referring to FIG. 1A, the LBS system 10 may couple to a first computing device 20 or a second computing device 30. In one example, the LBS system 10 may be formed, installed or configured in a server or a computer as software, for example, a program (e.g., called an “LBS system program”) including instructions in JAVA codes, HTML codes, XML codes, PHP codes, JSP codes or SQL codes executed by a CPU(s) and/or co-processor(s) based on an web platform (e.g., Apache) in an OS environment (e.g., Windows or Linux) of the server or the computer, or hardware, for example, a card (a PCB board) having an interface to couple to/with the motherboard of the server or the computer. Those skilled in the art can easily understand that the server or the computer may have only one CPU (processor) or a set of CPU(s) (including the coprocessor(s)), and thus the present invention is not limited to the number of the CPU(s). In another example, the first computing device 20 or the second computing device 30 may include at least one of a television (TV), a personal computer (PC), a laptop or notebook, a cellular phone (mobile phone), a personal digital assistant (PDA), a navigator (GPS), a digital camera, a video camera, a projector or a device equipped with a projector module, a mobile device, a portable media player (PMP), an electronic book (e-book), a web pad (webpad), an information appliance (IA), a walk-man or MP3 player, a TV gamer, a handheld garner, an electronic dictionary or a car computer.

The LBS system 10 may include a position module 11, a management module 12 and a map information module 13. The position module 11 may be configured to receive first position information. The first position information may include at least one of latitude and longitude (coordinates), a name of an attraction or a landmark that can be used to identify one's current location (e.g., “I am near the Golden Gate Bridge”, etc.), an address or an IP address come from the first computing device 20. In one example, the first computing device 20 may send the first position information, such as its coordinates received by a GPS module (which usually has an antenna to receive GPS signals including coordinates from satellites and a GPS chip for demodulating/decoding the GPS signals) embedded in the first computing device 20, related to its location to the LBS system 10. In another example, the position module 11 may be implemented as a first program (or a subprogram of a program, e.g., the LBS system program mentioned above) or a first routine (or a subroutine) of the LBS system 10 executed by a processor (e.g., the CPU(s) and/or co-processor(s) of the server) of the server for forming/generating a first web application or a first task to receive the first position information and conducting the first position information to related parts of the LBS system 10. In this example, the first program (subprogram) or the first routine (subroutine) may include a first set of instructions in web programming code(s) that control the operation(s) or function(s) of receiving the first position information in the server. The web programming code(s) may include JAVA codes, HTML codes, XML codes, PHP codes or JSP codes. In still another example, the position module 11 may be implemented as a specific hardware module, for example, a chip including at least a part of an ASIC that receives the first position information and coupling the first position information to the other parts (e.g., the production management module 12) of the LBS system 10. In this example, the chip may be mounted on the motherboard of the server directly, or mounted on or coupled with a card coupled with or inserted in a slot of the motherboard of the server (i.e., a PCB board having an interface that can communicate with the motherboard of the server). Those skilled in the art can easily understand that a hardware-implemented position module 11 may take advantages as being executed faster than a software-implemented position module 11, but its cost may be higher.

The management module 12 may be configured to receive product information, and generate a product page 16a based on the product information. The management module 12 may generate/open an input window 21-2 coupled to the management module 12 and configured to receive input about the product information inputted by a user (or a seller). In one example, the product information may usually be transmitted as packets (e.g., internet packets) or a bit stream (or a plurality of bit streams) through a communication channel (i.e., the channel from the first computing device 20 to the LBS system 10, for example, through internet or cellular network including telecommunication equipment). The product information may include or be related to at least one of a title (e.g., include the name of the product), a price, a description, a picture, a voice description or a video of a product. In this example, the product information may be filled into corresponding field of a template by the management module 12 to generate the product page 16a (e.g., the template may include a title field for the title of the product page, and the title included in the product information may be filled into the title field correspondingly by the management module 12 for forming the product page 16a, and so on).

The product page 16a may show at least one of the title, the price, the description, the picture, the voice description or the video of the product. The product page 16a may be stored in a database 16. In one example, the product page 16a may be stored in the database 16 as a file (or a set of files) including HTML or XML codes (or flash or Java scripts) related to the product information (e.g., it may be stored as a file named “xxx.htm”, etc.). When the second computing device 30 receives the product page 16a (the file(s)), it may apply a compiler or a browser to compile/parse the HTML codes or the XML codes (or execute the flash or Java script) and show the product page 16a in a window (e.g., the window 31-2 for product pages) on a screen 31 of the second computing device 30 (i.e., the product page 16a is stored as the file including the HTML or XML codes in the database 16, and will be transmitted as packets or a bit stream to the second computing device 30 to be executed, compiled or parsed and shown as a web or within the window 31-2 on the screen 31).

The management module 12 may further include a bid module 12-1. In one example, the product page 16a may include a bid field for a user to place a bid to the product described on the product page 16a. The bid module 12-1 in this example is capable of being coupled with the bid field of the product page 16a to receive the bid. Moreover, the bid module 12-1 may be configured to be used to set up a selling period and a minimum reserve, wherein the selling period is the duration that the user can place bids on the product through the product page 16a, and thus the selling period can be used to identify if the product page 16a is valid (Valid or not valid depends on the selling period expires or not). For example, if the selling period of the product page 16a expires, the window 31-2 will show that the item (product) is ended or the product page 16a (or the product) is removed, or the bid module 12-1 (the bid field of the product page 16a) can no longer receive a bid or a question, etc. Once the selling period expires, no further actions can be done to the product page 16a. The minimum reserve can be used to identify/determine if a bid is effective (valid) or not based on if an offer (i.e., a price that the user is willing to or wants to purchase the product) of the bid is higher than the minimum reserve or not. The bid will be considered as effective if the offer of the bid is higher than the minimum reserve. In other example, after receiving the bid, a communication module 14 (included in the LBS system 10) may send a notice to let the seller who sells the product through the product page 16a know that someone has placed a bid on his/her item (or someone is interested in his/her product).

In another example, the bid module 12-1 may be configured to set up a buy-it-directly price. In this example, the bid module 12-1 may couple to a bid field of the product page 16a to receive a bid from a user through the bid field. Once the bid module 12-1 receives the bid, which means the user wants to buy the product with the buy-it-directly price, the status of the product shown on the window 31-2 will become “sold (sold out)” or “ended”. In still other example, after receiving the bid, the communication module 14 may send a notice to let the seller who sells the product through the product page 16a know that someone confirms to purchase the product with the buy-it-directly price.

In other example, similarly, the bid module 12-1 may couple to a bid field of the product page 16a to receive a bid, wherein the status of the product shown on the window 31-2 will become “reserved” once the bid module 12-1 receives the bid. That is, when the product page 16a including the bid field is shown as the window 31-2 on the screen 31 of the second computing device 30, if a user places the bid to the bid module 12-1 through the bid field, it means the user wants to reserve the product (or an item of the product) or make reservation on the product (perhaps the product is intangible such as providing a service like hair-cutting, spa or booking a table, etc.). Those skilled in the art can easily understand that, in examples of the present invention, the product does not necessarily be a tangible good. Services are another kind of products and thus the product mentioned in this specification should not be limited to be tangible. In yet other example, after receiving the bid, the communication module 14 may send a notice to let the seller know the user wants to make a reservation on his/her product.

Those skilled in the art can easily understand that the management module 12 may be configured/implemented as a second program (or another subprogram, for example, such as another subprogram of the LBS system program as mentioned above) or a second routine (or another subroutine) installed in the serve and executed by a processor (e.g., the CPU and/or the co-processor) of the server to form/generate a second web application or a second task to achieve/provide the abovementioned function(s). In this example, the second program (subprogram) or the second routine (subroutine) may include a second set of instructions also in web programming code(s) that control the operation(s) or function(s) of receiving the product information, generating the product page accordingly and/or other management function(s) to the product pages. Similarly, in this example, the web programming code(s) may include JAVA codes, HTML codes, XML codes, PHP codes, JSP codes or SQL codes (e.g., a set of instructions to control and/or access database 16 or 19 (will be discussed later) in SQL data structure). In other example, the management module 12 may be configured/implemented as a specific hardware module, for example, at least a part of an ASIC providing the abovementioned function within the LBS system 10. Those skilled in the art can easily understand that a hardware-implemented management module may take advantages that it can be executed faster than a software-implemented management module. However, the former may cost higher than the later.

From the abovementioned examples of the present invention, the product page 16a may be configured to couple with the communication module 14. In addition to the notice(s) sent in the abovementioned situation (s), the communication module 14 may also be configured to receive a question about the product (to ask the seller about the product). The communication module 14 may include a first notice module 14-1 configured to send a first notice to inform the seller (or the user who carries or posts the product page 16a) of the product someone has asked a question to his/her product (e.g., color(s), size(s), arrival time(s), etc.).

The communication module 14 may also be configured to receive an answer provided by the seller about the question. Moreover, the communication module 14 may include a second notice module 14-2 configured to send a second notice to inform the user who asks the question his/her question has been answered when the communication module 14 receives the answer.

The aforementioned mechanisms or methods of applying the modules of the LBS system 10 to ask questions and receive answers will be further described and illustrated in examples hereinafter.

In still another example, at least one of first notice module 14-1 or the second notice module 14-2 may include at least one of a question and answer (Q&A) module, an e-mail module or an instant messenger (IM) module. The Q&A module may be configured to provide a input field on the window 31-2 or another window called communication-module-related window 31-3 for the user to enter/submit his/her questions and receive/see the answers. The e-mail module may be used to send the first or the second notice by emails to inform the user or the seller. In one example, the emails may include not only the notices but also the contents of the question or the answer. The IM module may be configured to peer-to-peer transfer the notices, and the notices will be shown in the communication-module-related window 31-3 directly or immediately once the question or the answer is received. Those skilled in the art can easily understand that the first notice module 14-1 can be implemented as a first instant messenger and the second notice module 14-2 can be implemented as a second instant messenger, separately, wherein the former solely handles a job (or jobs) of sending a first message when the communication module 14 receives a question about the product, while later solely handles a job (or jobs) of sending a second message when the communication module 14 receives an answer related to the question about the product.

Similarly, the communication module 14 may be configured/implemented as a program (or subprogram) or a routine (or subroutine) installed or run by a processor (perhaps a CPU or its co-processor) of the server including the LBS system 10 to achieve/provide the above-mentioned function. In other example, the communication module 14 may be configured/implemented as a specific hardware module, for example, at least a part of an ASIC providing the above-mentioned function within the LBS system 10. Those skilled in the art can easily understand that a hardware-implemented communication module may take advantages that it can be executed faster than a software-implemented communication module. However, the former may cost higher than the later.

In other example, a communication-module-related window 21-3 coupled with the communication module 14 and shown on the screen 21 of the first computing device 20 may be configured to receive input about the answer, the first notice, the question or other notice.

Therefore, the communication-module-related window 31-3 coupled with the communication module 14 and shown on the screen 31 of the first computing device 30 may be configured to receive input about the question, the second notice, the answer about the question or other notice.

The map information module 13 may be configured to couple the product page 16a to a location (or a point) on a map based on or corresponding to the first position information. In one example, the first position information may include at least one of latitude and longitude (or coordinates), a name of an attraction or a landmark, an address or an IP address related to the product page and the map information module 13 may be configured to find a location (or a point) related/corresponding to the at least one of the latitude and longitude, the name of the attraction or the landmark, the address or the IP address, and couple the product page 16a to the location on the map.

In one example, the latitude and longitude (the coordinates) may be usually received by the GPS module in the first computing device 20 as discussed above. A positioning module 22 formed in the first computing device 20 (and perhaps coupled with the GPS module) may receive the latitude and longitude (the coordinates) from the GPS module and send the latitude and longitude (the coordinates) to the position module 11. In another example, if a user enters an address or a name (a related keyword) of an attraction or a landmark to identify his/her current location, the positioning module 22 may look up coordinates corresponding to the attraction, the landmark or the address by sending a query to a map system and then the positioning module 22 may receive the corresponding coordinates from the map system. An example of the map system may be found as the Google Map. In this example, the positioning module 22 may look up the corresponding coordinates through the Google Map API.

In other examples that users enter an address or a name (a related keyword) of an attraction or a landmark to identify his/her current location, the positioning module 22 may also send the name (the keyword) or the address to the position module 11 and the position module 11 may then send the name (the keyword) or the address to the map system to look up (to get) the corresponding coordinates of the attraction, the landmark or the address. Those skilled in the art can easily understand that the positioning module 22 or the position module 11 may also be capable of looking up corresponding coordinates of an IP address of the first computing device 20 (or the second computing device 30) by an IP-to-address system thru its API.

Similarly in one example, the positioning module 22 may be configured/implemented as a program (or subprogram) or a routine (or subroutine) installed or run by a processor (perhaps a CPU or a microprocessor/micro-controlling unit or micro-controller) of the first computing device 20 to execute jobs of receiving the first position information and sending the first position information to the position module 11 of the LBS system 10. In another example, the positioning module 22 may be configured/implemented as a specific hardware module, for example, at least a part of an ASIC doing the receiving job for receive the first position information and redirecting the first position information to the position module 11 of the LBS system 10. Again, those skilled in the art can easily understand that a hardware-implemented positioning module may take advantages as being executed faster than a software-implemented positioning module. However, the former may cost higher than the later.

In another example, a user may input a name of an attraction or a landmark, such as a name of a place, a tour attraction, a bus or train stop/station or a historic spot to the LBS system 10 through an input window 21-1 coupled with the position module 11. The map information module 13 coupled with the position module 11 to receive the first position information may be configured to look for corresponding location(s) (point(s)) on the map related to the words (or keyword(s)) of the name of the attraction or the landmark.

In other example, the IP address may be used to identify its corresponding location on the map. In this example, the map information module 13 may further include an IP-to-location converter module 13-1. The IP-to-location converter module 13-1 may be configured to find the location corresponding to the IP received on the map, since each packet transmitted in interne may comprises an IP address of where it from, and usually a server who redirects or handles the routing of the packet may also maintain a mapping table for IP address and its corresponding physical address in the world. The IP-to-location converter module 13-1 may look up the mapping table (perhaps through interne) to find the corresponding location and treat it as the location of the first computing device 20 on the map.

Note that the position module 11 and the map information module 13 may be configured to provide the same or similar function(s) as aforementioned to a positioning module 32 formed in the second computing device 30 to receive second position information related to the location of the second computing device on the map.

Moreover, in one example, the map information module 13 may be configured to identify or to mark the location related to the product page 16a as an icon shown on the map (e.g., a balloon), and at least one of a tag, the window 31-2 showing the product page 16a or a link (or a hyperlink) linking to the product page 16a will be shown once the icon is clicked or selected by a user. In this example, the tag may include at least one of the title, the price, the description, the picture, the voice description or the video of the product page 16a.

In one example, the map may be stored (or buffered) in the storage of the server. In another example, the map may be stored in another server (e.g., a server(s) of the Google Maps) other than the server including the LBS system 10 but coupled with it (in this example, the server storing the map may have a map API for using, accessing or control its map). In both examples, the map information module 13 may couple the product page 16a with the location on the map by storing the coordinates related to the product (or the product page 16a) and relates the coordinates with the product page 16a in the database 16 (e.g., the product page 16a and its related coordinates may be stored in different segments or fields of same single data, or in different data that related to each other (e.g., first data is specific for storing the coordinates and second data is specific for storing information of product pages)).

In another example, the map may be stored in the storage of the first computing device 20 or the second computing device 30 (or buffered in the computing device 20 or 30 from the server providing the map). In this example, when demonstrating the location of the product page 16a on the map, the map information module 13 may transmit the position information (e.g., the coordinates, the address or other information related to the location of the product of the product page 16a) to the computing device 20 or 30 and an LBS widget installed in the computing devices 20 or 30 may demonstrate the location with the map stored in the computing devices 20 or 30 by placing a mark, a button, a tag or an icon on the map (i.e., no map is transmitted but only the coordinates are transmitted. The map in the computing device 20 or 30 will point out the location corresponding to the received coordinates and show the piece of the map around the location then). Later if the mark, the button, the tag or the icon is clicked/selected by a user, the LBS widget may send a request to the LBS system 10 and the LBS system 10 may transmit a product page(s) corresponding to the clicked/selected mark, button, tag or icon (in this example the product page 16a) to the computing device 20 or 30 and the LBS widget may show the product page in another window (e.g., with another user interface, etc.).

Moreover, in one example, the map information module 13 may also be configured/implemented as a third program (or subprogram) or a third routine (or subroutine) installed or executed by a processor (e.g., the CPU and/or the co-processor) of the server to achieve/provide the abovementioned function. In this example, the third program (subprogram) or the third routine (subroutine) may include a third set of instructions in web programming code(s) that control the operation(s) or function(s) of coupling the product page 16a with the location on the map by referring to the coordinates related to/stored with the product page 16a. Also, in this example, when the tag or the icon (or the link) related to the product page 16a is clicked/pushed, first the management module 12 may fetch the data of the product page 16a in the database 16 with its related coordinates, and the map information module 13 may fetch a region of the map (which is data of a partial map or a piece of the map) accordingly to the coordinates (e.g., a region having default or predetermined size/range that includes or surrounds the location represented by the coordinates on the map) to show the region together with the icon or the tag on the screen 21 or 31 (e.g., to show the partial map and the icon/tag on it with a browser or a UI of a widget). The map information module 13 may therefore include JAVA codes, HTML codes, XML codes, PHP codes, JSP codes or SQL codes for accessing the map (no matter it is directly coupled to the map or can only access the map with the map API).

In other example, the map information module 13 may be configured/implemented as a specific hardware module, for example, at least a part of an ASIC providing the above-mentioned function within the LBS system 10. Those skilled in the art can easily understand that a hardware-implemented map information module may take advantages that it can be executed faster than a software-implemented map information module. However, the former may cost higher than the later.

Further, the LBS system 10 may include a search module 15. The search module 15 may be configured to receive a keyword and the second position information (i.e. about the location of the second computing device 30). The keyword may be entered through a search field 323 shown in a search-field window 31-4, or recognized from a word pronounced by a user by the help of voice recognition to form a keyword.

Similarly, the second position information may include at least one of latitude and longitude (coordinates), a name of an attraction or a landmark, an address or an IP address related to the location of the second computing device 30 (which is also used to send the keyword). In addition, the search module 15 may be configured to compare the keyword with words in at least one of product information, product pages (including the product page 16a perhaps) or icons related to locations (or the corresponding points to the locations) within a range (perhaps a predetermined range) near the location on the map corresponding to the second position information or centered by the location on the map corresponding to the second position information to find at least one of product information, a product page or an icon related to the keyword as a search result if the at least one of product information, the product pages or icons related to the keyword exists. Moreover, the scope of the range may be designed to be settable or adjustable depending on domain(s), type(s) or area a use wants to search or the domain(s) the keyword belongs to. For example, a first range adopted to search for a real estate may be larger/bigger than a second range used to search for a hamburger.

Moreover, the map information module 13 may be configured to show a region of the map (or a part of the map) including at least a part of the range centered by the location corresponding to the second position information or near the location corresponding to the second position information on the map in a search-result window 31-5 shown on the screen 31 of the second computing device 30 to locate the search result generated by the search module 15 with respect to the keyword. In one example, the search module 15 may be configured to mark the location of or related to the search result as the icon or the tag in the region, wherein the icon or the tag is configured to link to or to show at least one of corresponding product page or product information if the icon or the tag is pressed, clicked or selected.

In one example, the search module 15 may be configured/implemented as a program (or subprogram) or a routine (or subroutine) installed or run by a processor (perhaps a CPU or its co-processor) of the server including the LBS system 10 to achieve/provide the above-mentioned function. In other example, the search module 15 may be configured/implemented as a specific hardware module, for example, at least a part of an ASIC providing the abovementioned function within the LBS system 10. Those skilled in the art can easily understand that a hardware-implemented search module may take advantages that it can be executed faster than a software-implemented search module. However, the former may cost higher than the later.

Moreover, those skilled in the art can easily understand that the aforementioned position module 11, management module 12, map information module 13, communication module 14 and/or search module 15 may be embodied as hardware (e.g., combinational logic, circuit, or a chip), software or partially hardware and partially software (or firmware). In the software embodiment of the present invention, the CPU of the server (not shown) may execute the software program (or programming codes) about at least one of the modules of the LBS system 10 stored in storage or memory of the server (also not shown) or control at least some of the modules of the LBS system 10 to achieve the corresponding aforementioned functions of the LBS system 10.

Moreover, although the management module 12 and the search module 15 are illustrated separately in FIG. 1A, those skilled in the art can easily understand that the search module 15 can be embedded/included as a sub-module (or a subprogram or a subroutine of the management module 12 if both are implemented as software) of the management module 12 in other embodiment of the present invention.

Moreover, as the LBS system 10 functions, corresponding user interface(s) or window(s) may show on the screen 21 of the first computing device 20 or the screen 31 of the second computing device 30. In one example, the screen 21 may show the input window 21-1 coupled with the position module 11 and configured to receive input about the first position information inputted by the user (or the seller) who uses the first computing device 20. In another example, the screen 21 may show the input window 21-2 coupled with the management module 12 and configured to receive input about the product information inputted by the user (or the seller). In other example, the screen 21 may show the communication-module-related window 21-3 coupled with the communication module 14 and configured to receive input about an answer, the first notice, the question or other notice.

Moreover, those skilled in the art can also understand that if the first computing device 20 includes the GPS module and the positioning module 22 is configured to couple with the GPS module for receiving the coordinates of the first computing device 20, then the input window 21-1 is not necessary since the coordinates (i.e., the first position information) can be automatically received by the positioning module 22 from the GPS module and sent to the position module 11.

Similarly, the screen 31 may show a input window 31-1 coupled with the position module 11 and configured to receive input about the second position information from for a user (or a buyer). Those skilled in the art can also understand that if the second computing device 30 includes the GPS module and the positioning module 32 is configured to couple with the GPS module for receiving the coordinates of the second computing device 30, then the input window 31-1 is not necessary.

In prior art, position information of map information is always fixed (e.g., the coordinates of a gas station may not change every hour). However, by adopting the LBS system 10 of the present invention, position information of map information (i.e., the aforementioned shown on the map) can change frequently. For example, position information of a real-estate broker may be changing every hour since he/she may show up in different locations of houses he/she sells/introduces. Online shopping embodied by the LBS system 10 of the present invention could be another example. In this example, a seller may go anywhere and sell product he/she brings and thus his/her location on the map of the LBS system 10 will change every minute or hour according to his/her updating coordinates.

To this end, the positioning module 22 (which may be formed in the seller or the broker's first computing device) may receive updated position information from the GPS module after the first position information and send the updated position information (or the updating position information) to the position module 11 frequently (or periodically). Then the map information module 13 may couple the product page with a new location on the map corresponding to the updated position information when the position module 11 receives the updated position information.

In one embodiment of the present invention, the period that the positioning module 22 sends updated position information according to can designed to be changeable or adjustable by the user (e.g., the seller or the broker) or the system designer of the LBS system 10.

Since periodically/frequently sending position information to the position module 11 may consume battery power of the first computing device, in one embodiment of the present invention, the positioning module 22 may send new position information as the updated position information to the position module 11 only when the difference between the new position information and the previous position information (i.e., the position information the positioning module 22 receives from the GPS module last time) or the first position information is larger than or equal to a difference limitation (which means the seller or the broker has left “far enough” from his/her original location).

In one example, the management module 12 may also be configured to execute at least one of showing the product page 16a is invalid, cancelling the product page 16a or withdrawing the product page 16a when the difference between the updated position information and the first position information is larger than or equal to a difference limitation.

FIG. 1B is a block diagram illustrating an LBS system 10′ according to another example of the present invention. Referring to FIG. 1B, the LBS system 10′ may be similar to the LBS system 10 described and illustrated with reference to FIG. 1A, except that the LBS system 10′ may further include a report module 18 and may cause the screen 31 of the second computing device 30 to show a report window 31-9 coupled with the report module 18. In conventional location-based service field, users may seldom or never have chances to express their views or give their opinions to the correctness of map information shown on an electronic map. For example, if the map information is changed (e.g., a store is closed down, a house is rebuilt or a road is changed), a user may have to arrive the point to find the change, and it may waste time or make the user confused. To the LBS system 10′ of the present invention, the map information includes the product information, and the product information may change more rapidly than the change of the map information of those prior art. For example, a product may be sold out anytime, or a seller may add or cancel a product page immediately and these could may the map information of the map provided by the LBS system 10′ change rapidly. Therefore, when the user (e.g., a customer) arrives a place which is marked as the location on the map related to the product page 16a (or related to the product information), if he/she found the location shown on the map is incorrect (e.g., can't find the seller or the product being sold at the place, etc.), he/she can use his/her cellular phone (i.e., the second computing device 30) to open the report window 31-9 on its screen 31, and push (click, press of select) a report button 399 to generate a report to the LBS system 10′ (will be described and illustrate with reference to FIG. 3F-1 and 3F-2) to indicate that the location of the product page 16a is incorrect.

The report module 18 may be configured to receive the report indicating the location in connection with the product page 16a is incorrect. In one example, the report module 18 may cause the management module 12 to execute at least one of showing the product page 16a is invalid (or the location of it is incorrect), cancelling the product page 16a, withdrawing the product page 16a or making other users cannot place a bid through the product page 16a.

Sometimes, if the management module 12 takes the above-mentioned action(s) to the product page 16a only based on a single user's report, it may be unfair since, for example, a competitor of the seller of the product page 16a may deliberately try this way to cause the product page 16a to be cancelled. In order to prevent the report module 18 from becoming a tool for this kind of vicious competition, in one example, the report module 18 may be configured to count the number of reports generated by different users about the product page 16a, and the report module 18 will cause the management module 12 to execute the at least one of showing the product page 16a is invalid, cancelling the product page 16a or withdrawing the product page 16a if the number of reports achieves or exceeds a first limited number. Note that in some examples the first limited number could also be set as “1” and it will cancel the place a bid function of the product page or causes the product page 16a be cancelled or marked as invalid if the product page 16a is reported once.

Moreover, in order to ensure the effectiveness of the report, to location-based service field, it may be suitable to follow the rule—“to see is to believe”. Therefore, the report module 18 may be configured to compare position information of the second computing device the use uses to generate the report with the first position information related to the product page 16a (i.e., the location shown on the map), and the report will be determined to be valid only if the difference between the two position information is smaller or equal to a difference limitation, which means when generating the report, only if the user's location is really close to the location related to the product page 16a, he/she can judge if the location is wrong or right.

Moreover, in still another example, the report module 18 may be configured to count the number of the abovementioned valid reports generated by different users to the product page 16a, and the report module 18 will cause the management module 12 to execute the at least one of showing the product page 16a is invalid, cancelling the product page 16a or withdrawing the product page 16a if the number of valid reports achieves or exceeds a second limited number. Note that in some examples the second limited number could also be set as “1”.

FIG. 1C is a block diagram illustrating an LBS system 10″ according to still another example of the present invention. Referring to FIG. 1C, the position module 11, the search module 15 and some windows on the screen 21 or 31 that related to the modules 11 and 15 are not shown for simplifying the illustration. The LBS system 10″ may be similar to the LBS system 10 or 10′ described and illustrated with reference to FIG. 1A or 1B, except that the LBS system 10″ may further include a registration/login module 17. The registration/login module 17 may be coupled with an account database 19. Also, the registration/login module 17 may cause the screen 21 of the first computing device 20 to show a registration/login window 21-6 coupled with the registration/login module 17.

In prior art, a system (e.g., a website) or a widget coupled to a remote server or system may identify identification of a user (or a member) by comparing an account and a password entered by the user or codes included in a card or a device for the system to detect or recognize (e.g., IMEI in a cellular phone or a serial number of a USB drive) with the an account and its password or codes set or stored in database (e.g., user database) of the system to check if the two are matched or identical. Traditionally the passwords or codes are usually composed of characters, and it is possible to be guessed or cracked.

Moreover, when executing a login procedure, except providing a field for entering passwords, some systems or websites may also provide a figure together with another field for a user to enter characters, symbols or numbers corresponding to what he/she reads in the figure. The purpose of this is to prevent a hacker to use a robot to attack/crack the systems because only humans can recognize the characters, symbols or numbers shown in the figure. However, it may still be cracked by applying image recognition to the figure each time and sometimes it is not convenient for a user to see the figure and enter characters according to the figure.

Therefore, the LBS system 10″ of the present invention may provide a mechanism to identify identification of a user by comparing his/her current position information and position information registered with his/her account, except that to ask the user to enter his/her codes, account or password(s). It may increase a level of protection from hacking or cracking the LBS system 10″ since the position information registered in the LBS system 10″ may not easily be known (e.g., it may be latitude and longitude having many digits) and also be convenient since positioning modules in the computing devices coupled to the LBS system 10″ may be configured to send current position information it receives when the user tries to login the system, and the LBS system 10″ may compare the current position information and a registered position information related to an account automatically.

The registration/login module 17 may be configured to record position information related to an account into the account database 19 when the account is registered. In this example, the registration/login module 17 may be configured to receive data including the account, a password related to the account or other personal details entered by a user (e.g., a seller) who wants to register the account into the LBS system 10″ through the registration/login window 21-6 coupled with the registration/login module 17. When registering the account, position information related to the user may also be registered and stored in the account database 19. In one example, the registered position information may come from an address entered in the registration/login window 21-6 by the user when registering, and the registration/login module 17 may look up position information corresponding to the address entered as the registered position information. In another example, the registered position information may come from position information received by the positioning module 22 when the user registered his/her account (i.e., the position information of the first computing device 20 when it is used by the user to register the account).

In this example, the registration/login module 17 may be configured to compare current position information of the first computing device 20 when the first computing device 20 is used to login the LBS system 10″ and the position information stored in the account database 19 when the user tries to login the LBS system 10″ with the account. Also in this example, the account will be allowed to login the LBS system 10″ if the difference between the current position information of the first computing device 20 and the registered position information stored in the account database 19 is smaller or equal to a first difference limitation (e.g., the maximum difference or distance between coordinates of the two position information that allowable to login the LBS system 10″).

In another example, the management module 12 may be configured to compare (perhaps by the help of the registration/login module 17) position information of the first computing device 20 when the first computing device 20 sends product information related to the registered position information stored in the account database 19 (i.e., when the management module 12 receives the product information). A product page related to the product information will be generated if the difference between the two position information is smaller or equal to a second difference limitation (e.g., the maximum difference or distance between coordinates of the two position information that the position information will be considered as being sent by the user who owns the account or knows the registered position information of the account).

Similarly, cheating about online shopping may happen when a criminal cracks a seller's account, pretends to be the seller of a product sold by the seller, and deliberately answering a question about the product online to lead a customer (who asks the question) to transfer his/her money to a wrong account. To prevent this fault, the communication module 14 may be configured to compare (perhaps by the help of the registration/login module 17) position information of the first computing device 20 when the first computing device 20 is used to send the answer with the registered position information stored in the account database 19 when the communication module 14 receives the answer about the question. The answer will be considered as valid if the difference between the two position information is smaller or equal to a third difference limitation (e.g., the maximum difference or distance between coordinates of the two position information that the position information of the first computing device 20 may still be recognized as being used by the user or to send the answer when the user grants).

Those skilled in the art can easily understand that the user who owns/registers the account may use other computing device (other than the one who uses to register the account) to login the LBS system 10″, generate a product page or answer the question. If the current position information related to the location where his/her uses the other computing device to login the LBS system 10″ is within a range (e.g., points within the range are all different from the registered position information with a difference less than or equal to the first or the second difference limitation) near the registered position information, the login will still be successful, corresponding product page will still be generated or the answer will still be valid, respectively.

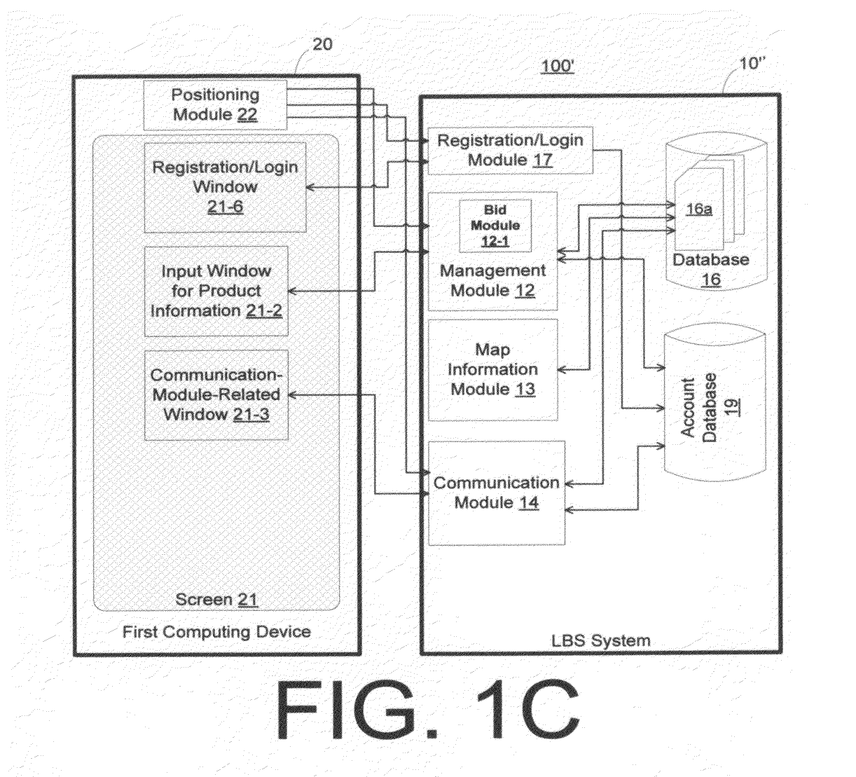

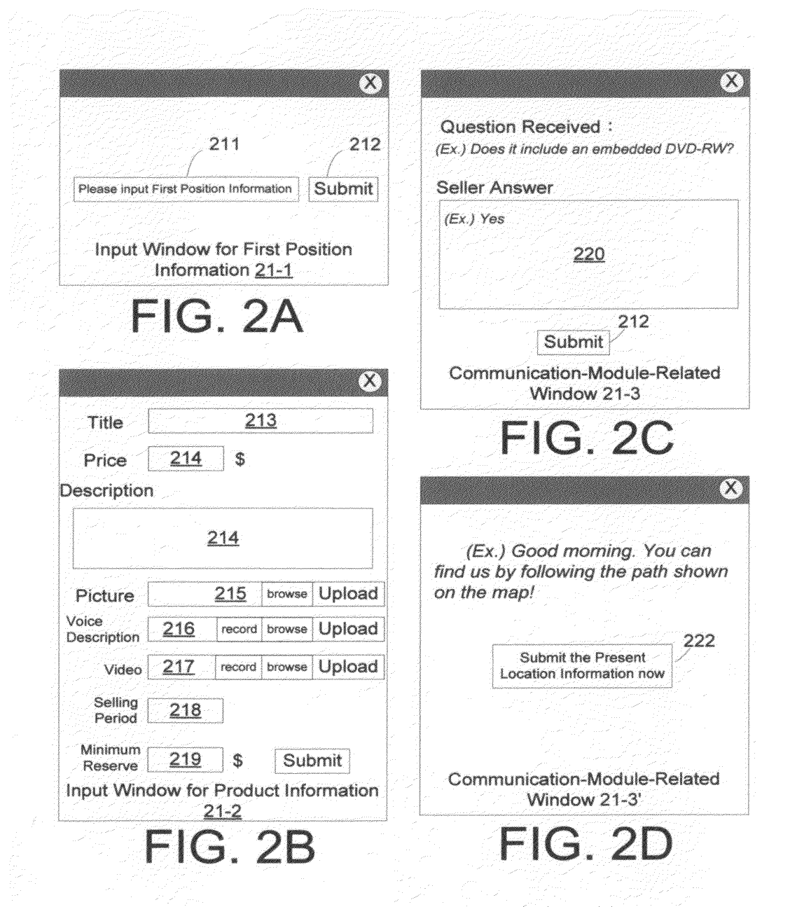

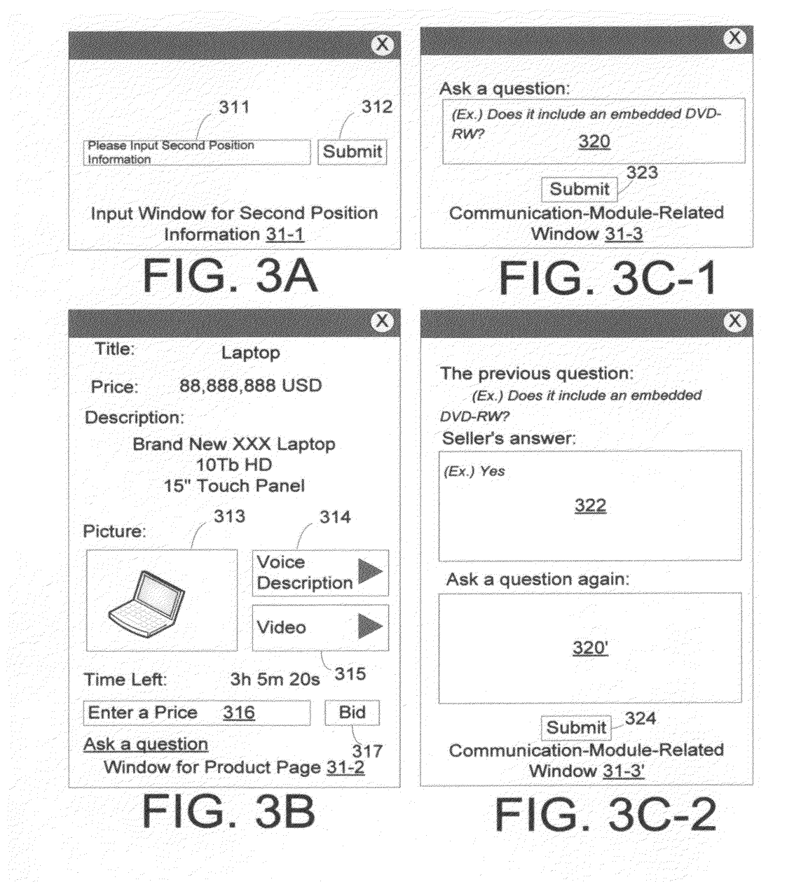

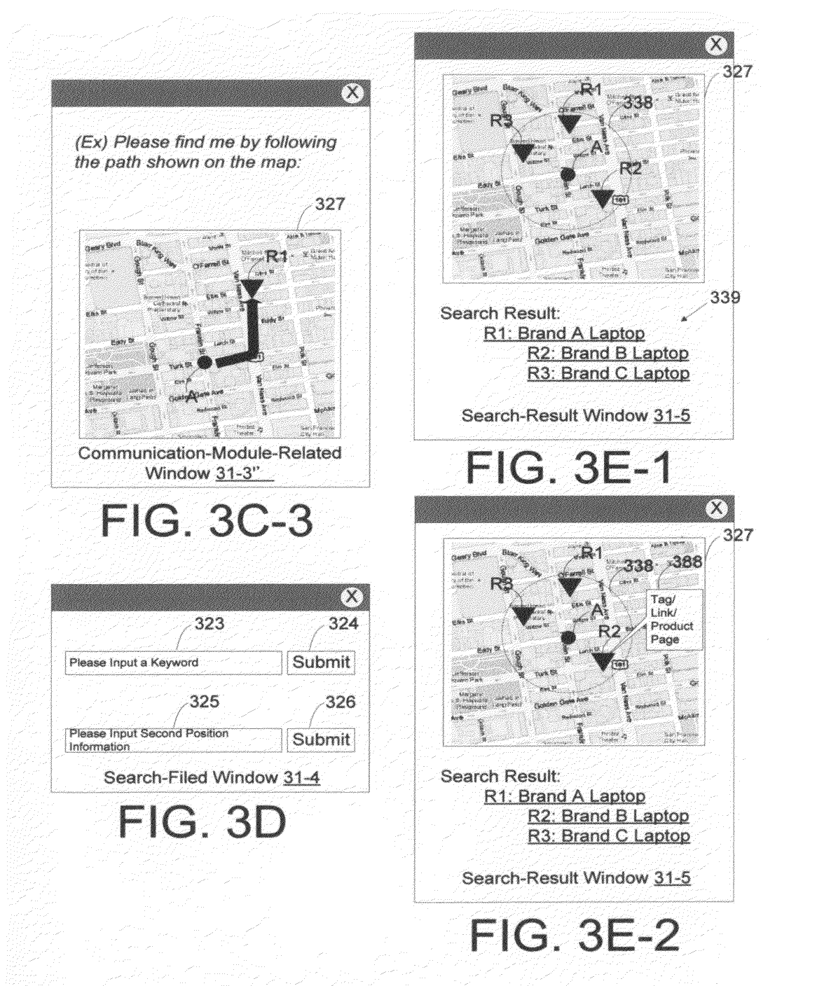

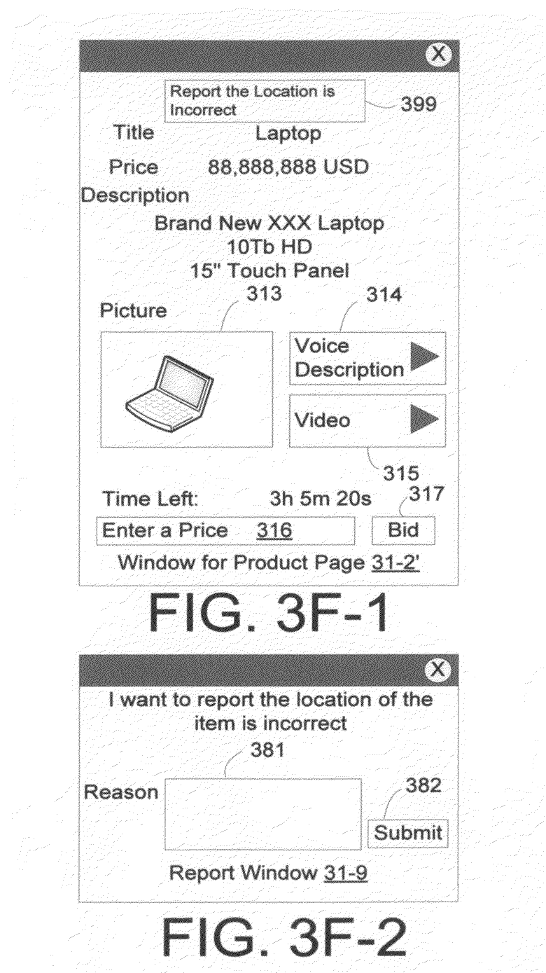

Exemplary windows related to or coupled with the aforementioned modules that could be shown on the screen 21 or 31 may be described and illustrated hereafter with reference to FIGS. 2A to 3F-2. Those skilled in the art can easily understand that these windows may only be examples for explaining some embodiments of the present invention, but should not be the limitation of the scope of the present invention.

FIG. 2A is a diagram illustrating the input window 21-1 according to an example of the present invention. Referring to FIG. 2A, the input window 21-1 may include an input field 211 for a user to enter/input first position information and a submit button 212 for the user to submit the first position information he/she enters to the LBS system 10. In one example, the user may enter his/her address or the address of his/her current location, a name of an attraction or a landmark (or a famous place) as his/her first position information and send the first position information to the position module 11 after clicking the submit button 212.

FIG. 2B is a diagram illustrating the input window 21-2 according to another example of the present invention. Referring to FIG. 2B, the input window 21-2 may include a title field 213 and a price field 214, wherein title field 213 may be configured to enter the title of the product page 16a and the price field 214 may be configured to enter the price of the product. In one example, the price field 214 may be configured to enter a starting price (a starting bid) of the product for customer to make an offer or place a bid having a price higher than the starting price. In another example, the price field 214 may be configured to enter the buy-it-directly price of the product.

Moreover, the input window 21-2 may include a description field 221 configured to enter the description of the product. The input window 21-2 may also include a figure-file-path field 215 for the user (the seller) to enter an archive path directing to a figure file including the image (picture or drawing) of the product. The user may enter the archive path directed to the figure file, or use the browsing button (not numbered) to look for the archive path of the figure file. After clicking the upload button (not numbered), the figure file will be uploaded to the LBS system 10.

Similarly, the input window 21-2 for the product information may further include a voice-description-file-path field 216 or a video-file-path field 217 for uploading the files about the voice description or the video of the product, respectively. Moreover, if the first computing device 20 is equipped with a microphone, a camera or a video camera, or coupled with a microphone, a camera or a video camera, the seller may be able to take a picture or record a voice description or a video about the product directly (e.g., by clicking the record button to begin to record the voice description or the video). For example, the seller may be able to take a picture or a video about his/her item by his/her cellular phone and then enter the name and/or price of it to submit to the LBS system 10 and generate a corresponding product page quickly thru a widget coupling with the LBS system 10 and integrated with the aforementioned functions of taking picture/video and uploading.

Moreover, the input window 21-2 may include a selling-period field 218 or a minimum-reserve field 219 for the seller to setup the selling period or the minimum reserve, respectively. Moreover, all the aforementioned settings or files related to the input window 21-2 will be uploaded to the management module 12 after a submit button (not number) in the input window 21-2 is clicked.

FIG. 2C is a diagram illustrating the communication-module-related window 21-3 according to an example of the present invention. Referring to FIG. 2C, the communication-module-related window 21-3 may show the question received by the communication module 14 (in this example, the question is “Does it include an embedded DVD-RW?”). The communication-module-related window 21-3 may provide a message input field 220 for the seller to enter his/her response/answer the question about the product (in this example, the response/answer to the question is “Yes”). The response/answer will be sent to the user (the customer) who asks the question about the product by the help of the communication module 14 after the submit button 212 is clicked. In another example, the message input field 220 may be configured to receive characters or voice (e.g., turn on a microphone or a recorder of the first computing device 20 to record the seller's oral answer).

FIG. 2D is a diagram illustrating a communication-module-related window 21-3′ according to another example of the present invention. Referring to FIG. 2D, a seller may be able to send his/her current position information to a customer by clicking a button 222 to submit the current location information. In one example, if the customer receives the seller's position information, a route corresponding to a path from the location related to current position information of the customer to the location related to the seller's current position information may be shown in a map 327 of a communication-module-related window 31-3″ (see FIG. 3C-3).

FIG. 3A is a diagram illustrating the input window 31-1 according to an example of the present invention. Referring to FIG. 3A, the input window 31-1 may include an input field 311 for the user to enter the second position information and a submit button 312 for submitting the second position information after entering. Similarly, the user may enter his/her address or the address of his/her current location, a name of an attraction or a landmark (or a famous place) as his/her first position information and send the first position information to the position module 11 after clicking the submit button 312.

FIG. 3B is a diagram illustrating the window 31-2 for showing the product page 16a according to an example of the present invention. Referring to FIG. 3B, the window 31-2 may show a product page (e.g., the product page 16a) including at least one of the title (e.g., “Laptop”), the price (e.g., “88,888,888 USD”), the description (e.g., “Brand New XXX Laptop,” “10Tb HD” and “15” Touch Panel“) or the picture or the selling period of the product (e.g., “Time Left: 3 h 5 m 20 s”). In one example, the window 31-2 may also provide a voice-description play button 314 or a video play button 315 for the user (the customer) to click and play the voice description or the video of the product, respectively.

Moreover, the window 31-2 may further include a bid field 316, the user (buyer) may be able to place a bid or make an offer to the product by entering a price into the bid field 316, and submit the bid or the offer after clicking the bid button 317 to the management module 12. In one example, when the offer price of the bid is larger than or equal to the minimum reserve, the bid module 12-1 will determine that the bid is valid. In another example, when the selling period expires, the bid module 12-1 will consider the bid (perhaps from a plurality of bids placed for buying the product) having highest offer price to be the winning bid, and a user who places the winning bid will win the product by paying the offer price of the winning bid.

In another example, when a link—“Ask a question” shown on the window 31-2 is clicked, the communication-module-related window 31-3 will be shown.

FIG. 3C-1 is a diagram illustrating the communication-module-related window 31-3 according to an example of the present invention. A communication process of the window 31-3 may be similar to the communication process of the window 21-3 described and illustrated with reference to FIG. 2C.

FIG. 3C-2 is a diagram illustrating a communication-module-related window 31-3′ according to another example of the present invention. Similarly, a communication process of the window 31-3 may be similar to the communication process of the window 21-3 described and illustrated with reference to FIG. 2C.

FIG. 3C-3 is a diagram illustrating the communication-module-related window 31-3″ according to other example of the present invention. Referring to FIG. 2D again, after receiving the seller's current location information (which is sent after the seller clicks the button 222 to submit it), the second computing device 30 will open the communication-module-related window 31-3″ after receiving the seller's current position information, and the route corresponding to the path from the location related to the current position information of the second computing device 30 (i.e., the customer's current position information) to the location related to the seller's current position information may be shown in the map 327 of a communication-module-related window 31-3″.

FIG. 3D is a diagram illustrating the search-field window 31-4 according to an example of the present invention. Referring to FIG. 3D, the search-field window 31-4 may include the search field 323 and a submit button 324, wherein the input field 323 may be configured for the user to enter a keyword and submit the keyword to the search module 15 by clicking the submit button 324.

In one example, if the second computing device 30 does not include the GPS module, a second-position-information-input field 325 and a submit button 326 will also be provided in the search-field window 31-4, wherein the second-position-information-input field 325 may be used to enter the second position information and send it to the search module 15 after the submit button 326 is clicked.

In this example, the search module 15 may be configured to search at least one of product information, product pages, tags or icons with locations locates with in a range (perhaps a predetermined range, see a range 338 in FIG. 3E-1) near the location on the map corresponding to the second position information or centered by the location on the map corresponding to the second position information to find product information, a product page or an icon related to the keyword after receiving the keyword and the second position information.

FIG. 3E-1 is a diagram illustrating the search-result window 31-4 according to another example of the present invention. Referring to FIG. 3E-1, the map information module 13 may be configured to mark locations related to the search result on the map 327 with icons R1, R2 or R3. In one example, the search-result window 31-4 may show the locations related to the search result within the range 338 (by marking the locations with icons such as the icons R1, R2 or R3 in this example) centered by a location A (i.e., the location of the second computing device 30 in this example). In another example, the search result may also be described below (e.g., “R2: Brand B Laptop,” etc.).

When the icon R1 (or R2 or R3) is selected, a tag 388 associated with the icon R1 may be shown for example. The tag 388 may include at least one of the product page 16a or the link (or hyperlink) that can be used to link to the product page, as shown in FIG. 3E-2. In one example, the tag 388 may further include at least one of the title, the price, the description, the picture, the voice-description-play button or the video-play button related to the product page 16a.

FIG. 3F-1 is a diagram illustrating a product-page window 31-2′ according to another example of the present invention. Referring to FIG. 3F-1, the product-page window 31-2′ may be similar to the product-page window 31-2 described and illustrated with reference to FIG. 3B, except that a report button 399 may also be provided in the product-page window 31-2′. The report button 399 may be used in a situation as follows:

One day, Joseph wants to buy a brand B laptop. He uses his second computing device 30 to open the search-field window 31-4 and enter a keyword “XXX laptop”. Later, the search-result window 31-5 shows that there is a seller selling the brand B laptop at the location marked as the icon R2 around his location A on the map 327. Then, he goes for the seller as indicated on the map 327. However, he finds that actually there is no seller selling the brand B laptop at the location in the real world. Then he may reopen the window 31-2′ again and click the report button 399 to indicate that there is no such seller at the location in the world (the location related to the product page or the icon R2 is incorrect).

In another example, after the report button 399 is clicked, the report window 31-9 may be opened on the screen 31. The report window 31-9 may include a reason field 381 for entering the reason why a product page is reported, as shown in FIG. 3F-2. The report including the reason will be sent after a submit button 382 is clicked. In other example, the reason may be reviewed by an administrator of the LBS system 10.

Further, although the aforementioned LBS systems of the present invention take selling products or providing services as examples, one skilled in the art can easily understand that applications like posting career advertisements or finding jobs can also be realized by the LBS systems of the present invention.

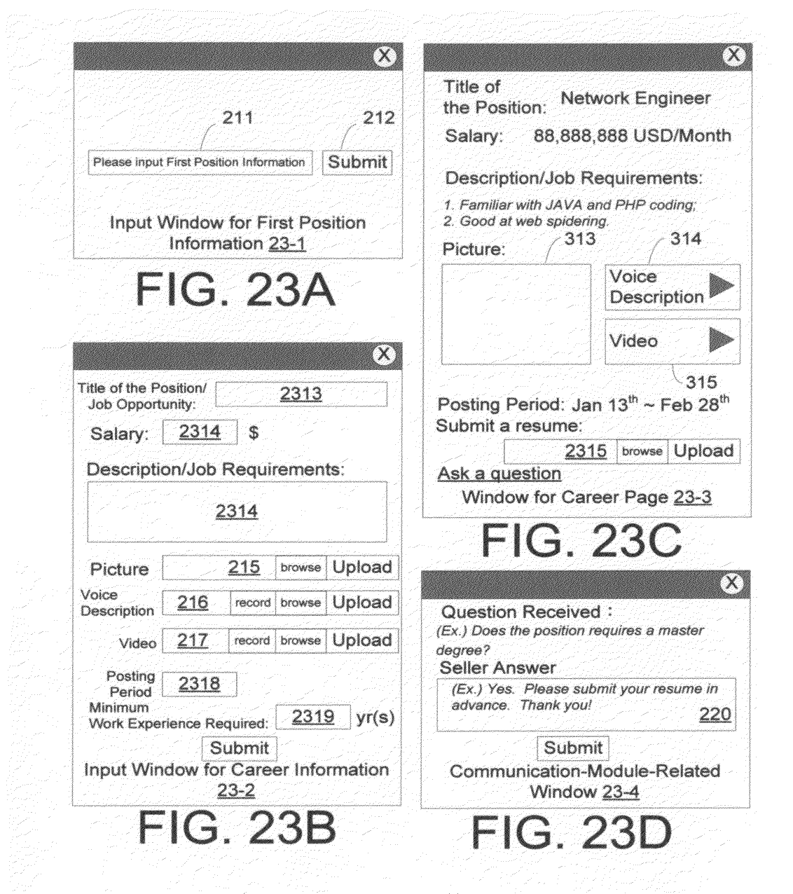

FIGS. 23A to 23D are diagrams illustrating how an employer or a hirer (an HR) posts his/her career advertisement thru the LBS system 10 of the present invention.

FIG. 23A is a diagram illustrating the input window 23-1 for the first position information according to an example of the present invention. Similarly, the employer may input first position information (e.g., an address, a name of an attraction or a landmark (or a famous place) nearby) of a workplace (e.g., a location of his/her company/store) thru the input window 23-1. One skilled in the art can easily understand that if the employer uses a cellular phone having a GPS module to upload information about his/her career advertisement, the employer's coordinates may be treated as default location of the workplace and thus it is not necessary to input the first position information thru the input window 23-1.

FIG. 23B is a diagram illustrating an input window 23-2 for inputting career information according to an example of the present invention. Referring to FIG. 23B, the input window 23-2 is similar to the window 21-2 as aforementioned. The input window 23-2 may include a title field 2313 for entering the title of the position or a job opportunity of a job. In one example, the input window 23-2 may also include a salary field 2314 which can be used to enter the salary (or the range of the salary) of the job. Moreover, the input window 23-2 may include a description (job requirement) field 2314 for the employer to enter the description or the requirement of the job.

Similarly, the input window 23-2 may also include the figure-file-path field 215 for the employer to enter an archive path directing to a figure file (a picture) of the boss or the company/store.

Similarly, the input window 23-2 may further include a voice-description-file-path field 216 or a video-file-path field 217 for uploading the files about the voice description or the video of the job, respectively. In this way, it may help a job seeker/hunter get more idea about the job (e.g., the employer, working environment, the workplace or duty/working load, etc.).

In one example, the employer may be able to setup a posting period that he/she wants to hire an employee for the position thru a posting period field 2318. In another example, the employer may be capable of ending the career advertisement anytime if he/she has already found a candidate or recruit an employee for it by ending the posting in advance.

In other example, the employer may be able to setup a working experience requirement (e.g., similar experience about the job, how many years, etc.) for the job thru a minimum working experience field 2319. In this way, a career page may be generated after the employ uploads the career information of the job, and the working experience requirement will be shown on the career page too. Moreover, current condition of the position may also be shown on the career page (e.g., ended, occupied, etc.).

FIG. 23C is a diagram illustrating a window that shows a product page according to an example of the present invention. Referring to FIG. 23C, the input window 23-3 may be similar to the window 31-2 as aforementioned. The window 23-3 may show the career page including at least one of the title (e.g., “Network Engineer”), the salary (e.g., “88,888,888 USD/Month”), the description (e.g., “Familiar with JAVA and PHP coding”, and “Good at web spidering”), the picture 313 or the posting period (e.g., “Jan 13^{th} to Feb 28^{th}”). In one example, the window 23-3 may also provide a voice-description play button 314 or a video play button 315 for a user (the job seeker) to click and play the voice description or the video of the career, respectively.

Moreover, the window 23-3 may further include a resume-submitting field 2315. The user may be able to submit the file of his/her resume to the employer thru the resume-submitting field 2315.

Furthermore, the career page may also include a link called “Ask a question”. When the link is clicked, communication-module-related windows 24-3 or 24-3′ will be shown (it will be described and illustrated with reference to FIGS. 24C-1 and 24C-2 later).

FIG. 23D is a diagram illustrating a communication-module-related window 23-4 according to another example of the present invention. Referring to FIG. 23D, the communication-module-related window 23-4 may be configured to be used by the employer to answer a question come from the job seeker.

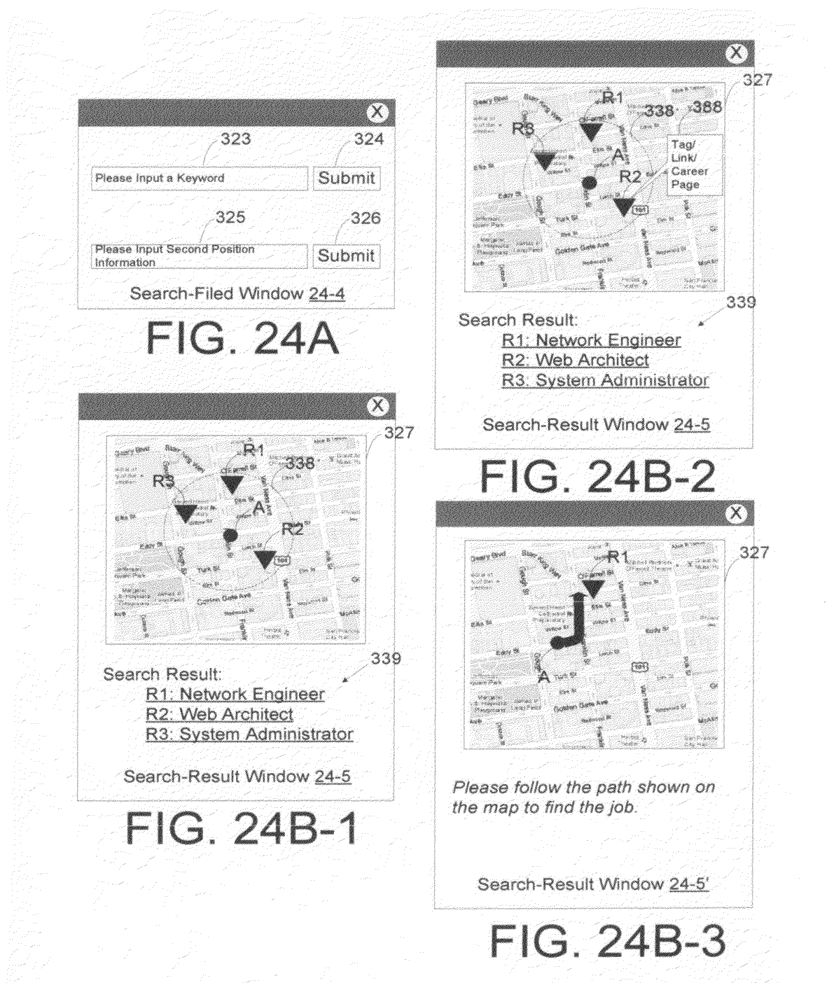

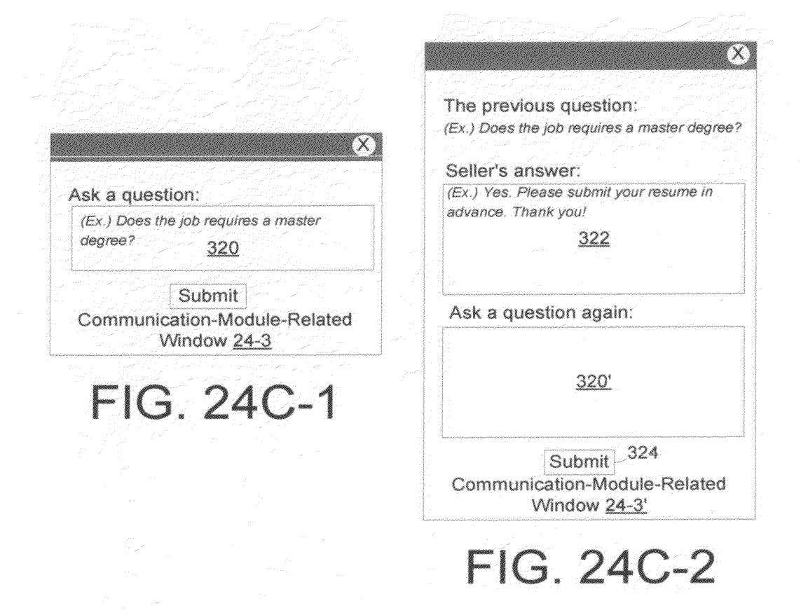

FIG. 24A is a diagram illustrating a search-field window 24-4 according to an example of the present invention. Referring to FIG. 24A, the search-field window 24-4 may be similar to the search-field window 31-4 as aforementioned that the user (the job seeker) can input a keyword a position/job he/she wants to find thru the field 323 and perhaps enter the location he/she wants to go for working thru the field 325. One skilled in the art can easily understand that if the user uses a second computing device having a GPS module (e.g., a cellular phone) to search jobs in the LBS system 10, the user's coordinates (the second position information) received by the GPS module may be sent to the position module 11 of the LBS system 10 and be treated as the location the user wants to find a job. Therefore in this example, it is not necessary to input the second position information thru the field 325.

FIG. 24B-1 is a diagram illustrating a search-result window 24-5 according to an example of the present invention. Referring to FIG. 24B-1, the search-result window 24-5 may be similar to the search-result window 31-5 as aforementioned. After searching, the search module 15 may transmit search results to the second computing device and the search results may be shown on the map 327 of the search-result window 24-5 as being point out (or marked) as icons R1, R2 and R3 (i.e. the location of the search results). In region 339, brief introductions/descriptions of the search results are shown (e.g., R1 represents a job opportunity about Network Engineer, etc.).

FIG. 24B-2 is a diagram illustrating the change of the search-result window 24-5 shown in FIG. 24B-1. Referring to FIG. 24B-2, when the icon on the map 327 (e.g., R2) is touched, a tag including career information or a career page will be shown (in the tag or with another window).

FIG. 24B-3 is a diagram illustrating a search-result window 24-5′ according to another example of the present invention. Referring to FIG. 24B-3, a path from the user's current location to the location of the job (e.g., the company/store) will be shown on the map 327.

FIG. 24C-1 is a diagram illustrating the communication-module-related window 24-3 for the user to enter his/her question about the job in the field 320 according to an example of the present invention. Moreover, FIG. 24C-2 is a diagram illustrating the communication-module-related window 24-3′ according to another example of the present invention. Referring to FIG. 24C-2, after the employer answers the previous question, if the user still have another question about the job, he/she may be able to enter a new question thru the field 320′. In one example, the communication-module-related windows 24-3 or 24-3′ may be implemented as an instant messenger.

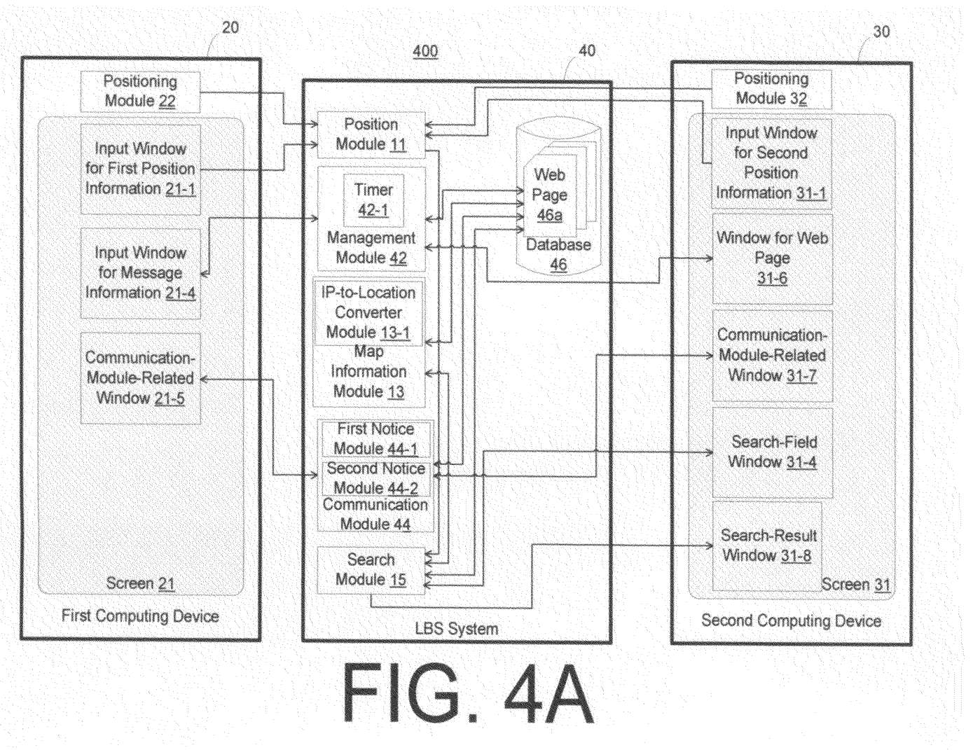

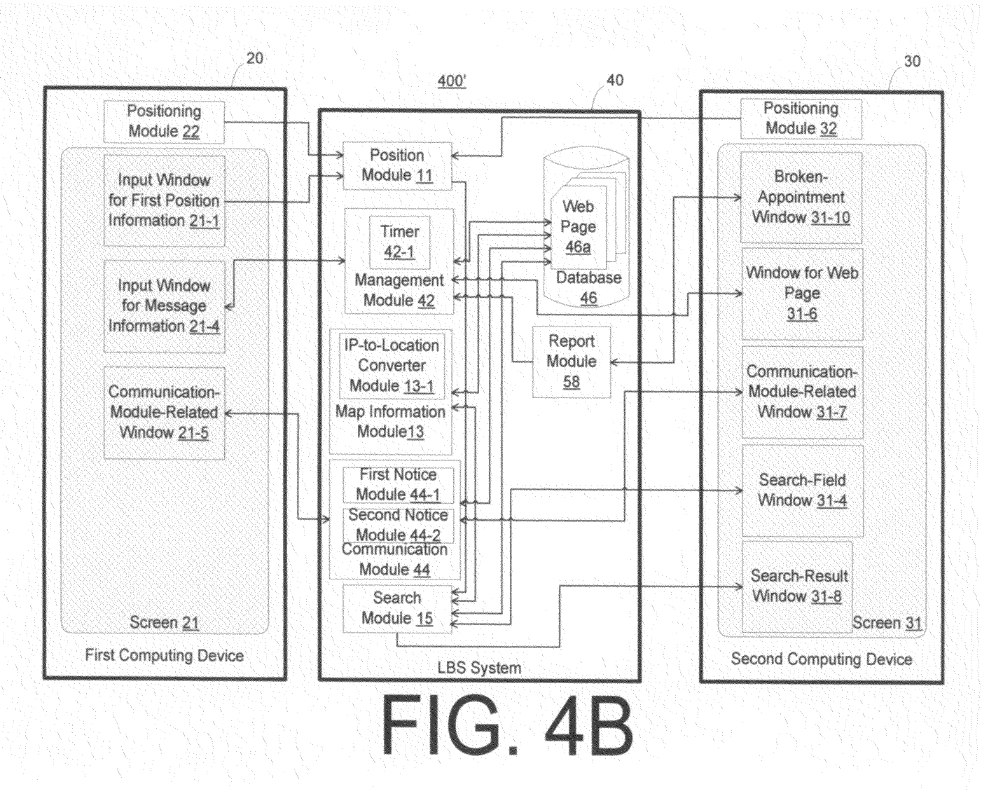

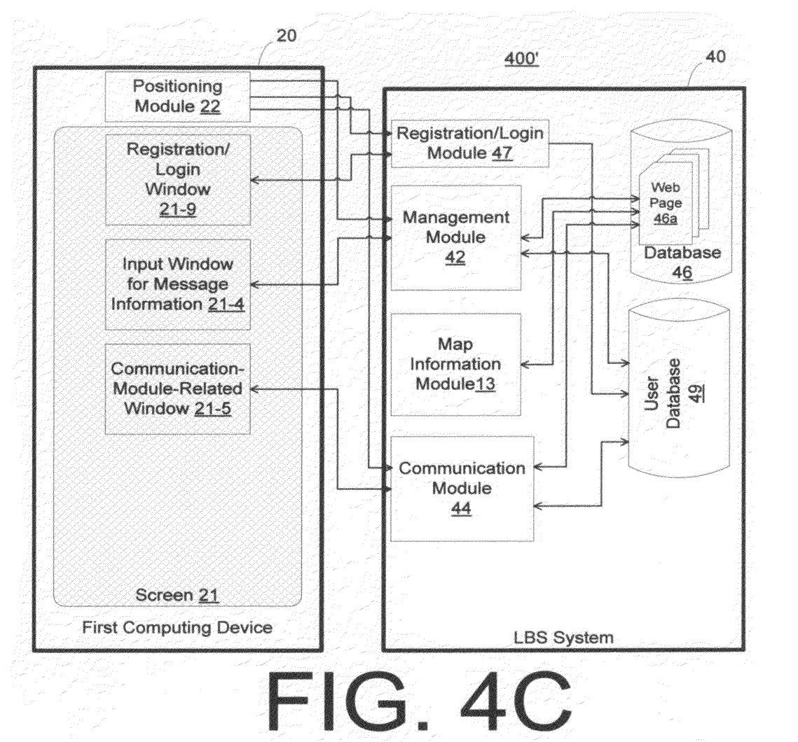

FIG. 4A is a block diagram illustrating an LBS system 40 according to an example of the present invention. Referring to FIG. 4A, the LBS system 40 may be similar to the LBS system 10 described and illustrated with reference to FIG. 1A, except that a management module 42 and a communication module 44 of the LBS system 40 may be different from the management module 12 and the communication module 14.

The management module 42 may be configured to receive message information (e.g., a message a user wants to leave) and a value of an expiration time, and generate a web page 46a to show the message information. In one example, the message information may include at least one of a title, a description, a picture, a voice description or a video. The programming codes or file(s) related to the web page 46a may be stored in a database 46.

In one example, the management module 42 may further include a timer 42-1. The timer 42-1 may be configured to count the time elapsing after the web page 46a is generated, and compare the time and the value of the expiration time to decide if the web page 46a or the message information shown on the web page 46a should still be shown or be marked as valid.

Moreover, communication module 44 may further include a first notice module 44-1 and a second notice module 44-2, wherein first notice module 44-1 may be configured to send a first notice if the communication module 44 receives a first message about the message information (e.g., another user leave another message based on the message information shown on the web page 46a to the user), and second notice module 44-2 may be configured to send a second notice if the communication module receive 44 receives a second message (e.g., the user who generates the web page 46a leaves a new message to response the first message) In one example, at least one of the first notice module 44-1 or the second notice module 44-2 may include at least one of a question and answer (Q&A) module, an e-mail module or an instant messenger module (instant messenger).

Similarly, the screen 21 may be capable of showing a input window 21-4 coupled with the management module 42 for the user to input the message information, except that the screen 21 may show a input window 21-1 coupled with the position module 11 for the user to input his/her address (e.g., of his/her current location). Moreover, the screen 21 may show a communication-module-related window 21-5 coupled with the communication module 44 for the user to receive the first message or input the second message.

Similarly, the screen 31 may be capable of showing a window 31-6 for the user of the second computing device 30 to get/browse the message information, except that the screen 31 may show a input window 31-1 coupled with the position module 11 for the user to input his/her second position information (e.g., the address he/her locates on now). Moreover, may show a communication-module-related window 31-3 coupled with the communication module 44 for the user to send the first message or receive the second message.

Similarly screen 31 may show a search-field window 31-4 and a search-result window 31-8 coupled with the search module 15, to receive a keyword and to show a search result according to the keyword and the second position information, separately.

Those skilled in the art can also understand that the search-field window 31-4 and the search-result window 31-8 may be shown with a single window or with two different windows.

FIG. 4B is a block diagram illustrating an LBS system 40′ according to another example of the present invention. Referring to FIG. 4B, the LBS system 40′ may be similar to the LBS system 40 described and illustrated with reference to FIG. 4A, except that the LBS system 40′ may further include a report module 58 and may cause the screen 31 of the second computing device 30 to show a report window 31-10 coupled with the report module 58.

Because that when a user finds a web page including message information he/she is interested through the LBS system 40′ and tries to go to the location on the map related to the web page to see the user who generates the web page, if the location of the web page is incorrect, or if the user who generates the web page not show up on the location, it may waste his/her time (on a fool's errand). Once the user finds this situation, there may be desirable to have a mechanism for him/her to warn other users not to be cheated by the web page as him/her. To this end, the report module 58 of the LBS system 40′ may provide the report mechanism. Once the user finds he/she is cheated or the user who generates the web page breaks their appointment, he/she may open a broken-appointment window 31-10 and push (press or click) a report button 588 in the window to send a report to the report module 58 for indicting the situation. In one example, there may be a field for him/her to enter the reason why he/she reports the web page and the reason will be send with the report to the report module 58. Then, the management module 42 may execute at least one of showing the web page is incorrect (or the location of it is incorrect), cancelling the web page, withdrawing the web page or making other user(s) cannot find what he/she wants at the location of the web page.

However, if the management module 42 takes the above-mentioned action(s) to the product page 16a only based on a single user's report, it may be unfair since the user who reports may make a mistake or deliberately try this way to cause the web page to be cancelled. In another example, the report module 58 may be configured to count the number of reports generated by different users about the web page, and the report module 58 will cause the management module 42 to execute the at least one of showing the web page is incorrect, cancelling the web page or withdrawing the web page if the number of reports achieves or exceeds a first limited number. Note that in some examples the first limited number could also be set as “1”.

Similarly, in order to ensure the effectiveness of the report, to location-based service field, the LBS system 40′ may follow the rule—“to see is to believe”. Therefore, the report module 58 may be configured to compare position information of the second computing device the use uses to generate the report with the first position information related to the location of the web page, and the report will be determined to be valid only if the difference between the two position information is smaller or equal to a difference limitation, which means when generating the report, only if the user's location is really close to the location of the web page his/her report will be considered as valid.

Moreover, in still another example, the report module 58 may be configured to count the number of the abovementioned valid reports generated by different users to the web page, and the report module 58 will cause the management module 42 to execute the at least one of showing the web page is incorrect, cancelling the web page or withdrawing the web page if the number of valid reports achieves or exceeds a second limited number. Note that in some examples the second limited number could also be set as “1”.

FIG. 4C is a block diagram illustrating an LBS system 40″ according to still another example of the present invention. Referring to FIG. 4C, the search module 15 and some windows on the screen 21 or 31 that related to the modules 11 and 15 are not shown for simplifying the illustration. However, the LBS system 40″ may be similar to the LBS system 40 or 40′ described and illustrated with reference to FIG. 4A or 4B, except that the LBS system 40″ may further include a registration/login module 47. The registration/login module 47 may be coupled with a user database 49. Also, the registration/login module 47 may cause the screen 21 of the first computing device 20 to show a registration/login window 21-9 coupled with the registration/login module 47.

The registration/login module 47 may be configured to record position information related to an account into the user database 49 when the account is registered by the user who uses the first computing device 20. In this example, the registration/login module 47 may be configured to receive data including the account, a password related to the account or other personal details entered by the user who wants to register the account into the LBS system 40″ through the registration/login window 21-9 coupled with the registration/login module 47. When registering the account, position information related to the user may also be registered and stored in the user database 49. In one example, the registered position information may come from an address entered in the registration/login window 21-9 by the user when registering, and the registration/login module 47 may look up position information corresponding to the address entered as the registered position information. In another example, the registered position information may come from position information received by the positioning module 22 in the first computing device 20 coupled with the LBS system 40″ when the user registered his/her account (i.e., the position information of the first computing device 20 when it is used by the user to register the account).

Moreover, the positioning module 22 may be configured to send currently received position information when the user tries to use the first computing device 20 to login the LBS system 40″. In this example, the registration/login module 47 may be configured to compare the current position information of the first computing device 20 when the first computing device 20 is used to login the LBS system 40″ and the position information stored in the user database 49 i.e., when the user tries to login the LBS system 40″ with the account. Also in this example, the account will be allowed to login the LBS system 40″ if the difference between the current position information of the first computing device 20 and the registered position information stored in the user database 49 is smaller or equal to a third difference limitation (e.g., the maximum difference or distance between coordinates of the two position information that allowable to login the LBS system 40″).

In another example, the management module 42 may be configured to compare (perhaps by the help of the registration/login module 47) position information of the first computing device 20 when the first computing device 20 sends message information related to the registered position information stored in the user database 49 (i.e., when the management module 42 receives the message information). A web page related to the message information will be generated if the difference between the two position information is smaller or equal to a fourth difference limitation (e.g., the maximum difference or distance between coordinates of the two position information that the message information will be considered as being sent by the user who owns the account or knows the registered position information of the account).

Moreover, in one example, the communication module 44 may be configured to compare (perhaps by the help of the registration/login module 47) position information of the first computing device 20 (or the second computing device 30) when the first computing device 20 (or the second computing device 30) is used to send a message (or message information) with the registered position information. The message (or message information) will be considered as valid if the difference between the two position information is smaller or equal to a fourth difference limitation.

Those skilled in the art can easily understand that the user who owns/registers the account may use other computing device (other than the one who uses to register the account) to login the LBS system 40″, generate a web page or send a message. If the current position information related to the location where his/her uses the other computing device to login the LBS system 10″ is within a range (e.g., points within the range are all different from the registered position information with a difference less than or equal to the first or the second difference limitation) near the registered position information, the login will still be successful, corresponding product page will still be generated or the message will still be valid, respectively.

Exemplary windows related to or coupled with the aforementioned modules that could be shown on the screen 20 or 30 may be described and illustrated hereafter with reference to FIGS. 5A to 6D-2. Those skilled in the art can easily understand that these windows may only be examples related to some embodiments of the present invention, but should not be the limitation of the scope of the present invention.

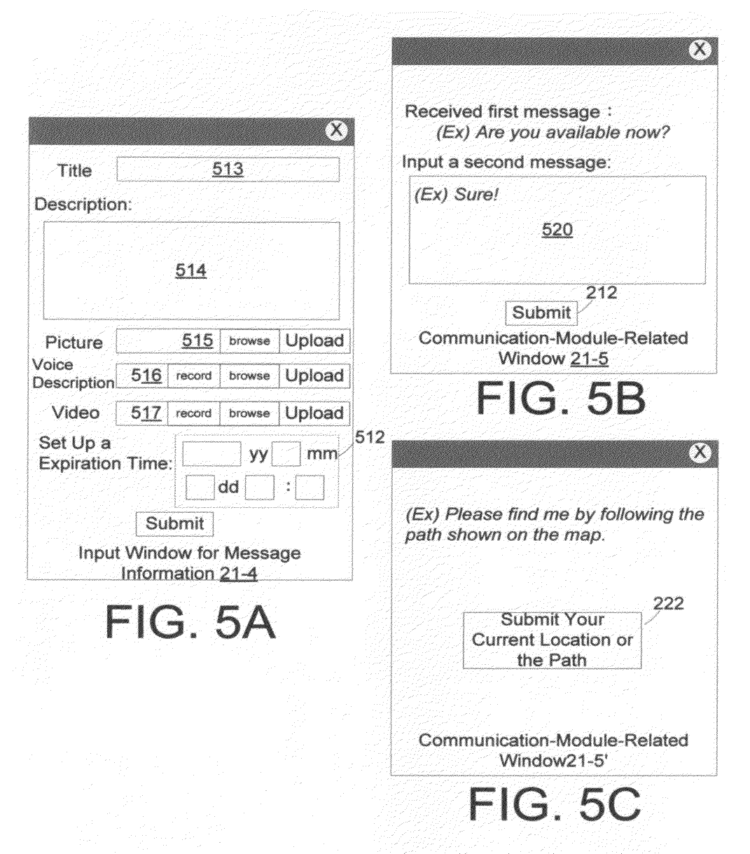

FIG. 5A is a diagram illustrating the input window 21-4 for the message information according to an example of the present invention. Referring to FIG. 5A, the input window 21-4 may be similar to the input window 21-2 described and illustrated with reference to FIG. 2B, except that the input window 21-4 may include fields 512 for setting up the expiration time (i.e., the web page will be valid until the expiration time), instead of fields 218 and 219 for setting the selling period and the minimum reserve.

FIG. 5B is a diagram illustrating the communication-module-related window 21-5 according to an example of the present invention. Referring to FIG. 5B, the communication-module-related window 21-5 may be similar to the communication-module-related window 21-3 described and illustrated with reference to FIG. 2C.

FIG. 5C is a diagram illustrating the communication-module-related window 21-5′ according to an example of the present invention. Referring to FIG. 5C, the communication-module-related window 21-5′ may be similar to the communication-module-related window 21-3′ described and illustrated with reference to FIG. 2D.

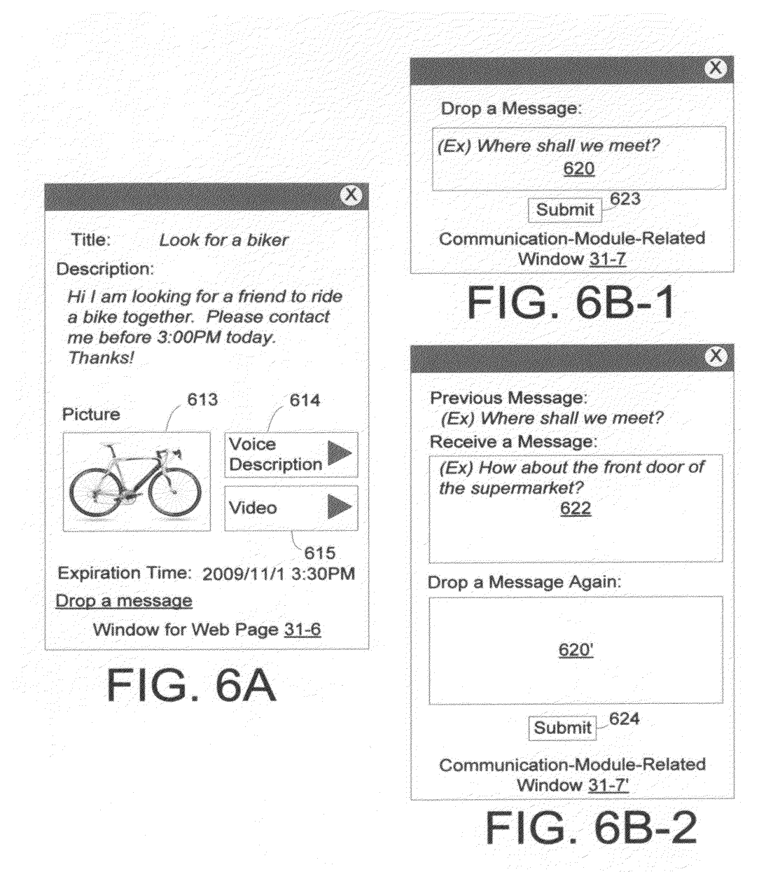

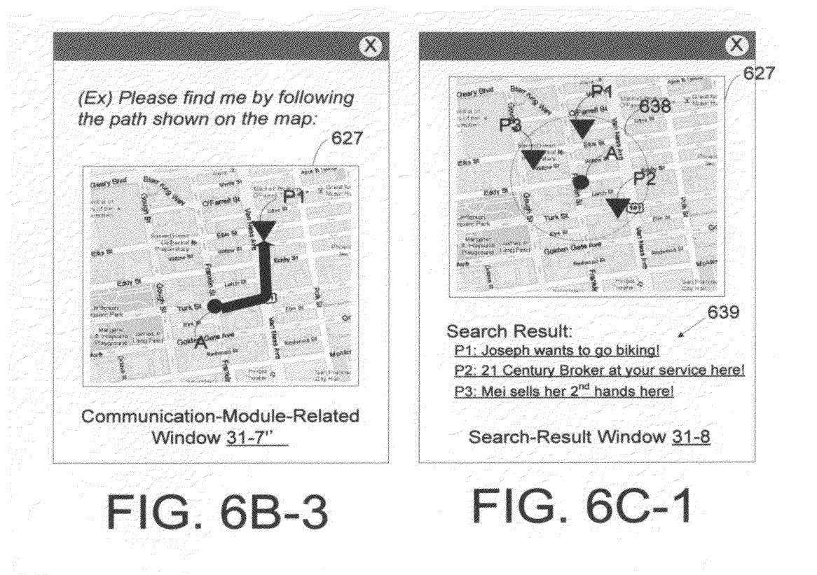

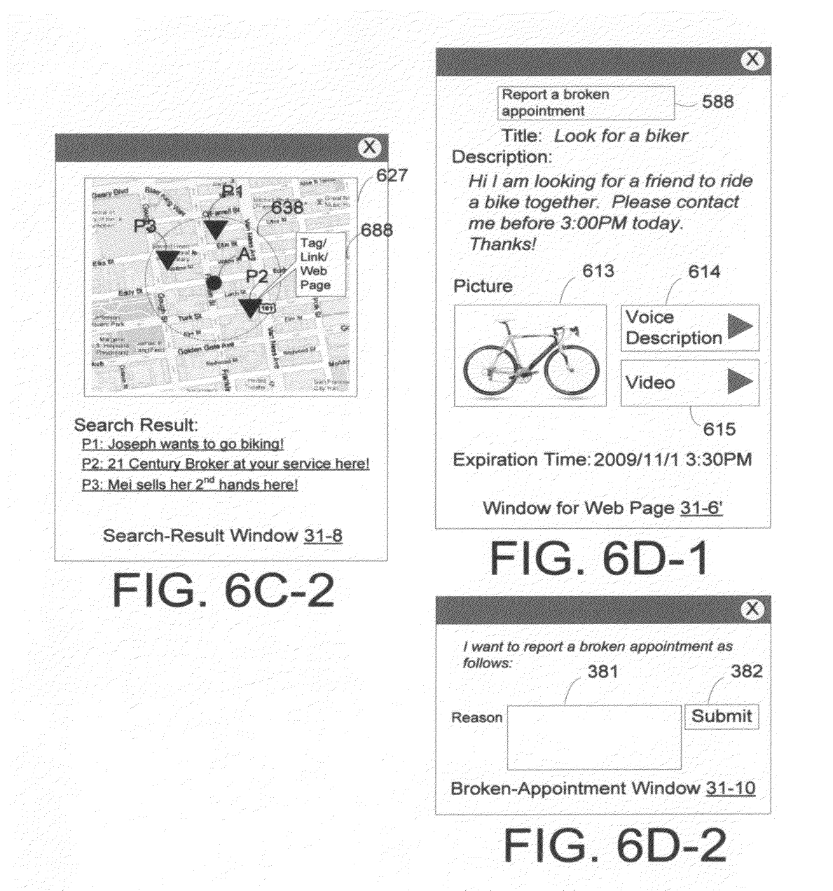

FIG. 6A is a diagram illustrating the window 31-6 according to an example of the present invention. Referring to FIG. 6A, the window 31-6 may show a web page including at least one of the title (e.g., “Look for a biker”), the description (e.g., “Hi I am looking for a friend to ride a bike together . . . ”), or the picture or the expiration time (e.g., “2009/11/1 3:30 PM”). In this example, the window 31-6 may be similar to the window 31-2 described and illustrated with reference to FIG. 3D, except that the fields 218 and 219 are not shown/provided in the window. In one example, when a link called “Drop a message” is clicked, the communication-module-related window 31-7 will be shown.

FIG. 6B-1 is a diagram illustrating the communication-module-related window 31-7 according to an example of the present invention, and FIG. 6B-2 is a diagram illustrating a communication-module-related window 31-7′ according to an example of the present invention. Referring to FIG. 6B-1 and FIG. 6B-2, the communication-module-related window 31-7 or 31-7′ may be similar to the communication-module-related window 31-3 or 31-3′ described and illustrated with reference to FIG. 3C-1 or FIG. 3C-2, respectively.

FIG. 6B-3 is a diagram illustrating a communication-module-related window 31-7″ according to another example of the present invention. Referring to FIG. 6B-3, the communication-module-related window 31-7″ may be similar to the communication-module-related window 31-3″ described and illustrated with reference to FIG. 3C-3.

FIG. 6C-1 is a diagram illustrating the search-result 31-8 window according to another example of the present invention. Referring to FIG. 6C-1, the map information module 13 of the LBS system 40 may be configured to mark locations related to the search result on the map 627, for example, with icons P1, P2 or P3. In one example, the search-result window 31-8 may show the locations (by marking the locations with icons such as the icons P1, P2 or P3 in this example) related to the search result within the range 638 centered by a location A (i.e., the location of the second computing device 30 in this example). In another example, the search result may also be described below (e.g., “P1: Joseph wants to go biking,” etc.).

When the icon P1 (or P2 or P3) is selected, a tag 688 associated with the icon P1 may be shown for example. The tag 688 may include at least one of the web page 46a or the link (or hyperlink) that can be used to link to the web page 46a, as shown in FIG. 6C-2. In one example, the tag 688 may further include at least one of the title, the price, the description, the picture, the voice-description-play button or the video-play button related to the web page 46a.

FIG. 6D-1 is a diagram illustrating the window 31-6′ according to another example of the present invention. Referring to FIG. 6D-1, a report button 588 of the window 31-6′ may be similar to the report button 399 of the window 31-2′ described and illustrated with reference to FIG. 3F-1.

FIG. 6D-2 is a diagram illustrating the broken-appointment window 31-10 according to an example of the present invention. Referring to FIG. 6D-2, the broken-appointment window 31-10 may be similar to the report window 31-9 described and illustrated with reference to FIG. 3F-2. In this example, the report including the reason will be sent after a submit button 382 is clicked. In other example, the reason may be reviewed by an administrator of the LBS system 40.

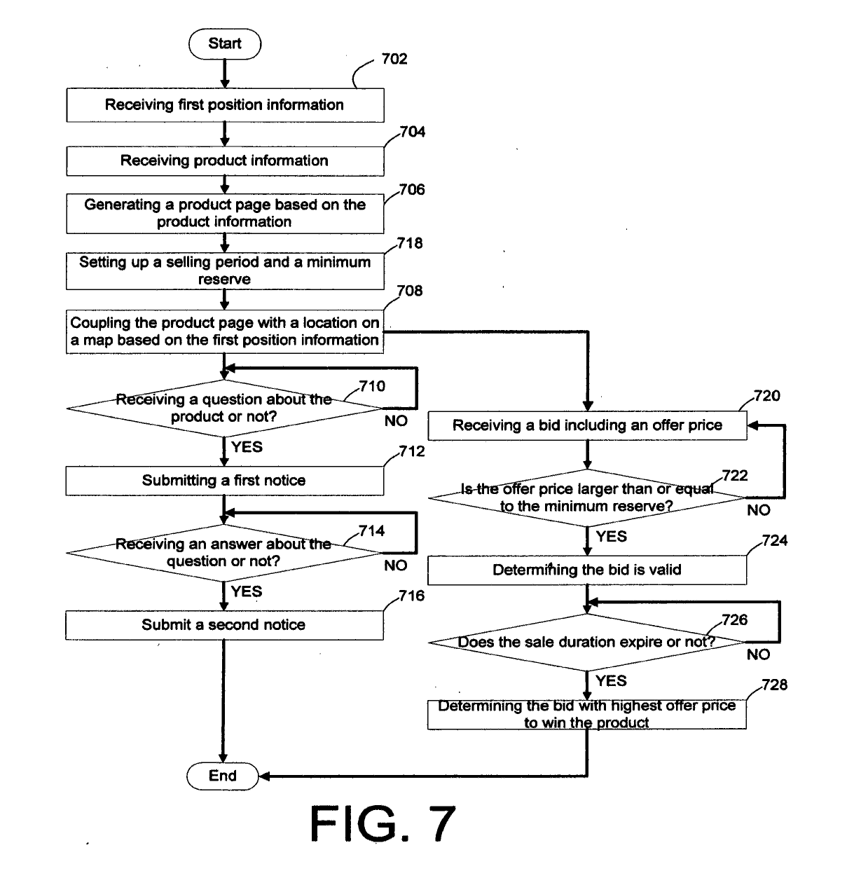

FIG. 7 is a flowchart illustrating a method of providing a location-based service according to an example of the present invention. Referring to FIG. 7, in step 702, the position module 11 may receive the first position information through the input window 21-2 or the positioning module 22. In step 704, the management module 12 may receive the product information, wherein the product information may include at least one of the title, the price, the description, the picture, the voice description or the video of the product. In step 706, the management module 12 may generate the product page 16a based on the product information, wherein the product page 16a may include at least one of the title, the price, the description, the picture, the voice description or the video of the product. In step 708, the map information module 13 may couple the product page with the location on the map based on the first position information.

Furthermore, in step 710, the communication module 14 may determine/identify if it receives the question about the product from the communication-module-related window 31-3. If yes, the communication module 14 will send a first notice to inform the seller of the product, as shown in step 712. In step 714, the communication module 14 may also determine/identify if it receives the answer about the question from the communication-module-related window 21-3. If yes, the communication module 14 may send a second notice to inform the user who asks the question.

In one example, in step 708, the map information module 13 may mark the location of the product page 16a with the icon shown on the map, wherein at least one of the tag, the product page 16a or the link linked to the product page 16a will be shown when the icon is clicked or selected. Moreover, the tag may include or be related to at least one of the title, the price, the description, the picture, the voice description or the video of the product.

In other example, in step 708, the IP-to-location converter module 13-1 may convert the IP address related to the product information into the location shown on the map.

In another example, the management module 12 may receive setting(s) to set the selling period and/or the minimum reserve of the product on the product page 16a accordingly in step 718.

In step 720, the management module 12 may receive a bid from the product-page window 31-2, wherein the bid may include an offer.

In step 722, the management module 12 may identify if the offer is larger than or equal to the minimum reserve. If the offer is larger than or equal to the minimum reserve, the bid will be identified as effective (or valid) in step 724.

In step 726, the management module 12 may determine if the selling period expires (or ends) or not. When the selling period expires (or ends), the bid including highest offer will be identified as the winner of the product in step 728.

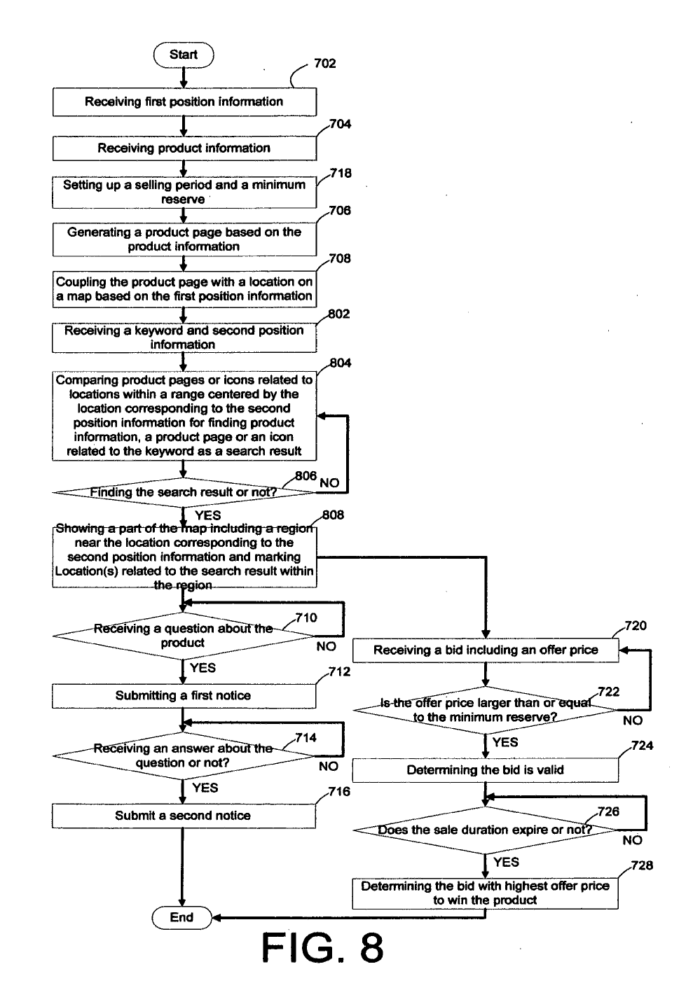

FIG. 8 is a flowchart illustrating a method of providing a location-based service according to another example of the present invention. Referring to FIG. 8, except step 802, 804, 806 and/or 808 the location-based service method described and illustrated in connection with FIG. 8 may be similar to the method described and illustrated with reference to FIG. 7.

In step 802, the search module 15 may receive a keyword from the search-field window 31-4 and second position information, wherein the second position information may be inputted by a user who wants to look for product information related to the keyword and around him. Further, the second position information may be entered by the user through the window 31-1, or sent by the positioning module 32 to the position module 11. In one example, the second position information may include at least one of latitude and longitude, a name of an attraction or a landmark, an address or the IP address (Internet protocol address) of the device sending the keyword.

In step 804, the search module 15 may search the product pages, the product information, the tags or the icons related to locations within the range centered by the location corresponding to the second position information or near the location on the map corresponding to the second position information to find the product information, the product page, the tag or the icon related to the keyword as the search result.

In step 806, the search module 15 may identify if the search result is found. If the search result is found, the map information module 15 may show the range and mark those related to the search result on the map in the search-result window 31-5 in step 808.

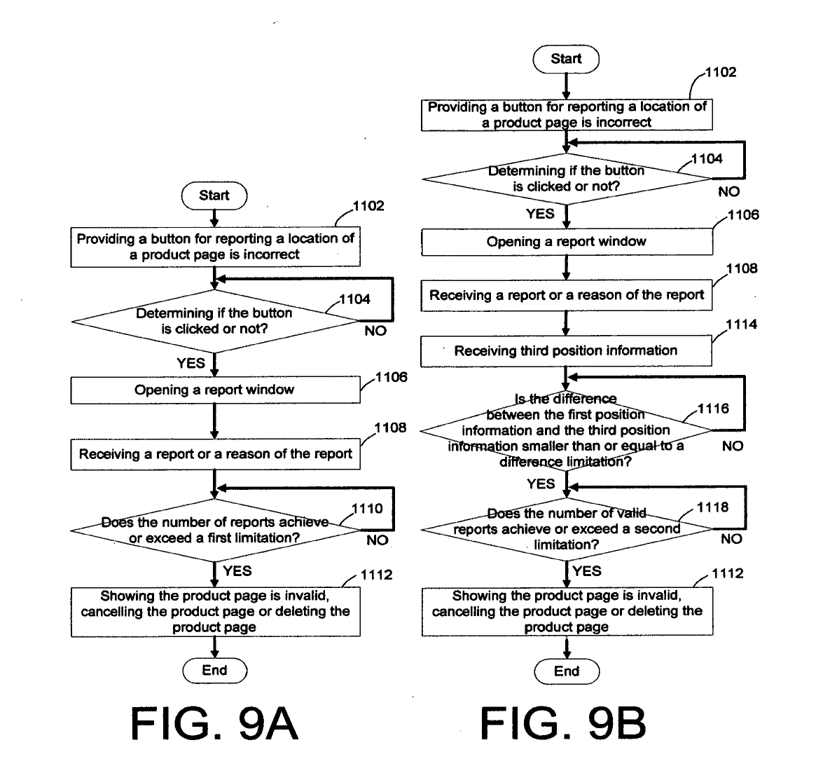

FIG. 9A is a flowchart illustrating a method of providing a location-based service according to still another example of the present invention. Referring to FIG. 9A, in step 1102, the management module 12 may generate the product page 16a according to the product information if it receives the product information. When generating the product page 16a, a report button 399 may be provided together with the report product page 16a for reporting then location of the product (or related to the product page 16a) is incorrect. That is, both the product page 16a and the report button 399 will be shown in the window 31-2. The report button 399 may be coupled to the report module 18 and configured to send a report (e.g., a single message to indicate the location is incorrect or together with the reason why the product page 16a is reported) to the report module 18 when the report button 399 is pressed, clicked, touched or selected. In one example, when the report button 399 is clicked or selected, the report window 31-9 will be opened for the user to enter his/her reason about reporting the product page 16a.

In step 1104, the report module 18 may identify if the report button 399 is clicked/selected. If “yes,” which means the user reports the product page 16a, go to step 1110. Otherwise if “No,” remain standby and wait for next time the report button is clicked/selected.

In step 1110, the report module 18 may identify if the number of reports that report the location related to the product page 16a is incorrect is larger than or equal to a number limitation (or a maximum number or an upper bound). If “yes,” go to step 1112. If “No,” keep going to accumulate the number of the reports when receiving a new report. When the number of reports is larger than or equal to a limitation, the report module 18 will cause the management module 12 to execute at least one of showing the product page 16a is invalid (or, showing the location is incorrect), cancelling the product page 16a or withdrawing the product page 16a.

Moreover, in step 1104, if “yes,” then go to step 1106. In step 1106, the report window 31-9 will be opened for the user to generate a report or to enter his/her reason why he/she reports the product page 16a in step 1108.

FIG. 9B is a flowchart illustrating a method of providing a location-based service according to yet another example of the present invention. Referring to FIG. 9B, the location-based service method described and illustrated in connection with FIG. 9B may be similar to the method described and illustrated with reference to FIG. 9A, except that steps 1114, 1116 or 1118 may not be the same.

In step 1114, the report module 18 may receive third position information (e.g., its current latitude and longitude) of the second computing device 30 used to send the report. In step 1116, the report module 18 may check if the difference between the third position information and the first position information is smaller than or equal to the difference limitation. If the difference between the third position information and the first position information is smaller than or equal to the difference limitation (i.e., if “yes” in step 1116), the report will be determined as valid and then go to step 1118.

In step 1118, the report module 18 may count the number of valid reports the product page 16a being reported as its location is incorrect. If the number of valid reports is larger than or equal to the number limitation, the report module 18 will cause the management module 12 to execute at least one of showing the product page 16a is invalid, cancelling the product page 16a or withdrawing the product page 16a.

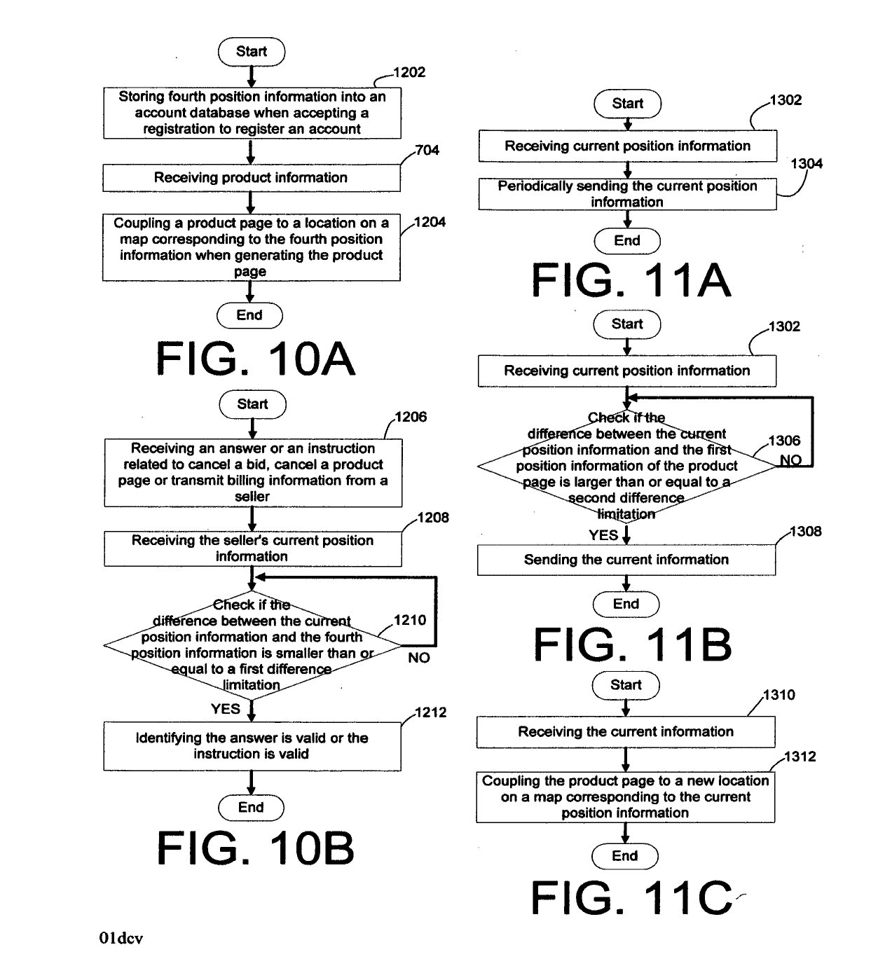

FIG. 10A is a flowchart illustrating a method of providing a location-based service according to still another example of the present invention. Referring to FIG. 10A, in step 1202, when an account is registered, fourth position information of (related to) the account (e.g., related to the location the user of the account wants to be identified as an effective location) may be stored into the account database 19. In one example, the fourth position information of (related to) the account may be entered by the user when registering the account (e.g., to enter the user's location or the location he or she wants to be identified as effective) and stored into the account database 19. In another example, the fourth position information of (related to) the account may be stored as the position information of the first computing device 20 when the first computing device 20 is used to register the account.

In step 1204, the management module 12 may receive the product information. In step 1206, the management module 12 may generate a product page according to the product information and couple a location on the map to the product page based on the fourth position information.

FIG. 10B is a flowchart illustrating a method of providing a location-based service according to yet another example of the present invention. Referring to FIG. 10B, in step 1206, the management module 12 may receive the product information generated by the seller, the answer or the instruction from the seller.

In step 1206, the position module 11 may receive fifth position information related to the location when the seller generates the product information or the instruction (i.e., the location of the first computing device 20 used to generate/send the product information or the instruction).

In step 1210, the management module 12 may compare the fifth position information with the fourth position information stored in the account database 19. When the difference of the two position information is smaller or equal to the difference limitation, go to step 1212. In step 1212, the management module 12 may generate a product page based on the product information, show the answer or execute the instruction.

FIG. 11A is a flowchart illustrating a method of providing a location-based service according to still another example of the present invention. Referring to FIG. 11A, in step 1302, when a user (or a seller) login the LBS system 10′″ with his/her account through the first computing device 20, the positioning module 22 of the first computing device 20 may periodically or continuously receive the current position information of the first computing device 20 from the GPS module. In step 1304, the positioning module 22 may periodically or continuously send the current position information of the first computing device 20 to the position module 11 of the LBS system 10′″.

Those skilled in the art can easily understand that, in the aforementioned method, step 1304 can be changed to send the current position information of the first computing device 20 only if the difference between the current position information and its previous position information is larger than or equal to a difference limitation, but not periodically or continuously. The method is shown in FIG. 11B. Those skilled in the art can easily understand that applying the method described and illustrated with reference to FIG. 11B may consume less power than applying the method described and illustrated with reference to FIG. 11A.

FIG. 11C is a flowchart illustrating a method of providing a location-based service according to still another example of the present invention. Referring to FIG. 11C, in step 1310, the position module 11 of the LBS system 10′″ may receive updated (or current) position information (sent by the positioning module 22) of the first computing device 20 used to login an account, and the management module 12 may couple a product page generated by the account with a location on the map related to the updated position information in step 1312.

In one example, the management module 12 may be configured to couple the product page generated by the account with a location on the map related to the updated position information only if the difference between the updated position information and its previous position information is larger than or equal to a first difference limitation, or cancel the product page if the difference is larger than or equal to a second difference limitation (which means the seller who login the LBS system 10′″ with the account is too far away from his/her original location setting of its product page).

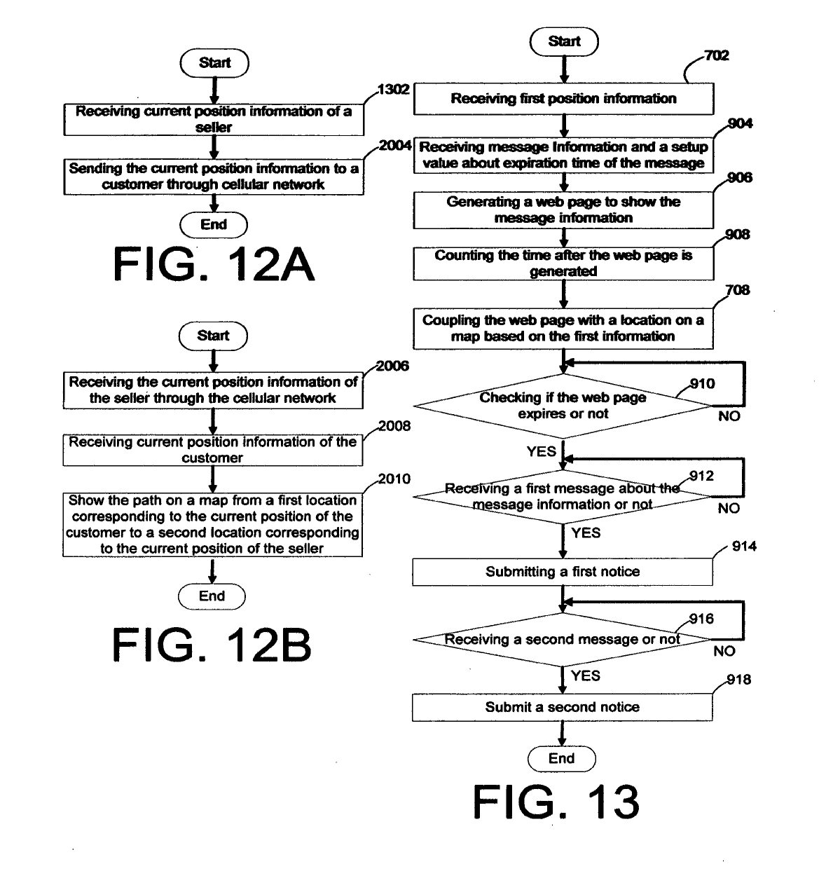

FIG. 12A is a flowchart illustrating a method of providing a location-based service according to still another example of the present invention. Referring to FIG. 12A, after step 1302 as mentioned above, in step 2004, the positioning module 22 may be configured to send the current position information (i.e., related to the seller's current location) to the LBS system 10, and then the LBS system 10 will pass the current position information to the second computing device 30, or directly send the current position information to the user's second computing device 30 through the cellular network (e.g., an SMS including the current position information).

FIG. 12B is a flowchart illustrating a method of providing a location-based service according to yet another example of the present invention. Referring to FIG. 12B, in step 2006, the second computing device 30 will receive the current position information. In step 2008, the GPS module or the positioning module 32 of the second computing device 30 may also receive the current position information of the user. Next, in step 2010, the second computing device 30 may show the map with a reference path from the user's current position information to the seller's current position information on its screen 31.

FIG. 13 is a flowchart illustrating a method of providing a location-based service according to still another example of the present invention, wherein steps 702 and 708 are the same or similar to the steps described and illustrated with reference to FIG. 7. Referring to FIG. 13, in step 904, the management module 42 may receive message information and a value of an expiration time from the input window 21-4.

In step 906, the management module 42 may generate a web page to show the message information. The message information may include at least one of a title, a description, a picture, a voice description or a video. The web page may include at least one of the title, the description, the picture, the voice description or the video.

In step 908, the timer 42-1 may count the time after the web page is generated.

In step 910, the timer 42-1 may compare current time and the value of the expiration time to determine if the web page expires or not. If “yes,” go to step 912.

In step 912, the first notice module 44-1 may determine if a first message related to the message information is received. When receiving the first message, the first notice module 44-1 will send a first notice in step 914.

Similarly, step 916, the second notice module 44-2 may determine if a second message related to the message information is received. When receiving the second message, the second notice module 44-1 will send a second notice in step 918.

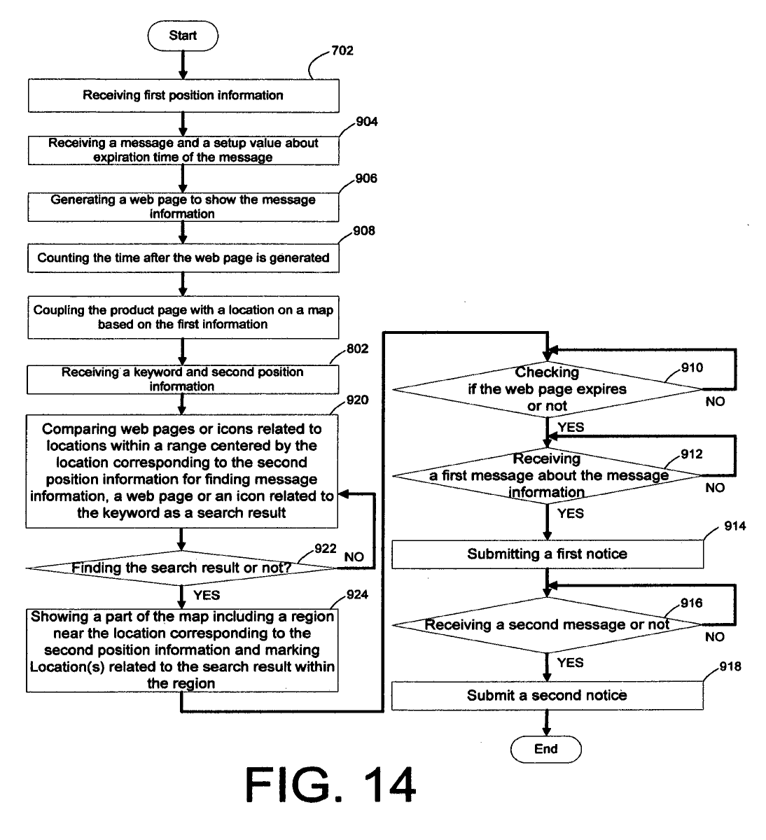

FIG. 14 is a flowchart illustrating a method of providing a location-based service according to yet another example of the present invention. Referring to FIG. 14, except steps 920, 922 and/or 924 the location-based service method described and illustrate with reference to FIG. 14 may be similar to the method described and illustrate with reference to FIG. 9.

In step 920, the search module 15 may search the web pages, the message information, the tags or the icons related to locations within the range centered by the location corresponding to the second position information or near the location on the map corresponding to the second position information to find the message information, the web page, the tag or the icon related to the keyword as the search result.

In step 920, the search module 15 may identify if the search result is found. If the search result is found, the map information module 15 may show the range and mark those related to the search result on the map in the search-result window 31-8 in step 924.

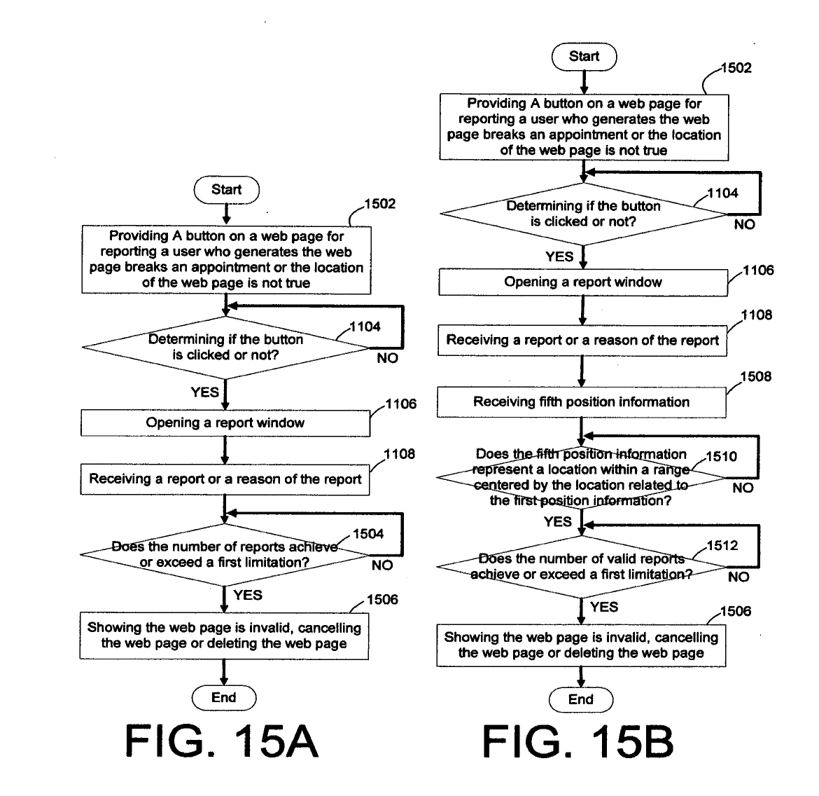

FIG. 15A is a flowchart illustrating a method of providing a location-based service according to still another example of the present invention. Referring to FIG. 15A, in step 1502, management module 42 may provide a report button 588 together with the web page for reporting the user who posts the web page breaks the appointment when generating the web page 46a.

In one example, the web page 46a and the report button 588 may be shown in the window 31-6. The report button 588 may be coupled with the report module 58 to send a report when the report button is pressed, clicked or selected. In another example, after pressing, clicking or selecting the report button 588, the report window 31-10 will be shown.

In step 1104, the report module 58 may identify if the report button 588 is clicked/selected. If “yes,” which means the user reports the web page 46a, go to step 1504. Otherwise if “No,” remain standby and wait for next time the report button is clicked/selected.

In step 1504, the report module 58 may identify if the number of reports that report the location related to the web page 46a is incorrect is larger than or equal to a number limitation (or a maximum number or an upper bound). If “yes,” go to step 1506. If “No,” keep going to accumulate the number of the reports when receiving a new report. When the number of reports is larger than or equal to a number limitation, the report module 58 will cause the management module 42 to execute at least one of showing the web page 46a is invalid (or, showing the location is incorrect), cancelling the web page 46a or withdrawing the web page 46a.

Moreover, in step 1104, if “yes,” then go to step 1106. In step 1106, the report window 31-10 will be opened for the user to generate a report or to enter his/her reason why he/she reports the web page 46a in step 1108.

FIG. 15B is a flowchart illustrating a method of providing a location-based service according to yet another example of the present invention. Referring to FIG. 15B, the location-based service method described and illustrated in connection with FIG. 15B may be similar to the method described and illustrated with reference to FIG. 15A, except that steps 1508, 1510 or 1512 may not be the same.

In step 1508, the report module 58 may receive fifth position information (e.g., its current latitude and longitude) of the second computing device 30 used to send the report. In step 1510, the report module 58 may check if the difference between the fifth position information and the first position information is smaller than or equal to the difference limitation. If the difference between the fifth position information and the first position information is smaller than or equal to the difference limitation (i.e., if “yes” in step 1510), the report will be determined as valid and then go to step 1512.

In step 1512, the report module 58 may count the number of valid reports the web page 46a being reported as its location is incorrect. If the number of valid reports is larger than or equal to the number limitation, the report module 58 will cause the management module 42 to execute at least one of showing the web page 46a is invalid, cancelling the web page 46a or withdrawing the web page 46a.

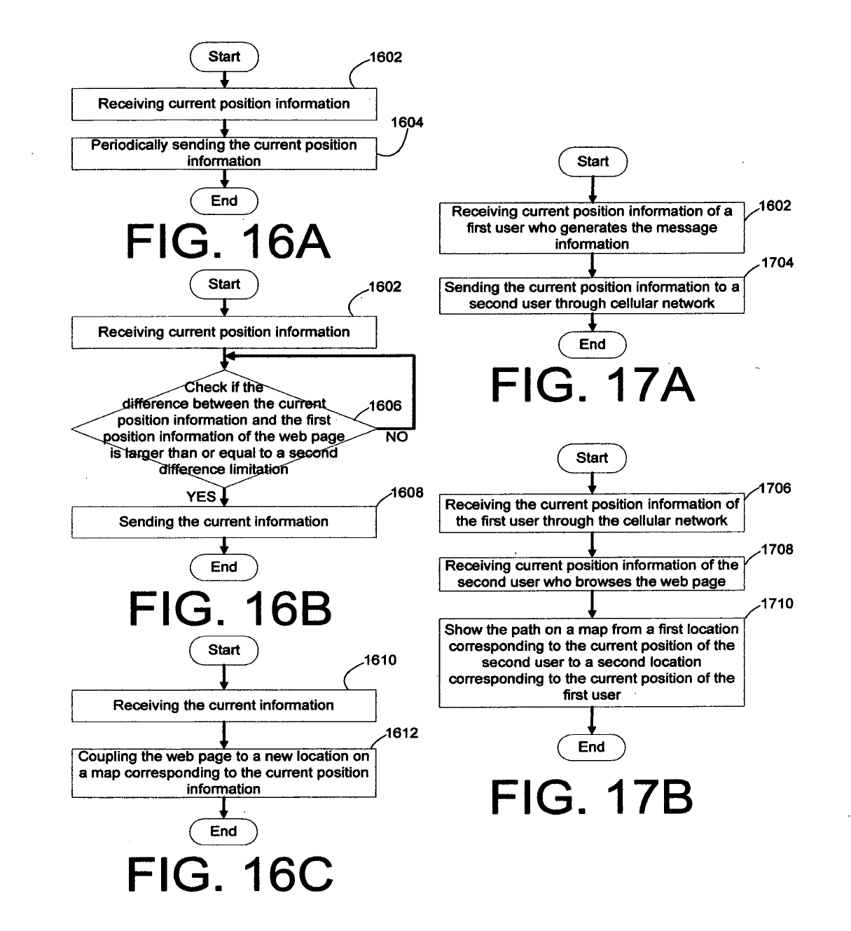

FIG. 16A is a flowchart illustrating a method of providing a location-based service according to still another example of the present invention. Referring to FIG. 16A, in step 1602, when a user (or a seller) login the LBS system 40′″ with his/her account through the first computing device 20, the positioning module 22 of the first computing device 20 may periodically or continuously receive the current position information of the first computing device 20 from the GPS module. In step 1604, the positioning module 22 may periodically or continuously send the current position information of the first computing device 20 to the position module 11 of the LBS system 40′″.

Those skilled in the art can easily understand that, in the aforementioned method, step 1604 can be changed to send the current position information of the first computing device 20 only if the difference between the current position information and its previous position information is larger than or equal to a difference limitation, but not periodically or continuously. The method is shown in FIG. 16B. Those skilled in the art can easily understand that applying the method described and illustrated with reference to FIG. 16B may consume less power than applying the method described and illustrated with reference to FIG. 16A.

FIG. 16C is a flowchart illustrating a method of providing a location-based service according to still another example of the present invention. Referring to FIG. 16C, in step 1610, the position module 11 of the LBS system 40′″ may receive updated (or current) position information (sent by the positioning module 22) of the first computing device 20 used to login an account, and the management module 42 may couple a web page generated by the account with a location on the map related to the updated position information in step 1612.

In one example, the management module 42 may be configured to couple the web page generated by the account with a location on the map related to the updated position information only if the difference between the updated position information and its previous position information is larger than or equal to a first difference limitation, or cancel the web page if the difference is larger than or equal to a second difference limitation (which means the seller who login the LBS system 40′″ with the account is too far away from his/her original location setting of its product page).

FIG. 17A is a flowchart illustrating a method of providing a location-based service according to still another example of the present invention. Referring to FIG. 17A, after step 1602 as mentioned above, in step 1704, the positioning module 22 may be configured to send the current position information to the LBS system 40, and then the LBS system 40 will pass the current position information to the second computing device 30, or directly send the current position information to the user's second computing device 30 through the cellular network (e.g., an SMS including the current position information).

FIG. 17B is a flowchart illustrating a method of providing a location-based service according to yet another example of the present invention. Referring to FIG. 17B, in step 1706, the second computing device 30 will receive the current position information. In step 1708, the GPS module or the positioning module 32 of the second computing device 30 may also receive the current position information of the second computing device 30. Next, in step 1710, the second computing device 30 may show the map with a reference path from the current position information of the second computing device 30 to the current position information of the first computing device 20 on its screen 31.

Those skilled in the art can easily understand that the aforementioned windows displayed in the screens 21 and 31 may be shown by browsers (i.e., for general purpose) of the computing devices 20 and 30, respectively. In these examples, the LBS system 10 may transmit webs as codes in XML, HTML, PHP or JAVA script(s) to the computing devices 20 and 30, and the browsers of the computing devices 20 and 30 may compile the codes and displayed as the corresponding webs in the windows. However, the codes may also be received by a widget specifically for coupling with the LBS system 10 and displayed as user interfaces of the widget.

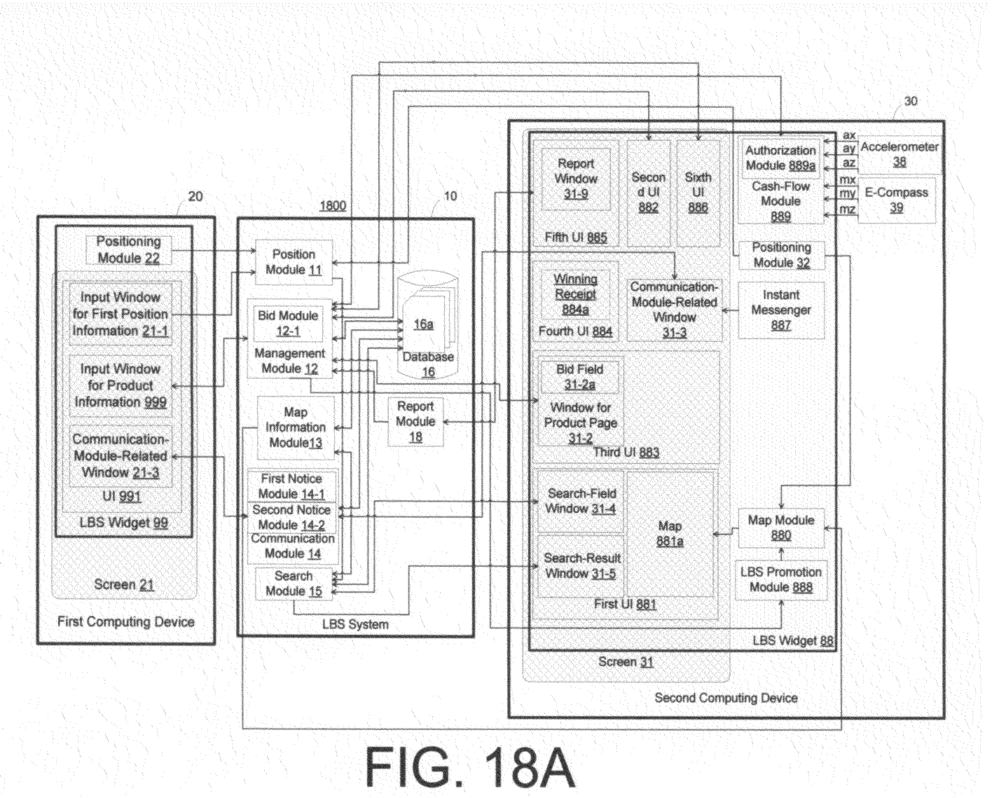

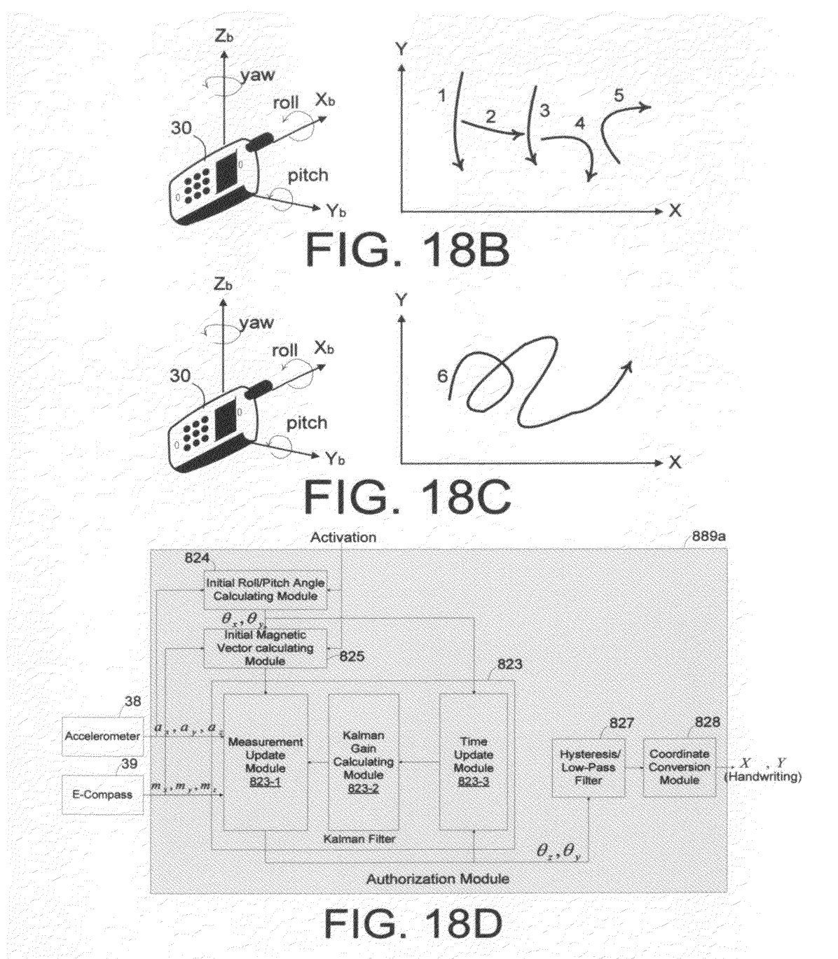

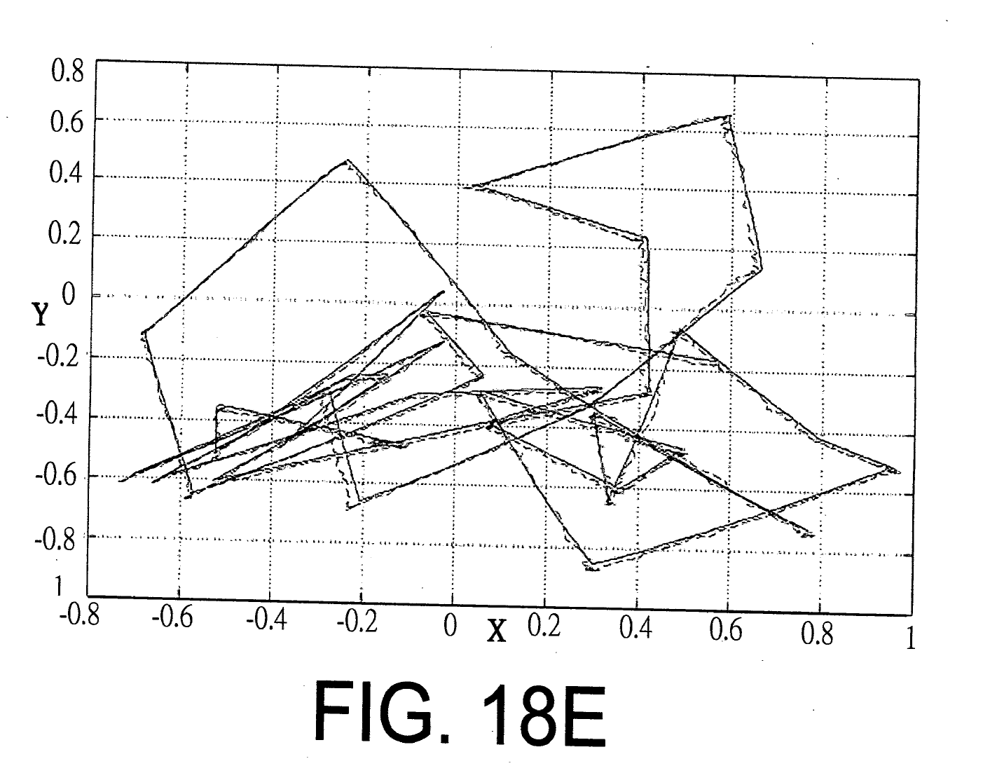

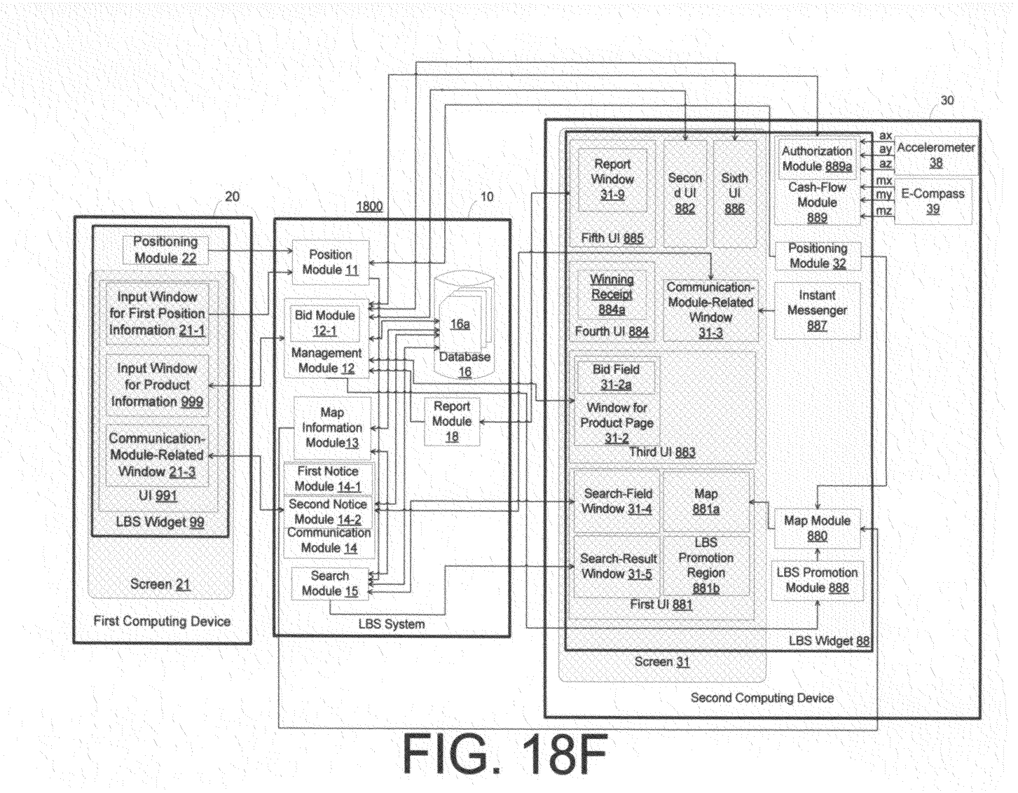

FIG. 18A is a block diagram illustrating an LBS widget 88 coupled with an LBS system 10′″ according to an example of the present invention. Referring to FIG. 18A, the aforementioned windows shown in the screen 21 or 31 may be initiated by user interface(s) of the LBS widget 88 (and also shown on the user interface(s)). The LBS widget 88 may be formed in the second computing device 30. Moreover, the LBS widget 88 may be implemented as a program capable of being installed in the second computing device 30 and executed by a processor (e.g., a CPU or an MCU) of the second computing device 30 to form/generate modules (or elements or components) of the LBS widget 88 and user interfaces coupled with the web application(s) or task(s) provided by the LBS system 10′″. In this example, the program may include a set of instructions in programming code(s) that can be executed in an operating system of the second computing device 30, for example, such as the iPhone OS of an iPhone or the Android of an Android phone.

The LBS widget 88 may include the positioning module 32, a map module 880 and an LBS promotion module 888. In the LBS widget 88, the positioning module 32 may be configured to receive first coordinates of the second computing device 30. The map module 880 may be configured to show a part of a map 881a on a first UI 881, wherein the part of the map 881a may include a first location corresponding to the first coordinates. For example, the coordinates of the “Fisherman's Wharf' are “37° 48′ 30″ N 122° 24′ 56″ W”. In this example, if a user (of the LBS widget 88) uses his/her cellular phone (i.e., the second computing device 30) at the Fisherman's Wharf, the first coordinates are the “37° 48′ 30″ N 122° 24′ 56″ W” and the first location shown on the map (also shown on the part of the map 881a) corresponding to the first coordinates is the Fisherman's Wharf. Therefore, the map module 880 may show the part including the first location, “Fisherman's Wharf”, on the map 881a on the first UI 881 based on the first coordinates “37° 48′ 30″ N 122° 24′ 56″ W”.

In another example, the first UI 881 may provide a search field or switch to the search-field window 31-4 as aforementioned for the user to enter a keyword for searching. If a search result exists (i.e., near the first coordinates and also matches the keyword), the search result for the searching may be shown on the part of the map 881a (and marked as a tag, a button, an icon or a link), or on the search-result window 31-5 as aforementioned.

The LBS promotion module 888 may be configured to receive product information and second coordinates related to a promoted product page and mark a second location corresponding to the second coordinates on the part of the map 881a with at least one of an icon, a tag, a buttons or a link. In the previous example, said a seller on the street of the Fisherman's Wharf posts his today's special, a crab meal, to the LBS system 10′″ and add it as an LBS promotion (i.e., an advertisement provided by the LBS widget 88/LBS system 10′″ of the present invention for advertising an item based on the locations or the distance between a seller of the item and a user of the LBS widget 88). The LBS system 10′″ then generates a promoted product page about the crab meal and couples the promoted product page with the seller's location or the location of his store (i.e., the second location) on the map based on the coordinates (i.e., the second coordinates in this example) or an address the seller entered as the position information of the crab meal (in this example, the LBS system 10′″ then looks up the corresponding second coordinates of the address the seller entered). Since the second location can also be shown on the part of the map 881a (which means the second location locates within a range that can be shown together with the first location on the same part of the map 881a), the LBS promotion module 888 may mark the second location on the part of the map 881a with an icon (or a tag, perhaps in a crab shape including/embedding a link to the promoted product page) automatically.

Moreover, if the at least one of the icon, the tag, the button or the link is chosen, the LBS widget 88 may initiate the first UI 881 or a third UI 883, and the promoted product page may be shown on at least one of the first UI 881 or the third UI 883 in a format, for example, like the window 31-2 for the product page as aforementioned (i.e., the promoted product page may be shown with the same UI (the first UI 881) or with a new opened UI (the third UI 883)). In one example, the promoted product page shown on the at least one of the first UI 881 or the third UI 883 may further include a bid field configured to be used to place a bid (similar to the aforementioned bid field 31-2a of the window 31-2 for product page). Moreover, the promoted product page may have a selling period, that is, the period while the product is available for purchasing thru the LBS system 10′″, and the bid is considered to be valid by the management module 12 if the bid is placed during the selling period of the promoted product page in this example.

In one example, the bid may include an offer, wherein the at least one of the first UI 881 or the third UI 883 may show the product of the promoted product page is sold or reserved if the offer of the bid is accepted by the seller (i.e., the seller agrees to sell the product with the price of the offer/bid).

In another example, the promoted product page may include a buy-it-directly price or an input for making a reserve, and the at least one of the first UI 881 or the third UI 883 may show the product of the promoted product page is sold if the user places a bid to purchase the product with the buy-it-directly price, or the product of the promoted product page is reserved if the user places a bid to reserve the product (i.e., the bid placed is only for making a reserve of the product).

In the above mentioned examples, if/when the product is sold or reserved or the once the user wins the product, the management module 12 may send a winning receipt to the LBS widget 88. After receiving the winning receipt, at least one of the first UI 881, the third UI 883 or a fourth UI 884 of the LBS widget 88 may show a winning receipt if the product of the promoted product page is won after the bid is placed. In this example, the winning receipt can be used like, for example, the user may bring his/her cellular phone to the seller of the product and show the seller the winning receipt on the screen of his/her cellular phone to tell the seller he/she is the winner of the product of the promoted product page, and he/she comes for purchasing/picking up the product from the seller now.

Moreover, the LBS widget 88 may include a cash-flow module 889. The cash-flow module 889 may be coupled with the management module 12 and configured to be used by the user (the winner) who wins/wants to buy the product of the promoted product page to pay a payment of the product of the promoted product page online. The cash-flow module 889 may first be coupled with a cyberbank (or an online bank or an internet bank) or an online cash-flow system (e.g., the PayPal), and display a window to ask the user to enter his/her account and its password of the cyberbank or the online cash-flow system and confirm to pay the payment online with the account.

In order to increase/improve the transaction security, the cash-flow module 889 may further include an authorization module 889a. The authorization module 889a may be configured to receive acceleration measurement values (aₓ, a_{y}, a_{z}) from an accelerometer 38 and magnetic measurement values (mₓ, m_{y}, m_{z}) from an electronic compass (e-compass) 39 in the X_{b}-, Y_{b}- and Z_{b}-axis directions (see FIGS. 18B and 18C) of the second computing device 30, respectively, when the user moves or wields the second computing device 30 (e.g., the cellular phone) for generating a handwriting, and generate the handwriting (e.g., a trace or traces) by calculation based on the acceleration measurement values (aₓ, a_{y}, a_{z}) and the magnetic measurement values (mₓ, m_{y}, m_{z}). The calculation for generating the handwriting based on the measurement values will be discussed in description and illustration with reference to FIG. 18D later. Moreover, the management module 12 (or the cyberbank or the online cash-flow system) may compare the handwriting generated by moving/wielding the second computing device 30 with a registered handwriting (e.g., a golden pattern of the user's handwriting or traces such as his/her signature or in some special pattern(s)) stored in database (i.e., database coupled with the management 12 or in the cyberbank or the online cash-flow system), and the payment of the product of the promoted product page is paid successfully if the generated handwriting matches the registered handwriting. In one example, a receipt after completing the payment may be shown on one of the UIs of the LBS widget 88, and similarly the user may bring his/her cellular phone to the seller of the product and show the receipt to the seller to let the seller know he/she has already pay the payment of the product (and thus he/she can pick up the product immediately).

Moreover, FIG. 18B is a diagram illustrating a set of handwritings (traces) 1 to 5 (or handwriting with pieces 1 to 5) generated by moving/wielding the second computing device 30 according to an example of the present invention. In this example, each trace (piece) (i.e., one of the handwritings 1, 2, 3, 4 and 5) is separated from the others. In this example, the user may try to enter his/her handwriting sets for authorizing the paying of his/her online payment since the corresponding registered handwriting may include a set of traces (handwritings). Similarly, FIG. 18C is a diagram illustrating a handwriting 6 generated by moving/wielding the second computing device 30 according to another example of the present invention. In this example, the handwriting 6 is continuous (i.e., a longer/single trace) since its corresponding registered handwriting is continuous and single.

Further, although the handwritings shown in FIG. 18B or 18C are two-dimensional, those skilled in the art can easily understand that FIG. 18B or 18C are only for exemplarily demonstrating the way to generate the handwritings in the drawings of this specification. Since the second computing device 30 may be wielded/moved in three-dimensional space (i.e., in the air), a handwriting or a registered handwriting could also be three-dimensional (i.e., all the points of the handwriting is not necessary to be in the same plane). Therefore, the handwriting(s) generated by the authorization module 889a should not be limited to two-dimensional.

FIG. 18D is a block diagram illustrating the authorization module 889a according to an example of the present invention. Referring to FIG. 18B, the authorization module 889a may be coupled with the accelerometer 38 and the e-compass 39 to receive the acceleration measurement values (aₓ, a_{y}, a_{z}) and the magnetic measurement values (mₓ, m_{y}, m_{z}), respectively. In this example, the accelerometer 38 may be disposed in the second computing device 30, and can move with the second computing device 30, so as to measure the acceleration measurement values aₓ^{b}, a_{y}^{b} and a_{z}^{b} of the second computing device 30 in the directions of the X_{b}, Y_{b} and Z_{b} axes of the body frame of the second computing device 30, respectively, in response to movements of the second computing device 30 due to forces exerted on the second computing device 30 (such as being moved/wielded by the user). Note that the superscript “b” of the acceleration measurement values aₓ^{b}, a_{y}^{b} or a_{z}^{b} means the acceleration values are measured with reference to the body frame. Similarly, the e-compass 39 may be disposed in the second computing device 30 too, and can measure the terrestrial magnetisms (the magnetic measurement values) Mₓ^{b}, M_{y}^{b} and m_{z}^{b} in the directions of the X_{b}, Y_{b} and Z_{b} axes, respectively (which may be represented by a magnetic vector [mₓ^{b}, M_{y}^{b}]^{T}), at each location where the e-compass 39 is located (i.e., a position inside the second computing device 30) during the movements. Since the direction of the magnetic field line of the terrestrial magnetic field in a small area may be regarded as a fixed direction, the measured magnetic vector may be used by the authorization module 889a as reference for calculating the trace of the movements (in this example, even if the user moves or wields the second computing device 30, the change in the position of the second computing device 30 is limited (not too big) and may not become big enough such that the direction of the magnetic field line passing through the area changes significantly). For example, from the changes in the terrestrial magnetisms mₓ^{b}, m_{y}^{b} and m_{z}^{b} in the directions of the three axes measured by the e-compass 39, the amount the second computing device 30 has deviated from the direction of the magnetic field line of the terrestrial magnetic field may be determined, and may be used for generating more accurate handwritings.

The authorization module 889a may include a first module such as an initial roll angle and pitch angle calculating module 824, a second module such as a navigation frame's initial magnetic vector calculating module 825, and a third module such as a Kalman Filter 823. Note that the navigation frame is the frame composed of the X- and Y-axes as shown in FIG. 18B or 18C.

When the user starts to move/wield the second computing device 30 for generating his/her handwriting(s), the authorization module 889a is activated (e.g., he/she may push/press a button shown on the screen 31 or a real button of the second computing device 30 to trigger/begin the input of his/her handwriting(s), and the initial roll/pitch angle calculating module 824 may be configured to set the instant when the bottom is pressed as the starting time for calculating the initial angles), the initial yaw angle may be set to a constant or 0. Since the pitch angle and roll angle are related to the direction of the gravitation acceleration (are influenced by gravitational force or its components), during initialization, the accelerometer 38 may measure the accelerations associated with the directions corresponding to these two angles. Therefore, the initial roll/pitch angle calculating module 824 may be configured to calculate the initial roll (φ) and pitch (θ) angles using the following equation:

$$[ \begin{matrix}{a}_{x}^{b} \\ {a}_{y}^{b} \\ {a}_{z}^{b}\end{matrix} ] = [ \begin{matrix}cos θ & 0 & sin θ \\ sin φ sin θ & cos φ & - sin φ cos θ \\ - cos φ sin θ & sin φ & cos φ cos θ\end{matrix} ] [ \begin{matrix}0 \\ 0 \\ - g\end{matrix} ] = [ \begin{matrix}- g sin θ \\ g sin φ cos θ \\ - g cos φ cos θ\end{matrix} ]$$

where g is the gravitational acceleration, aₓ^{b}, a_{y}^{b} and a_{z}^{b} are the accelerations in the X_{b} axis, Y_{b} axis and Z_{b} axis directions measured by the accelerometer 38 when the user is in preparation of using the movement of the second computing device 30 for inputting the handwriting(s). The initial roll (φ), pitch (θ) and yaw (Ψ) angles may be provided to the navigation frame's initial magnetic vector calculating module 825 for calculating the initial magnetic vector [mₓⁿ, m_{y}ⁿ, m_{z}ⁿ]^{T}.

The navigation frame's initial magnetic vector calculating module 825 may calculate the initial magnetic vector of the navigation frame [mₓⁿ, m_{y}ⁿ, m_{z}ⁿ]^{T} using the following equation:

$$[ \begin{matrix}{m}_{x}^{n} \\ {m}_{y}^{n} \\ {m}_{z}^{n}\end{matrix} ] = {[ \begin{matrix}cos θ & 0 & sin θ \\ sin φ sin θ & cos φ & - sin φ cos θ \\ - cos φ sin θ & sin φ & cos φ cos θ\end{matrix} ]}^{T} [ \begin{matrix}{m}_{x}^{b} \\ {m}_{y}^{b} \\ {m}_{z}^{b}\end{matrix} ]$$

where mₓ^{b}, m_{y}^{b} and m_{z}^{b} are the terrestrial magnetisms in the X_{b}, Y_{b} and Z_{b} directions measured by the e-compass 39 when the user is in preparation of using the movement of the second computing device 30 to input the handwriting(s). This initial magnetic vector [mₓⁿ, m_{y}ⁿ, m_{z}ⁿ]^{T} is subsequently input into the Kalman Filter 823 for use as a magnetic reference vector \vec{mₙ}.

The state equation of the Kalman Filter 823 may be represented by a continuous-time differential equation as follows:

$$\frac{d}{d t} \vec{X} = \frac{d}{d t} [ \begin{matrix}ψ \\ θ \\ φ \\ {\vec{b}}_{a}^{b} \\ {\vec{b}}_{c}^{b} \\ {\vec{s}}_{a}^{b} \\ {\vec{s}}_{c}^{b}\end{matrix} ] = [ \begin{matrix}{U}_{ψ} \\ {U}_{θ} \\ {U}_{φ} \\ {\vec{N}}_{ba} \\ {\vec{N}}_{bc} \\ {\vec{N}}_{sa} \\ {\vec{N}}_{sc}\end{matrix} ]$$

where each element of \vec{X} represents a state;
\vec{b}ₐ^{b} represents the accelerometer bias which the accelerometer 38 may have due to the process of manufacturing;
\vec{b}_{c}^{b} represents the compass bias which the e-compass 39 may have due to the process of manufacturing;
\vec{s}ₐ^{b} represents the truncation error due to the number of bits (e.g., 10-bit for representing an acceleration value) for representing the acceleration value on the accelerometer scale of the accelerometer;
\vec{s}_{c}^{b} represents the truncation error due to the number of bits (e.g., 10-bits for representing a terrestrial magnetism value) for representing the terrestrial magnetism value on the compass scale of the e-compass 39;
U_{Ψ} represents changes in the yaw angle Ψ due to the user using the second computing device 30 for generating traces of movements (i.e., differentiate Ψ with respect to time);
U_{θ} represents changes in the pitch angle θ due to the user using the second computing device 30 for inputting and generating traces of movements (i.e., differentiate θ with respect to time);
U_{φ} represents changes in the roll angle φ due to the user using the second computing device 30 for generating traces of movements (i.e., differentiate φ with respect to time);
\vec{N}_{ba} represents the changes in the accelerometer bias, which the accelerometer 38 may have due to the process of manufacturing, as a function of time;
\vec{N}_{bc} represents the changes in the compass bias, which the e-compass 39 may have due to the process of manufacturing, as a function of time;
\vec{N}ₛₐ represents the truncation error due to the number of bits for representing the acceleration values on the accelerometer scale of the accelerometer 38, as a function of time; and
\vec{N}_{sc} represents the truncation error due to the number of bits for representing the terrestrial magnetism values on the compass scale of the e-compass 39, as a function of time.

One skilled in the art should be able to easily understand that when the bias of the accelerometer 38 or the e-compass 39 due to the process of manufacturing is small or when the chip design of the accelerometer 38/e-compass 39 includes self-calibration function, or when the outputs are represented by larger number of bits, the effects of the aforementioned bias or scale factors may be neglected. Therefore, state functions including less or none of the elements related to the bias or scale factors may be obtained. Furthermore, under the circumstances where other factors that may affect the generation of trace information exist, the number of states of \vec{X} may be increased or decreased, in order to arrive at different trace generating effects.

Similarly, the discrete-time state equation of the authorization module 889a may be represented as follows:

$${\vec{X}}_{k} = [ \begin{matrix}{ψ}_{k} \\ {θ}_{k} \\ {φ}_{k} \\ {\vec{b}}_{a , k}^{b} \\ {\vec{b}}_{c , k}^{b} \\ {\vec{s}}_{a , k}^{b} \\ {\vec{s}}_{c , k}^{b}\end{matrix} ] = {I}_{15 \times 15} [ \begin{matrix}{ψ}_{k - 1} \\ {θ}_{k - 1} \\ {φ}_{k - 1} \\ {\vec{b}}_{a , k - 1}^{b} \\ {\vec{b}}_{c , k - 1}^{b} \\ {\vec{s}}_{a , k - 1}^{b} \\ {\vec{s}}_{c , k - 1}^{b}\end{matrix} ] + [ \begin{matrix}{u}_{ψ , k - 1} \\ {u}_{θ , k - 1} \\ {u}_{φ , k - 1} \\ {\vec{n}}_{ba , k - 1} \\ {\vec{n}}_{bc , k - 1} \\ {\vec{n}}_{sa} \\ {\vec{n}}_{sc}\end{matrix} ]$$

where I_{15×15} is a 15×15 identity matrix;
the subscript k represents the value at time k, subscript k−1 represents the value at time k−1 (the time before time k);
similarly, \vec{b}_{a,k}^{b} and \vec{b}_{a,k-1} represent the accelerometer bias, which the accelerometer 38 may have due to the process of manufacturing, at time k and time k−1, respectively;
\vec{b}_{c,k}^{b} and \vec{b}_{c,k-1}^{b} represent the compass bias, which the e-compass 39 may have due to the process of manufacturing, at time k and time k−1, respectively
\vec{s}_{a,k}^{b} and \vec{s}_{a,k-1}^{b} represent the truncation error due to the number of bits for representing the acceleration value on the accelerometer scale of the accelerometer 38 at time k and time k−1, respectively;
\vec{s}_{c,k}^{b} and \vec{s}_{c,k-1}^{b} represent the truncation error due to the number of bits for representing the terrestrial magnetism value on the compass scale of the e-compass 39 at time k and time k−1, respectively;
u_{Ψ,k-1} represents increment in the yaw angle Ψ due to the user using the second computing device 30 for generating traces of movements at time k−1;
u_{θ,k-1} represents increment in the pitch angle θ due to the user using the second computing device 30 for generating traces of movements at time k−1;

u_{φ,k-1} represents increment in the roll angle φ due to the user using the second computing device 30 for generating traces of movements at time k−1;

\vec{n}_{ba,k-1} represents the increment in the accelerometer bias, which the accelerometer 38 may have due to the process of manufacturing, at time k−1;
\vec{n}_{bc,k-1} represents the increment in the compass bias, which the e-compass 39 may have due to the process of manufacturing, at time k−1;
\vec{n}ₛₐ represents the increment in the accelerometer bias, which the accelerometer 38 may have due to the process of manufacturing, at time k−1 (the increment is almost fixed); and
\vec{n}_{sc} represents the increment in the compass bias, which the e-compass 39 may have due to the process of manufacturing, at time k−1 (the increment is almost fixed).

In addition, the relation between the state of the authorization module 889a and the measured values of the accelerometer 38 or the e-compass 39 may be represented by the following measurement equation:

$${\vec{Z}}_{k} = h ( {\vec{X}}_{k} ) = [ \begin{matrix}{S}_{a , k} {C}_{n , k}^{b} {\vec{g}}_{n} + {\vec{b}}_{a , k}^{b} \\ {S}_{c , k} {C}_{n , k}^{b} {\vec{m}}_{n , k} + {\vec{b}}_{c , k}^{b}\end{matrix} ] + Noise$$

where Noise is the measurement noise, and C_{n,k}^{b} is a navigation-frame-to-body-frame coordinate transformation matrix at time k, which transforms the navigation frame coordinate (subscript n) to the corresponding body frame coordinate (superscript b).

Since the body-frame-to-pseudo-frame coordinate transformation matrix at time k may be represented by:

$${C}_{b , k}^{p} = [ \begin{matrix}1 & 0 & 0 \\ 0 & cos φ & sin φ \\ 0 & - sin φ & cos φ\end{matrix} ] , and$$

the pseudo-frame-to-navigation-frame coordinate transformation matrix at time k may be represented by:

$${C}_{n , k}^{p} = [ \begin{matrix}cos θ cos ψ & - cos θ sin ψ & sin θ \\ sin ψ & cos ψ & 0 \\ - sin θ cos ψ & sin θ sin ψ & cos θ\end{matrix} ]$$

Thereby the navigation-frame-to-body-frame coordinate transformation matrix at time k, C_{n,k}^{b}, may be obtained from C_{n,k}^{b}=C_{b,k}^{p T} C_{n,k}^{p}.

Furthermore, scale factor matrices S_{a,k} and S_{c,k} may be represented by:

$${S}_{a , k} = [ \begin{matrix}{s}_{a , x , k}^{b} & 0 & 0 \\ 0 & {s}_{a , y , k}^{b} & 0 \\ 0 & 0 & {s}_{a , z , k}^{b}\end{matrix} ] and$$

$${S}_{c , k} = [ \begin{matrix}{s}_{c , x , k}^{b} & 0 & 0 \\ 0 & {s}_{c , y , k}^{b} & 0 \\ 0 & 0 & {s}_{c , z , k}^{b}\end{matrix} ]$$

Moreover, the Kalman Filter 823 may include a measurement update module 823-1, a Kalman gain calculation module 823-2 and a time update module 823-3.

At the initial stage when the Kalman Filter 823 starts to function, first, the initial roll/pitch angle calculating module 824 may calculate the initial roll angle and pitch angle to obtain an initial state vector \vec{X}ₖ, and the navigation frame's initial magnetic vector calculating module 825 may obtain the initial magnetic vector [mₓⁿ, m_{y}ⁿ, m_{z}ⁿ]^{T} of the navigation frame. One of the Kalman Filters 823, a covariance matrix Q, which is related to the changes in the angles about the three axes of the input device, due to the user's movement and the bias of the accelerometer 38 and the e-compass 39, may be defined as follows:

$$Q = [ \begin{matrix}{σ}_{r}^{2} {I}_{3 \times 3} & {0}_{3 \times 3} & {0}_{3 \times 3} & {0}_{3 \times 6} \\ {0}_{3 \times 3} & {σ}_{{b}_{a}}^{2} {I}_{3 \times 3} & {0}_{3 \times 3} & {0}_{3 \times 6} \\ {0}_{3 \times 3} & {0}_{3 \times 3} & {σ}_{{b}_{c}}^{2} {I}_{3 \times 3} & {0}_{3 \times 6} \\ {0}_{6 \times 3} & {0}_{6 \times 3} & {0}_{6 \times 3} & {0}_{6 \times 6}\end{matrix} ]$$

where σᵣ² represents the variance in the change in angles due to the user's input, σ_{b}_{ₐ}² represents the variance in the change in angles due to the bias of the accelerometer 38, and σ_{b}_{_{c}}² represents the variance in the change in angles due to the bias in the e-compass 39. In one example, the three variances mentioned above may be obtained from variances calculated from the results of multiple experiments. In another example, at least one of the three variances mentioned above may be stored in advance in the Kalman Filter 823. For the Kalman Filters 832, a posterior estimate error covariance matrix Po may be defined as follow:

$${P}_{0} = [ \begin{matrix}{σ}_{r}^{2} {I}_{3 \times 3} & {0}_{3 \times 3} & {0}_{3 \times 3} & {0}_{3 \times 6} \\ {0}_{3 \times 3} & {σ}_{{b}_{a}}^{2} {I}_{3 \times 3} & {0}_{3 \times 3} & {0}_{3 \times 6} \\ {0}_{3 \times 3} & {0}_{3 \times 3} & {σ}_{{b}_{c}}^{2} {I}_{3 \times 3} & {0}_{3 \times 6} \\ {0}_{6 \times 3} & {0}_{6 \times 3} & {0}_{6 \times 3} & {I}_{6 \times 6}\end{matrix} ]$$

One of the Kalman Filters 823, a measurement noise covariance matrix R, may be defined as follow:

$$R = [ \begin{matrix}{σ}_{ma}^{2} {I}_{3 \times 3} & {0}_{3 \times 3} \\ {0}_{3 \times 3} & {σ}_{mc}^{2} {I}_{3 \times 3}\end{matrix} ]$$

where σₘₐ² represents the measurement noise variance of the accelerometer 38, and σ_{mc}² represents the measurement noise variance of the e-compass 39.

In one example, the measurement noise variance σₘₐ² of the accelerometer 38 and the measurement noise variance σ_{mc}² of the e-compass 39 may be obtained through experiments and be pre-stored in the Kalman Filter 823.

Subsequently, time update module 823-3 may be configured to calculate the following equations:

\vec{X}ₖ⁻={circumflex over (\vec{X}ₖ₋₁

A=I_{15×15}

Pₖ⁻=APₖ₋₁A^{T}+Q

where {circumflex over (\vec{X}ₖ represents the a posteriori estimated state vector \vec{X}ₖ of measured \vec{Z}ₖ at time k, A is a 15×15 identity matrix, and Pₖ⁻ represents the a priori estimated error covariance matrix at time k.

The Kalman gain calculating module 823-2 may be configured to perform calculation of the following equations to obtain the Kalman gain Kₖ at time k:

Hₖ=Jacobian(h(\vec{X}ₖ⁻))

Kₖ=Pₖ⁻Hₖ^{T}(HₖPₖ⁻Hₖ^{T}+R)⁻¹

Note that the function h(\vec{X}ₖ⁻)) may be obtained by substituting the a prioir state vector \vec{X}ₖ⁻ into the measurement equation mentioned above. Hₖ may be obtained by calculating the determinant (Jacobian) of h(\vec{X}ₖ⁻).

The measurement update module 823-1 may be configured to calculate the following equations to obtain an estimated state vector \vec{X}ₖ:

{circumflex over (\vec{X}ₖ=\vec{X}ₖ⁻+Kₖ(\vec{Z}ₖ−h(\vec{X}ₖ⁻))

Pₖ=(I−KₖHₖ)Pₖ⁻

where Pₖ is the a posteriori estimate error covariance matrix at time k. From this, the estimated pitch angle \hat{θ} and yaw angle \hat{Ψ} may be obtained.

In one example, the authorization module 889a may further include to a hysteresis/low pass filter 827 for removing, for example, disturbance to measurement or estimation due to the natural vibration of the user's body.

In another example, the authorization module 889a may further include a coordinate conversion module 828 for converting the pitch angle \hat{θ} and the yaw angle \hat{ψ} to a set, of (X, Y) coordinates.

FIG. 18E is a plot of Matlab simulation result of generating the handwriting with the authorization module 889a, wherein the dashed line (curve) represents the registered handwriting and the solid line (curve) represents the handwriting generated by the authorization module 889a based on the measurement of the acceleration and magnetism changes of the second computing device 30 when being moved/wielded. The simulation result shows that the generated handwriting can be close to the registered handwriting.

Referring to FIG. 18A again, in another example, the LBS widget 88 may further include an instant messenger 887 coupled with the communication module 14 of the LBS system 10′″. The instant messenger 887 may be configured to be used to send at least one of a message, a question or an answer about the promoted product page by function(s) similar to those described and illustrated for the communication-module-related window 31-3 (which could be integrated within the LBS widget 88 in this example) as aforementioned.

In still another example, the LBS widget 88 may further include a fifth UI 885 coupled with the report module 18 of the LBS system 10′″. The fifth UI 885 may be configured to be used to report information of the promoted product page is incorrect. The function of the fifth UI 885 may be similar to those described and illustrated for the report window 31-9 as aforementioned.

In other example, the LBS widget 88 may further include a sixth UI 886 coupled with the management module 12 of the LBS system 10′″. The sixth UI 886 may be configured to be used to rate the quality of the product of the promoted product page or the seller's service of selling the product of the promoted product page, for example, give it a score(s) or pick up one of options to express if the user feels good about the product or the service provided by the seller, etc.

FIG. 18F is a block diagram illustrating an LBS widget 88′ according to another example of the present invention. Referring to FIG. 18F, the LBS widget 88′ may be similar to the LBS widget 88 described and illustrated with reference to FIG. 18A, except that the first UI 881 of the LBS widget 88′ may be configured to show an LBS promotion region 881b. Similarly, the LBS promotion module 888 may be configured to receive the product information and the second coordinates related to the promoted product page, and show the product information related to the promoted product page in the LBS promotion region 881b if a distance between the first coordinates and the second coordinates is smaller than or equal to a distance limit.

One skilled in the art can understand that the first coordinates may represent a first point on the map, and the second coordinates may represent a second point on the map. Moreover, the distance between the two sets of coordinates may be represented by the distance between the two points on the map.

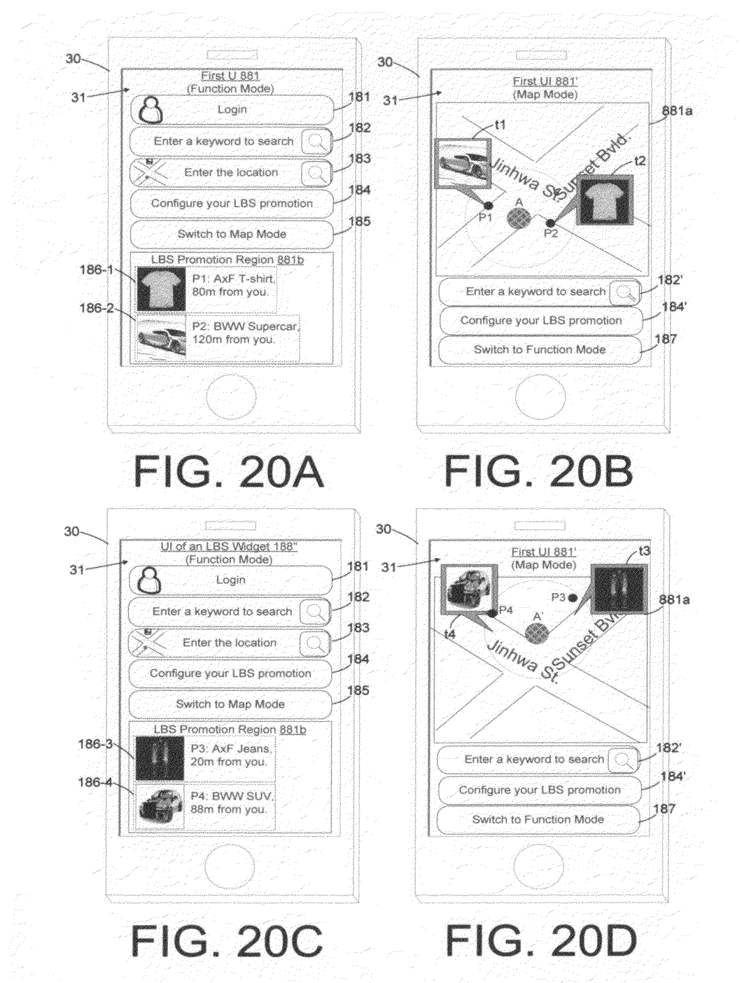

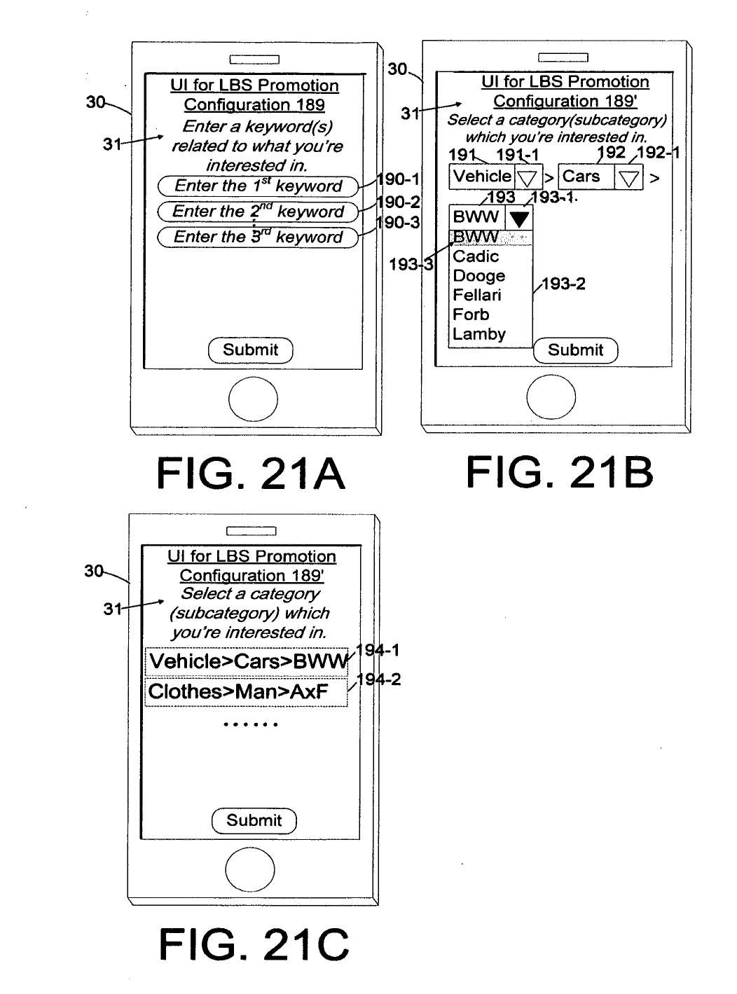

Moreover, some details of the LBS widgets 88 and/or 88′ will be described and illustrated with reference to FIGS. 20A to 21C later.

Referring to FIG. 18A or 18E again, the aforementioned windows shown in the screen 21 may also be initiated and/or shown by user interfaces of an LBS widget 99. Similarly, the LBS widget 99 may be formed in the first computing device 20. Moreover, the LBS widget 99 may be implemented as a program capable of being installed in the first computing device 20 and executed by a processor (e.g., a CPU or an MCU) of the first computing device 20 to form/generate modules (or elements or components) of the LBS widget 99 and the user interfaces coupled with the web application(s) or task(s) provided by the LBS system 10′″. In this example, the program may include a set of instructions in programming code(s) that can be executed in the operating system of the first computing device 20, for example, such as the Windows or Linux for a PC or a laptop (if the first computing device 20 is the PC or the laptop), or the iPhone OS of an iPhone or the Android of an Android phone (if first computing device 20 is the cellular phone).

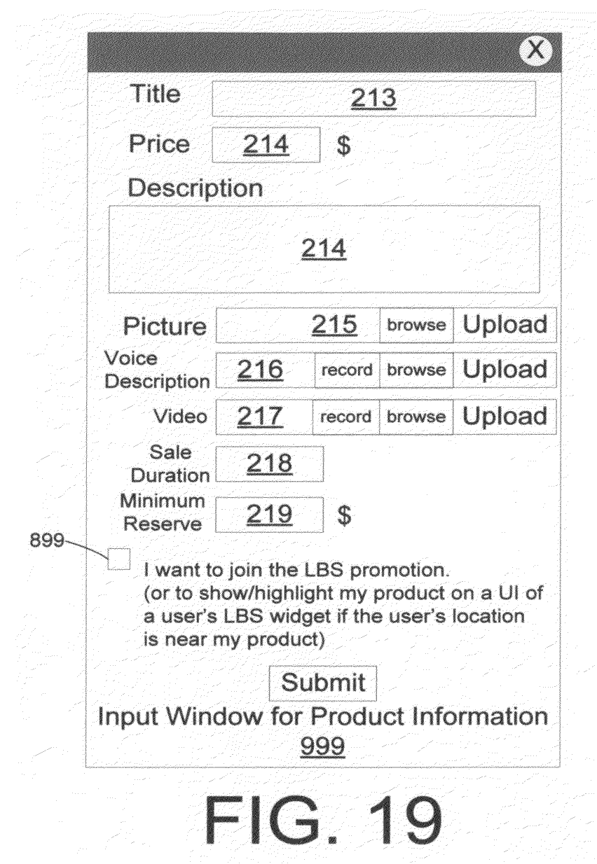

The LBS widget 99 may include the positioning module 22 (which may function as aforementioned) and a UI 991. The UI 991 may be configured to show the input window 999 as described and illustrated in FIG. 19.

FIG. 19 is a diagram illustrating an input window 999 for the product information according to an example of the present invention. In this example, the input window 999 may be opened by a browser of the first computing device 20 or initiated as a window of the LBS widget 99. Referring to FIG. 19, the input window 999 may be similar to the input window 21-2 described and illustrated with reference to FIG. 2B, except that the input window 999 may further include a checkbox 899. When a seller uploads the product information thru the input window 999, if the checkbox is checked, it means the seller wants to add his/her product into the LBS promotion provided by the LBS system 10′″ (to join the LBS promotion), and then a promoted product page for his/her product will be generated and the product information of his/her product will be shown in the LBS region 881b or highlighted/marked in the part of the map 881a.

FIG. 20A is a diagram illustrating the first UI 881 of the LBS widget 88′ according to an example of the present invention. Referring to FIG. 20A, the first UI 881 (or the function mode of the first UI of the LBS widget 88 or 88′) may be shown on the screen 31 of the second computing device 30 and may include the LBS promotion region 881b. For example, two items 186-1 and 186-2 are shown on the LBS promotion region 881b of which the first item 186-1 is about “AxF T-shirt” and the second item 186-2 is about a “BWW Supercar” (both are the title/name of products, and both are related to a corresponding promoted product page). Product information about the products or their corresponding promoted product pages may also be briefly shown with the items (e.g., the “AxF T-shit” is 80 meters from the user's location and the “BWW Supercar” is 120 m from the user's location, etc.). Moreover, if the user moves to another location, the LBS promotion region 881b may be refreshed accordingly, as shown in FIG. 20C, which means old two items 186-1 and 186-2 are replaced by two new items 186-3 and 186-4 (of course only if the two new items exists around the user's new location. It is possible that no item or just one item exists around the user's new location in other example), and so on.

Moreover, the first UI 881 may further include a login button 181, and a login window will be shown if the login button 181 is clicked or pushed.

Further, the first UI 881 may further include two fields 182 and 183, which are similar to the fields 323 and 325 described and illustrated with reference to FIG. 3D, respectively, for the user to input a keyword and or a location he/she is interested to search or look for an item.

Moreover, the first UI 881 may further include a configuration button 184, and a new window (or page) or a new UI will be shown if the configuration button 184 is pushed or clicked (as will be described and illustrated with reference to FIG. 21A, 21B or 21C later).

FIG. 20B is a diagram illustrating the first UI (numbered as 881′ in this example) of the LBS widget 88 (or 88′ but in map mode) according to another example of the present invention. Referring to FIG. 20B, items (perhaps corresponding to the aforementioned items 186-1 and 186-2 shown on the LBS region 881b when the first UI is in the function mode) may be shown on the part of the map 881a at points P1, P2, etc., and tags t1 or t2 related to the items may also be shown in the same part of the maps as LBS promotion items around the location A of the user. In one example, the tags t1 or t2 may first hided and will be shown once the points P1 or P2 is selected or touched.

Similarly, if the user moves to another location, the part of the map 881a may be refreshed accordingly, for example, two new points P3 and P4 (perhaps with corresponding tags t3 and t4) are shown after refreshing, as illustrated in FIG. 20D.

Moreover, the first UI 881′ may also include a search fields 182′ similar to the field 323 described and illustrated with reference to FIG. 3D for the user to input a keyword to search or items around him/her.

Furthermore, the first UI 881′ may also include a configuration button 184′. In this example, a new window (or page) or a new UI as will be shown if the configuration button 184 is pushed or clicked (as will be described and illustrated with reference to FIG. 21A, 21B or 21C later).

Note that in one example, the first UI 881 may include a button 185 to switch to a map mode similar to the first UI 881′ shown in FIG. 20B once the button 185 is touched, clicked or pressed. In another example, the first UI 881′ may also include a button 187 to switch to a function mode similar to the first UI 881 shown in FIG. 20B once the button 185 is touched, clicked or pressed. One skilled in the art can understand that the first UIs 881 and 881′ could be different ways to display same first UI of the LBS widget 88 (or 88′) that includes both of the two modes. Therefore in this example, a user may switch to one of the two modes depending on the way he/she would like to see/check the LBS promotion provided by the LBS system 10′″.

FIG. 21A is a diagram illustrating an UI 189 of the LBS widget 88 or 88′ for configuring an LBS promotion according to an example of the present invention. Referring to FIG. 21A, the UI 189 may be configured as a part of the first UI 881 or 881′, or to be coupled with the first UI 881 or 881′ (i.e., the UI 189 will be shown if the configuration button 184 or 184′ is clicked, pushed or selected). In this example, the UI 189 may include a field 190-1 for the user to enter a first keyword about the LBS promotion (or the promoted product page) he/she wants to see on the first UI 881 or 881′. Moreover, the user may be able to enter a plurality of keywords (e.g., a second keyword, a third keyword perhaps related to the same or different kinds or categories of products/services) to configure the LBS promotion shown on the first UI 881 or 881′, that is, only product information of promoted product page (or the promoted product page itself) related to the keyword(s) entered by the user will be shown on the first UI 881 or 881′ of the LBS widget 88 or 88′ installed in the user's second computing device 30. For example, at least one of the icon, the tag, the button or the link related to a promoted product page will be shown on the part of the map 881a of the first UI 881 or 881′ (in the map mode) if the promoted product page is related to the keyword and the location of the product of the promoted product page is also close to the user.

FIG. 21B is a diagram illustrating an UI 189′ of the LBS widget 88 or 88′ for configuring an LBS promotion according to another example of the present invention. Referring to FIG. 21B, instead of entering the keywords, the UI 189′ may include a drop-down menu (such as drop-down menus 191, 192 or 193 with drop-down buttons 191-1, 191-2 or 191-3, respectively) or a checkbox (not shown in the figure) to facilitate selecting a category (or subcategory) of promoted product pages of the LBS promotion the user wants to see. In this example, the “Vehicle” is a main category and the “Cars” is its subcategory, and so on.

Moreover, FIG. 21C is a diagram illustrating selected categories of the UI 189′ in FIG. 21B. In this example, the user chooses two categories “BWW” and “AxF” of the LBS promotion, and thus product information/icons or tags related to promoted product pages in the selected categories will be shown on the part of the map 881a or the LBS promotion region 881b of the first UI 881 or 881′ of the LBS widget 88 or 88′.

One skilled in the art can easily understand that the showing of the promoted product page may also be configured like, for example, the user checks a checkbox of the UI 189 or 189′ to generate a configuration such as to agree the LBS system 10′″ to show the most popular item(s) or information of the most popular product(s) around the user (and in certain period of a day for example), etc.

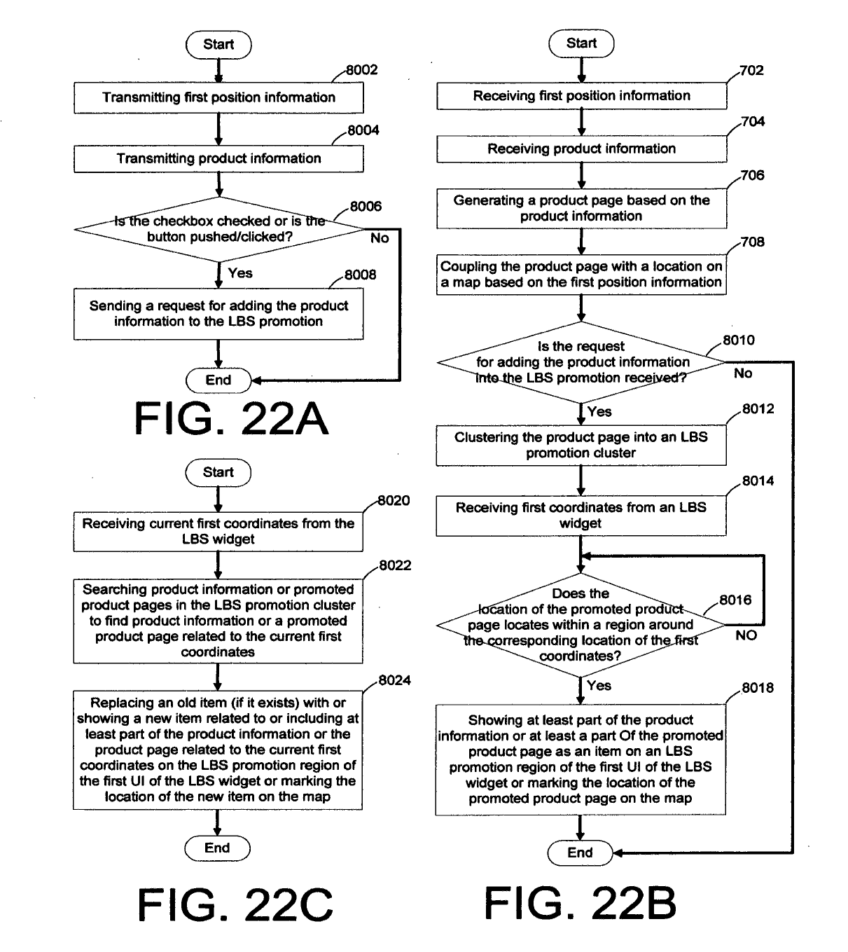

FIG. 22A is a flowchart illustrating a method of adding product information into an LBS promotion according to an example of the present invention. Referring to FIG. 22A, the seller may input the product information with the input window 999 with the browser of the first computing device 20 or the LBS widget 99, and check the checkbox 899. In step 8002, the browser or the LBS widget 99 may transmit the first position information of the seller (e.g., an address of a product or a store entered by its seller or the coordinates of the seller's first computing device (20), for example, his/her cellular phone or computer) to the position module 11 of the LBS system 10″. In step 8004, the browser or the LBS widget 99 may transmit the product information to the management module 12 of the LBS system 10′″. Moreover, if the checkbox 899 is checked, the browser or the LBS widget 99 may send a request (or a response of the checkbox) for adding the product information into the LBS promotion provided by the LBS system 10′″ in step 8006.

FIG. 22B is a flowchart illustrating a method of generating a promoted product page and providing an LBS promotion according to an example of the present invention, wherein steps 702, 704, 706 and 708 of generating a product page may be similar to those described and illustrated with reference to FIGS. 7 and 8. Referring to FIG. 22B, in step 8010, the management module 12 may determine if the checkbox is checked (by checking if the request is received or not). If the management module 12 receives the request for adding the product information into the LBS promotion, the management module 12 may cluster the product page into an LBS promotion cluster in the database 16 in step 8012. In this example, those clustered into the LBS promotion cluster will become promoted product pages. Therefore, the product page becomes a promoted product page after step 8012.

Later, the position module 11 may receive a user's first coordinates (or the first coordinates of the second computing device 30 or the user's cellular phone) from the LBS widget 88 in step 8014. In step 8016, the management module 12 may determine if the location of the promoted product page locates within a region around the corresponding location of the first coordinates on the map (i.e., to determine if the current location of the user is near the location of the promoted product page). Further in this example, the location of the promoted product page means the location corresponding to the first position information. Moreover, the region may be centered by the corresponding location of the first coordinates, or the region may include the location of the promoted product page and the corresponding location of the first coordinates (i.e., the two locations can be shown in the same part of the map). If the location of the promoted product page locates in the region, the management module 12 may transmit at least a part of the product information of the promoted product page (or the complete promoted product page) to the LBS promotion module 888 of the LBS widget 88 and the LBS promotion module 888 may show the at least part of the product information or the promoted product page as an icon (or a button, a tag or a link) on the part of the map 881a (maybe by the help of the map module 880) or as an item on the LBS promotion region 881b.

FIG. 22C is a flowchart illustrating a method of providing an LBS according to another example of the present invention. Referring to FIG. 22C, if the user's location changes, the LBS widget 88 may send new (current) first coordinates to the position module 11 of the LBS system 10′″. The position module 11 may receive the current first coordinates from the LBS widget 88 in step 8020. Next, the management module 12 may search product information or promoted product pages in the LBS promotion cluster for finding new product information or a new promoted product page related to the current first coordinates (e.g., with its location near the current location of the user/the location corresponding to the current first information) in step 8022. Moreover, in step 8024, if the new product information or the new promoted product page is found, the management module 12 may transmit the new product information or the new promoted product page, or just a link (or a new tag, an new icon or a new button) of the new product information or the new promoted product page, to the LBS promotion module 888. The LBS promotion module 888 may then replace an old item (if it exists) in the LBS promotion region with 881b with an new item related to the received, or cause the map module 880 to mark a location corresponding to the location of the new product information or the new promoted product page.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. An LBS widget comprises:
a positioning module configured to receive first coordinates;
a map module configured to show a part of a map on a first UI,
wherein the part of the map comprises a first location corresponding to the first coordinates; and
an LBS promotion module configured to receive product information and second coordinates related to a promoted product page and mark a second location corresponding to the second coordinates on the part of the map.

2. The LBS widget of claim 1 further comprises:
a second UI comprising at least one of an input field, a drop-down menu or a checkbox,
wherein the input field is configured to be used to enter a keyword, and
the drop-down menu or the checkbox is configured to be used to choose a category or subcategory,
wherein the at least one of the icon, the tag, the button or the link related to the promoted product page is shown on the first UI if the promoted product page is related to the keyword or the category or subcategory.

3. The LBS widget of claim 1, wherein the promoted product page is shown on at least one of the first UI or a third UI if the at least one of the icon, the tag, the button or the link is chosen.

4. The LBS widget of claim 3, wherein the promoted product page shown on the at least one of the first UI or the third UI further comprises a bid field configured to be used to place a bid.

5. The LBS widget of claim 4, wherein the bid is valid if the bid is placed during a selling period of the promoted product page.

6. The LBS widget of claim 4, wherein the bid comprises an offer,
wherein the at least one of the first UI or the third UI shows a product of the promoted product page is sold or reserved if the offer is accepted.

7. The LBS widget of claim 4, wherein the at least one of the first UI or the third UI shows a product of the promoted product page is sold or reserved after the bid is placed.

8. The LBS widget of claim 4 further comprises:
a cash-flow module configured to be used to pay a payment of a product of the promoted product page online, the cash-flow module comprising:
an authorization module configured to receive acceleration measurement values and magnetic measurement values and generate a handwriting based on the acceleration measurement values and the magnetic measurement values,
wherein the payment is paid successfully if the handwriting matches a registered handwriting.

9. The LBS widget of claim 4, wherein at least one of the first UI, the third UI or a fourth UI shows a winning receipt if a product of the promoted product page is won after the bid is placed.

10. The LBS widget of claim 1 further comprises:
an instant messenger configured to be used to send at least one of a message, a question or an answer about the promoted product page.

11. The LBS widget of claim 1 further comprises:
a fifth UI configured to be used to report information of the promoted product page is incorrect.

12. The LBS widget of claim 1 further comprises:
a sixth UI configured to be used to rate a product or a service of selling the product related to the promoted product page.

13. An LBS widget comprises:
a positioning module configured to receive first coordinates;
an LBS promotion module configured to receive product information and the second coordinates related to a promoted product page; and
a first UI comprising an LBS promotion region,
wherein the LBS promotion module is configured to show the product information related to the promoted product page in the LBS promotion region if a distance between the first coordinates and the second coordinates is smaller than or equal to a distance limit.

14. The LBS widget of claim 13, wherein the first UI is configured to show a part of a map,
wherein the part of the map comprises a first location corresponding to the first coordinates, and
LBS promotion module is configured to mark a second location corresponding to the second coordinates on the part of the map.

15. The LBS widget of claim 13 further comprises:
a second UT comprising at least one of an input field, drop-down menu or a checkbox,
wherein the input field is configured to be used to enter a keyword, and
the drop-down menu or the checkbox is configured to be used to choose a category or subcategory,
wherein the product information related to the promoted product page is shown in the LBS promotion region of the seventh UI if the promoted product page is related to the keyword or the category or subcategory.

16. The LBS widget of claim 14, wherein the promoted product page is shown on at least one of the seventh UT, the eighth UI or a third UT if the at least one of the icon, the tag, the button or the link is chosen.

17. The LBS widget of claim 16, wherein the promoted product page shown on the at least one of seventh UI, the eighth UI or the third UI further comprises a bid field configured to be used to place a bid.

18. The LBS widget of claim 17, wherein at least one of the first UT, the third UI or a fourth UI shows a winning receipt if a product of the promoted product page is won after the bid is placed.

19. The LBS widget of claim 17 further comprises:
a cash-flow module configured to progress paying a payment for a product of the promoted product page, the cash-flow module comprising:
an authorization module configured to receive an acceleration value and an angle value and generate a handwriting based on the acceleration value and the angle value,
wherein the payment is paid successfully if the handwriting matches a registered handwriting.

20. The LBS widget of claim 19, wherein at least one of the first UI, the third UI or a fourth UI shows a receipt after the payment is paid.
